(19) United States
(12) Patent Application Publication
(10) Pub. No.: US 2005/0138656 A1
(43) Pub. Date: Jun. 23, 2005

(54) Interactive television program guide with enhanced user interface

(75) Inventors: S. Sean Moore, Tulsa, OK (US); Jennifer A. Vogh, Tulsa, OK (US); Donald W. Allison, Tulsa, OK (US); Bryan Mitchell Drummond, Broken Arrow, OK (US); Robert H. McCoy, Broken Arrow, OK (US); Vaughn Rex Henson, Tulsa, OK (US); Rick Phillips, Santa Monica, CA (US); William L. Thomas, Bixby, OK (US); W. Benjamin Herrington, Tulsa, OK (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: United Video Properties, Inc., Tulsa, OK (US)

(21) Appl. No.: 10/925,364

(22) Filed: Aug. 24, 2004

Related U.S. Application Data
(63) Continuation of application No. 09/668,678, filed on Sep. 22, 2000, now abandoned.
(60) Provisional application No. 60/156,111, filed on Sep. 24, 1999.
(60) Provisional application No. 60/161,896, filed on Oct. 27, 1999.
(60) Provisional application No. 60/170,386, filed on Dec. 13, 1999.
(60) Provisional application No. 60/202,302, filed on May 5, 2000.

(51) Int. Cl. H04N 5/445; G06F 3/00; G06F 13/00

(52) U.S. Cl. 725/45; 725/44; 725/54

(57) ABSTRACT

An enhanced program guide interface is provided. The interface may use colors and other display characteristics, and may provide navigational interface elements, and other displays, to enhance the user's guidance experience. The system may include advertisements that are tied to the subject matter of program guide features, options or functions. Display elements may be componentized.

This application claims the benefit of Vogh et al. U.S. provisional patent application Ser. No. 60/156,111, filed Sep. 24, 1999, Vogh et al. U.S. provisional patent application Ser. No. 60/161,896, filed Oct. 27, 1999, Moore et al. U.S. provisional patent application Ser. No. 60/170,386, filed Dec. 13, 1999, and Moore et al. provisional patent application Ser. No. 60/202,302, filed May 5, 2000.

### BACKGROUND OF THE INVENTION

This invention relates to interactive television program guides, and more particularly, to interactive television program guides with enhanced user interfaces.

Interactive television program guides are well known. It is desirable to provide user interfaces for interactive television program guides that enhance the user's guidance experience. It is also desirable to include advertisements and e-commerce opportunities within program guides.

### SUMMARY OF THE INVENTION

These and other objects of the present invention are accomplished in accordance with the principles of the present invention by providing an interactive television program guide system having an enhanced user interface. The interface of the present invention may use colorings or other highlighting techniques to better indicate to the user where the user is located within the program guide, and the features that the user has selected. The interface may include, for example, a “sticky” highlight feature. The sticky highlight feature helps reassure the user, in response to the user performing an action within the guide, that the user's action was properly made, before the selected function is performed. The system may highlight features using, for example, colors that are different from the original colors of the features. If desired, a third color may be used to indicate that a feature has been selected.

The system may provide enhanced navigational tools for aiding the user in navigating within the guide. The system may, for example, provide a navigational scheme wherein program guide display screens are slid back and forth. The screens may include cutoffs that indicate additional information is available off of the current view space. The system may provide an anchor bar having dynamic location indicators. The system may provide a navigational display region that is simultaneously displayed with information such as, for example, program listings. Users may position indicators within the display region to access types of pieces of information such as, for example, program listings for a particular time slot or channel.

Actions that are associated with a program may be provided within, for example, an information display. The system may dynamically associate actions with a program using, for example, metadata, by putting additional fields in the program guide data, or using any other suitable approach. The actions may be provided in an action display for a selected program. The actions may be linked, via executable type commands or scripts, to other applications to provide the user with enhanced features that are related to the selected program.

The system may dynamically determine categories for listings by category displays. For example, the system may determine if there are listings available for given categories. Users may select only those categories for which listings are available. The system may provide dynamic softkeys for selecting guide functions. The softkeys may be color coded to keys on a user interface device.

The system may provide navigable displays of user-identified listings having video displays that are synchronized to the user's position within the listings. The navigable displays may be for, for example, favorite listings, listings for which reminders are scheduled, or for history listings.

The system may include advertisements that are tied to the subject matter of program guide features, options or functions. Tying advertisements to the subjects matter of guide features, options or functions may provide users with an increased awareness of guide content, as opposed to simply subjecting users to advertisements for products or services without providing them with additional information related to the guide.

Display elements may be componentized. Componentization of display elements may allow many components to be used in more than one screen. Components may also act as containers for other components. Libraries of components may be constructed to provide for the more efficient storage and retrieval of component if desired.

Further features of the invention, its nature and various advantages will be more apparent from the accompanying drawings and the following detailed description of the preferred embodiments.

### BRIEF DESCRIPTION OF THE DRAWINGS

FIG. 1 is a schematic block diagram of an illustrative system in accordance with the present invention.

FIGS. 2a-2e show illustrative arrangements for the interactive program guide equipment of FIG. 1 in accordance with the principles of the present invention.

FIG. 3 is an illustrative schematic block diagram of a user television equipment of FIGS. 2a-2e in accordance with the principles of the present invention.

FIG. 4 is a generalized schematic block diagram of portions of the illustrative user television equipment of FIG. 3 in accordance with the principles of the present invention.

FIGS. 5-32 are illustrative display screens for a first illustrative program guide interface in accordance with the present invention.

FIG. 33 is a flowchart of illustrative steps involved in the sticky highlight feature of the present invention.

FIG. 34 is a flowchart of illustrative steps involved in highlighting display elements using different display characteristics, in accordance with the present invention. FIGS. 35A, 35B, 36, 37A, 37B, 38, 39, 40A, 40B, 41-52, 53A, 53B, and 54-107 are illustrative display screens for a second illustrative program guide interface in accordance with the present invention.

FIGS. 108-135, 136A, 136B, 137A, and 137B are illustrative display screens for a third illustrative program guide interface in accordance with the present invention.

FIG. 138 is a flowchart of illustrative steps involved in providing advertisements in accordance with the present invention.

FIG. 139 is a flowchart of illustrative steps involved in providing a sliding navigational paradigm in accordance with the present invention.

FIGS. 140-149, 150A, 150B, and 151 are illustrative display screens for a fourth illustrative program guide interface in accordance with the present invention.

FIG. 152 is a flowchart of illustrative steps involved in providing a dynamic anchor bar in accordance with the present invention.

FIG. 153 is a flowchart of illustrative steps involved in providing navigational display regions in accordance with the present invention.

FIG. 154 is a flowchart of illustrative steps involved in providing dynamic actions associated with programs, in accordance with the present invention.

FIG. 155 is a flowchart of illustrative steps involved in providing dynamic category displays in accordance with the present invention.

FIG. 156 is a flowchart of illustrative steps involved in providing dynamic soft keys in accordance with the present invention.

FIG. 157 is a flowchart of illustrative steps involved in providing navigational displays having synchronized video windows, in accordance with the present invention.

### DETAILED DESCRIPTION OF THE INVENTION

The interactive television program guide of the present invention may be based on a number of different hardware platforms. Suitable hardware that may be used in implementing the program guide includes hardware such as satellite receivers, personal computer televisions (PC/TVS), personal computers (e.g., with television tuner cards), cable set-top boxes, or any other suitable hardware. Illustrative interactive television program guide systems are described, for example, in Knee et al. U.S. Pat. No. 5,589,892 and Knudson et al. U.S. patent application Ser. No. 09/357,941, filed Jul. 16, 1999, which are hereby incorporated by reference herein in their entireties. Client-server program guide systems are described, for example, in Ellis et al. U.S. patent application Ser. No. 09/374,043, filed Aug. 13, 1999, which is hereby incorporated by reference herein in its entirety. On-line program guide systems are described, for example, in Boyer et al. U.S. patent application Ser. No. 08/938,028, filed Sep. 18, 1997, which is hereby incorporated by reference herein in its entirety.

The interactive program guide may allow users to record programs on digital or analog storage devices (e.g., videocassettes, hard disks, floppy discs, flash memory, recordable compact discs (CDS), recordable digital versatile discs (DVDs), or any other type of storage). Interactive program guides having digital storage are described, for example, in Hassell et al. U.S. patent application Ser. No. 09/157,256, filed Sep. 17, 1998, which is hereby incorporated by reference herein in its entirety. Recording of media can also be performed by a program guide or other server. Client-server based program guides with remote server recording are described, for example, in Ellis et al. U.S. patent application Ser. No. 09/332,244, filed Jun. 11, 1999, which is hereby incorporated by reference herein in its entirety. On-line program guide may also record programs or direct a user's equipment to record programs.

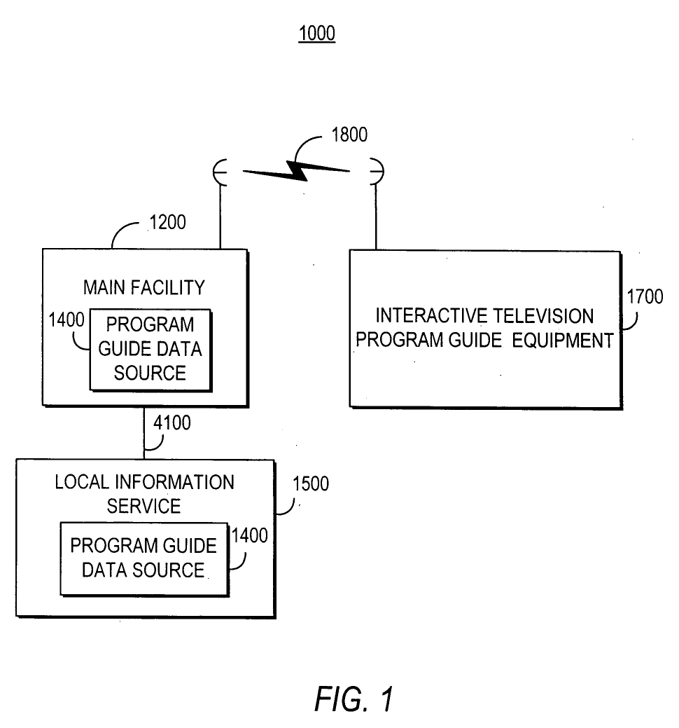

An illustrative system 1000 in accordance with the principles of the present invention is shown in FIG. 1. Main facility 1200 provides program guide data from program guide data source 1400 to interactive television program guide equipment 1700 via communications link 1800. There may be multiple program guide data sources but only one has been shown to avoid over-complicating the drawing. If desired, program guide data sources may be located at facilities separate from main facility 1200, such as at local information services 1500, and have their data provided to main facility 1200 for localization and distribution. Data sources 1400 may be any suitable computer or computer based system for obtaining data (e.g., manually from an operator, electronically via a computer network or other connection, or via storage media) and putting the data into electronic form for distribution by main facility 1200. Link 1800 may be a satellite link, a telephone network link, a cable or fiber optic link, a microwave link, an Internet link, a combination of such links, or any other suitable communications link. Video signals may also be transmitted over link 1800 if desired.

Local information service 1500 may be any suitable facility for obtaining data particular to a localized region and providing the data to main facility 1200 over communications link 4100. Local information service 1500 may be, for example, a local weather station that measures weather data, a local newspaper that obtains local high school and college sporting information, or any other suitable provider of information. Local information service 1500 may be a local business with a computer for providing main facility 1200 with, for example, local ski reports, fishing conditions, menus, etc., or any other suitable provider of information. Link 4100 may be a satellite link, a telephone network link, a cable or fiber optic link, a microwave link, an Internet link, a combination of such links, or any other suitable communications link.

The program guide data transmitted by main facility 1200 to interactive television program guide equipment 1700 may include television programming data (e.g., program identifiers, times, channels, titles, and descriptions) and other data for services other than television program listings (e.g., help text, pay-per-view information, weather information, sports information, music channel information, associated Internet web links, associated software, etc.). There are preferably numerous pieces or installations of interactive television program guide equipment 1700, although only one is shown in FIG. 1 to avoid over-complicating the drawing.

Program guide data may be transmitted by main facility 1200 to interactive television program guide equipment 17 using any suitable approach. Data files may, for example, be encapsulated as objects and transmitted using a suitable Internet based addressing scheme and protocol stack (e.g., a stack which uses the user datagram protocol (UDP) and Internet protocol (IP)). Systems in which program guide data is transmitted from a main facility to television distribution facilities are described, for example, in Gollahon et al. U.S. patent application Ser. No. 09/332,624, filed Jun. 11, 1999, which is hereby incorporated by reference herein in its entirety.

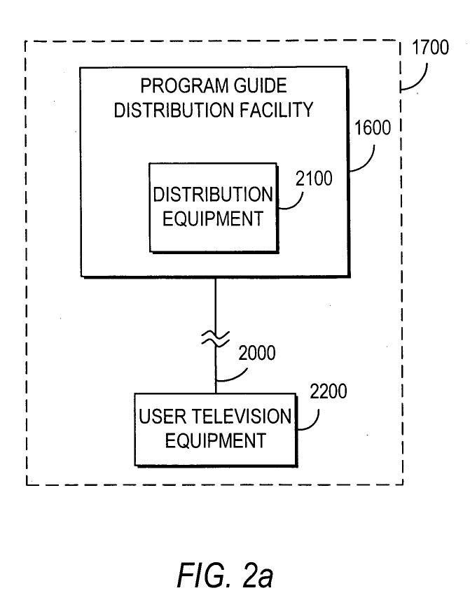

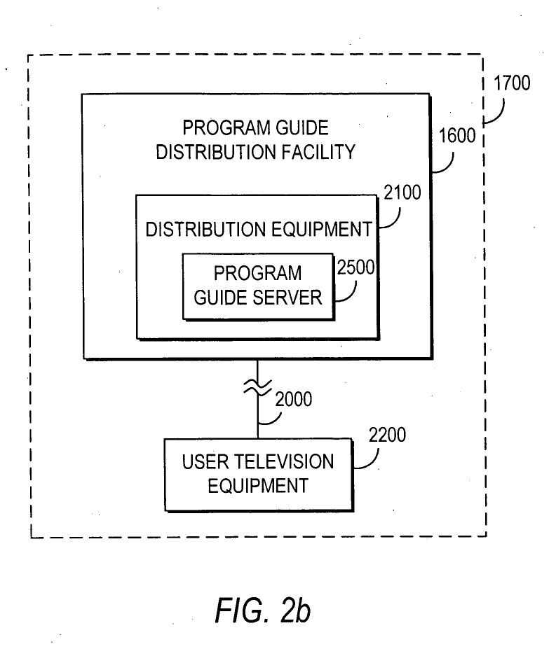

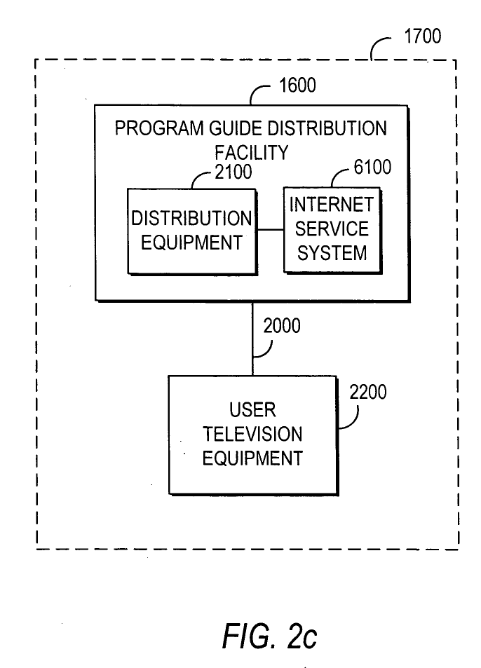

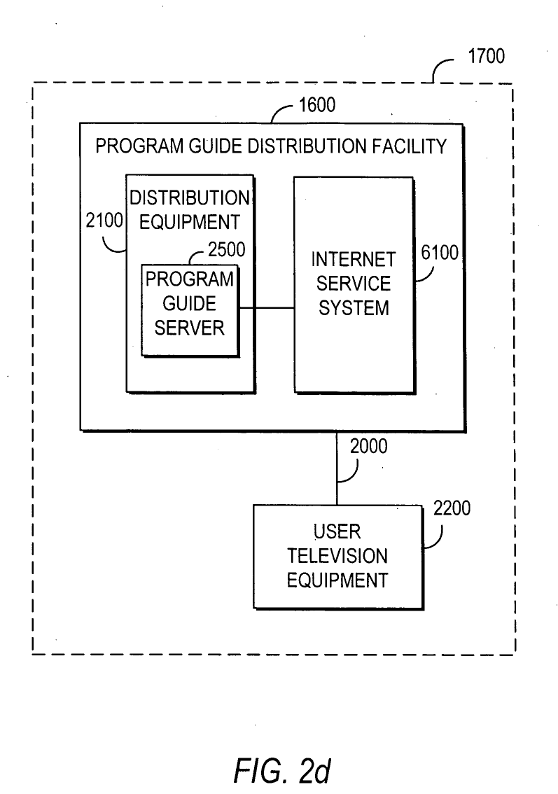

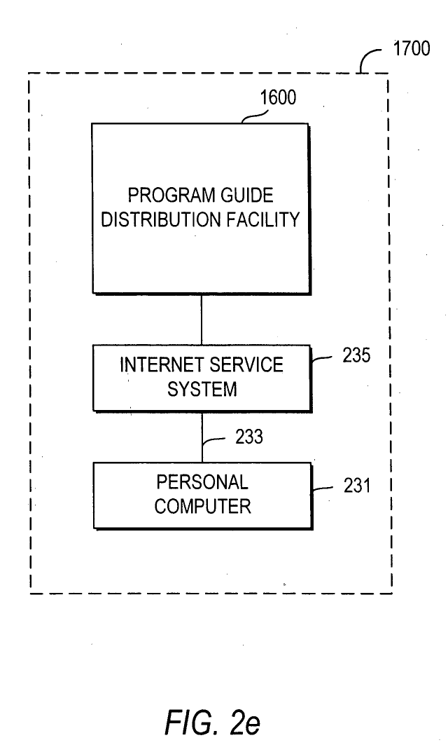

An interactive television program guide is implemented on interactive program guide television equipment 1700. Five illustrative arrangements for interactive program guide television equipment 1700 are shown in FIGS. 2a-2e. As shown, interactive program guide television equipment 1700 may include program guide distribution equipment 21 located at program guide distribution facility 1600, and user television equipment 22.

The interactive television program guide may run totally on user television equipment 2200 using the arrangements of FIGS. 2a and 2c, or may run partially on user television equipment 2200 and partially on interactive program guide television equipment 1700 using a suitable client-server or distributed processing arrangement such as those shown in FIGS. 2b and 2d. Program guide distribution facility 1600 may be any suitable distribution facility (e.g., a cable system headend, a broadcast distribution facility, or any other suitable type of distribution facility, and may have distribution equipment 2100.

Distribution equipment 21 of FIGS. 2a, 2b, 2c, and 2d is equipment suitable for providing program guide data to user television equipment 22 over communications path 20. In FIG. 2e, distribution equipment 21 may provide program guide data to Internet service system 235 via, for example, a suitable computer network or Internet link. Distribution equipment 21 may include, for example, suitable transmission hardware for distributing program guide data on a television channel sideband, in the vertical blanking interval of a television channel, using an in-band digital signal, using an out-of-band digital signal, or by any other suitable data transmission technique. Analog or digital video signals (e.g., television programs) may also be distributed by distribution equipment 2100 to user television equipment 2200 over communications paths 20 on multiple television channels. Alternatively, videos may be distributed to user television equipment 2200 from some other suitable distribution facility, such as a cable system headend, a broadcast distribution facility, a satellite television distribution facility, or any other suitable type of television distribution facility.

Communications paths 20 may be any communications paths suitable for distributing program guide data. Communications paths 20 may include, for example, a satellite link, a telephone network link, a cable or fiber optic link, a microwave link, an Internet link, a data-over-cable service interface specification (DOCSIS) link, a combination of such links, or any other suitable communications link. Communications paths 20 preferably have sufficient bandwidth to allow program guide distribution facility 1600 or another distribution facility to distribute television programming to user television equipment 2200. There are typically multiple pieces of user television equipment 2200 and multiple associated communications paths 2000, although only one piece of user television equipment 2200 and communications path 2000 are shown in FIGS. 2a -2d to avoid over-complicating the drawings. If desired, television programming and program guide data may be provided over separate communications paths.

FIG. 2b shows an illustrative arrangement for interactive program guide television equipment 1700 in a client-server based or distributed interactive program guide system. As shown in FIG. 2b, distribution equipment 2100 may include program guide server 2500. Program guide server 2500 may use any suitable combination of hardware and software to provide a client-server based program guide. Program guide server 25 may, for example, run a suitable database engine (e.g., SQL Server by Microsoft) and provide program guide data in response to queries generated by a program guide client implemented on user television equipment 2200. If desired, program guide server 2500 may be located at main facility 1200, or other location, such as a cable system headend, a broadcast distribution facility, a satellite television distribution facility, or any other suitable type of television distribution facility.

The program guide may retrieve program guide data from program guide server 2500 using any suitable client-server based approach. The program guide may, for example, pass SQL requests as messages to program guide server 2500. In another suitable approach, the program guide may invoke remote procedures that reside on program guide server 2500 using one or more remote procedure calls. Program guide server 2500 may execute SQL statements for such invoked remote procedures. In still another suitable approach, client objects executed by the program guide may communicate with server objects executed by program guide server 2500 using, for example, an object request broker (ORB). This may involve using, for example, Microsoft's Distributed Component Object Model (DCOM) approach.

The program guide implemented on interactive program guide television equipment 1700 may communicate with program guide server 2500 over communications path 2000 using any suitable network and transport layer protocols, if desired. They may communicate, for example, using a protocol stack which includes Sequenced Packet Exchange/Internetwork Packet Exchange (SPX/IPX) layers, Transmission Control Protocol/Internet Protocol (TCP/IP) layers, Appletalk Transaction Protocol/Datagram Delivery Protocol (ATP/DDP) layers, DOCSIS or any other suitable network and transport layer protocols.

FIGS. 2c and 2d show illustrative Internet based interactive television program guide systems. Distribution facility 1600 may, for example, include Internet service system 6100. Internet service system 6100 may use any suitable combination of hardware and software capable of providing program guide data to the guide using an Internet based approach (e.g., the HyperText Transfer Protocol (HTTP)). If desired, Internet service system 6100 may be located at a facility that is separate from program guide distribution facility 1600.

If the program guide is implemented on user television equipment 2200 of interactive program guide television equipment 1700 as shown in FIG. 2c, Internet service system 6100 (or other suitable equipment at program guide distribution facility 1600 that is connected to Internet service system 6100) may provide program guide data to user television equipment 2200 via the Internet, or via program guide distribution equipment 21 using any suitable Internet-based approach (e.g., using the HyperText Transfer Protocol (HTTP) over a Transmission Control Protocol/Internet Protocol (TCP/IP) type link). If the program guide implemented on interactive program guide television equipment 1700 is a client-server guide as shown in FIG. 2d, program guide server 2500 may obtain program guide data from Internet service system 6100. The program guide may also, however, obtain program guide data from Internet service system 61 via an Internet connection.

In another suitable arrangement, distribution equipment 2100 may include computer equipment or other suitable hardware on which a first portion or version of the interactive television program guide is implemented. A second portion or version of the program guide may be implemented on user television equipment 2200. The two versions or portions of the interactive program guide may communicate using any suitable peer-to-peer communications scheme (e.g., messaging, remote procedure calls, etc.) and perform interactive program guide functions distributively between television distribution facility 16 and user television equipment 2200.

Another suitable arrangement in which an on-line program guide is implemented on interactive program guide television equipment 1700 is shown in FIG. 2e. On-line program guide systems are described, for example, in Boyer et al. U.S. patent application Ser. No. 08/938,028, filed Sep. 18, 1997, which is hereby incorporated by reference herein in its entirety. The user may have personal computer (PC) 231 on which a program guide client or web browser is implemented. Personal computer 231 may be connected to Internet service system 235 via Internet link 233. Internet service system 233 may use any suitable combination of computer hardware and software capable of providing an on-line program guide server application or web site. Internet service system 235 is shown as obtaining program guide data from program guide distribution facility 1600. In other suitable approaches, Internet service system 235 may obtain information from other systems such as, for example, main facility 1200, local information service 1500, or any other suitable source of program guide data.

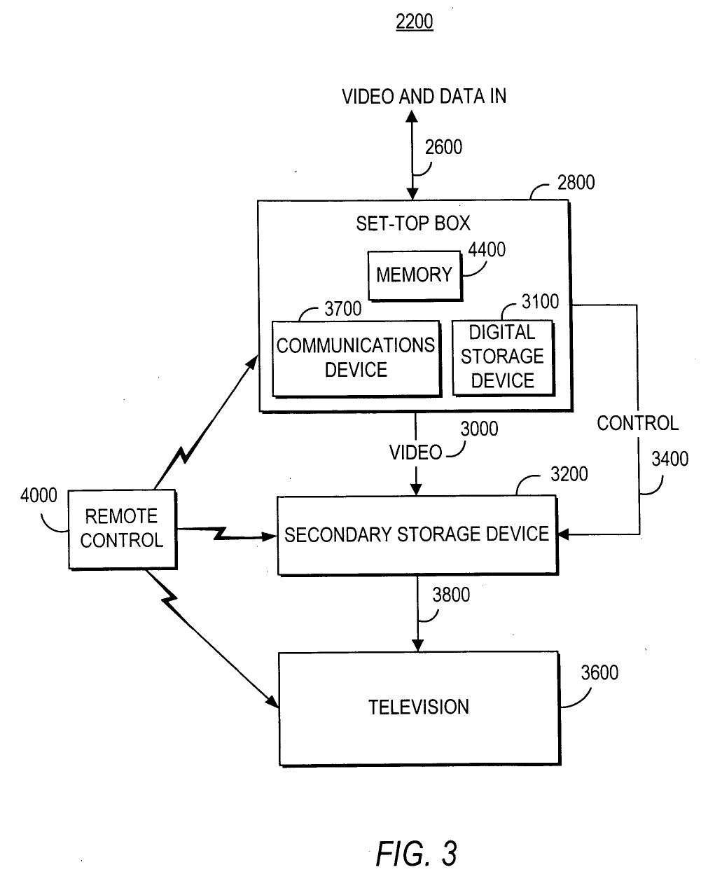

An illustrative arrangement for user television equipment 2200 is shown in FIG. 3. User television equipment 2200 of FIG. 3 receives video or a digital video stream and data from program guide distribution facility 1600 (FIG. 1), or some other suitable distribution facility, at input 2600. During normal television viewing, a user tunes set-top box 2800 to a desired television channel. The signal for that television channel is then provided at video output 3000. The signal supplied at output 3000 is typically either a radio-frequency (RF) signal on a predefined channel (e.g., channel 3 or 4), or a analog demodulated video signal, but may also be a digital signal provided to television 3600 on an appropriate digital bus (e.g., a bus using the Institute of Electrical and Electronics Engineers (IEEE) 1394 standard, (not shown)). The video signal at output 3000 is received by optional secondary storage device 3200.

The interactive television program guide may run on set-top box 2800, on television 3600 (if television 3600 has suitable processing circuitry and memory), on a suitable analog or digital receiver connected to television 3600, or on digital storage device 3100 if digital storage device 3100 has suitable processing circuitry and memory. The interactive television program guide may also run cooperatively on a suitable combination of these devices. Interactive television application systems in which a cooperative interactive television program guide application runs on multiple devices are described, for example, in Ellis U.S. patent application Ser. No. 09/186,598, filed Nov. 5, 1998, which is hereby incorporated by reference herein in its entirety.

Secondary storage device 3200 can be any suitable type of analog or digital program storage device or player (e.g., a videocassette recorder, a digital versatile disc (DVD) player, etc.). Program recording and other features may be controlled by set-top box 2800 using control path 3400. If secondary storage device 3200 is a videocassette recorder, for example, a typical control path 3400 involves the use of an infrared transmitter coupled to the infrared receiver in the videocassette recorder that normally accepts commands from a remote control such as remote control 4000. Remote control 4000 may be used to control set-top box 2800, secondary storage device 3200, and television 3600.

If desired, a user may record programs, program guide data, or a combination thereof in digital form on optional digital storage device 3100. Digital storage device 3100 may be a writeable optical storage device (such as a DVD player capable of handling recordable DVD discs), a magnetic storage device (such as a disk drive or digital tape), or any other digital storage device. Interactive television program guide systems that have digital storage devices are described, for example, in Hassell et al. U.S. patent application Ser. No. 09/157,256, filed Sep. 17, 1998, which is hereby incorporated by reference herein in its entirety.

Digital storage device 3100 can be contained in set-top box 2800 or it can be an external device connected to set-top box 2800 via an output port and appropriate interface. If necessary, processing circuitry in set-top box 2800 formats the received video, audio and data signals into a digital file format. Preferably, the file format is an open file format such as the Moving Picture Experts Group (MPEG) MPEG-2 standard or the Moving Joint Photographic Experts Group (MJPEG) standard. The resulting data is streamed to digital storage device 3100 via an appropriate bus (e.g., a bus using the Institute Electrical and Electronics Engineers (IEEE) 1394 standard), and is stored on digital storage device 3100. In another suitable approach, an MPEG-2 data stream or series of files may be received from. distribution equipment 2100 and stored.

Television 3600 receives video signals from secondary storage device 3200 via communications path 3800. The video signals on communications path 3800 may either be generated by secondary storage device 3200 when playing back a prerecorded storage medium (e.g., a videocassette or a recordable digital video disc), by digital storage device 3100 when playing back a pre-recorded digital medium, may be passed through from set-top box 2800, may be provided directly to television 3600 from set-top box 2800 if secondary storage device 3200 is not included in user television equipment 2200, or may be received directly by television 3600. During normal television viewing, the video signals provided to television 3600 correspond to the desired channel to which a user has tuned with set-top box 2800. Video signals may also be provided to television 3600 by set-top box 2800 when set-top box 2800 is used to play back information stored on digital storage device 3100.

Set-top box 2800 may have memory 4400. Memory 4400 may be any memory or other storage device, such as a random access memory (RAM), read only memory (ROM), flash memory, a hard disk drive, a combination of such devices, etc., that is suitable for storing program guide application instructions and program guide data for use by the program guide.

Set-top box 2800 may have communications device 3700 for communicating directly with distribution equipment 2100, program guide server 2500 or Internet service system 6100 over communications path 2000. Communications device 3700 may be a modem (e.g., any suitable analog or digital standard, cellular, or cable modem), network interface card (e.g., an Ethernet card, Token ring card, etc.), or other suitable communications device. Communications device 3700 may also be a personal computer with an Internet connection in, for example, the arrangement shown in FIGS. 2c and 2d. Television 3600 may also have such a suitable communications device if desired. In an alternative approach, user television equipment 2200 may communicate with Internet service system 6100 via distribution equipment 2100 using a suitable return path.

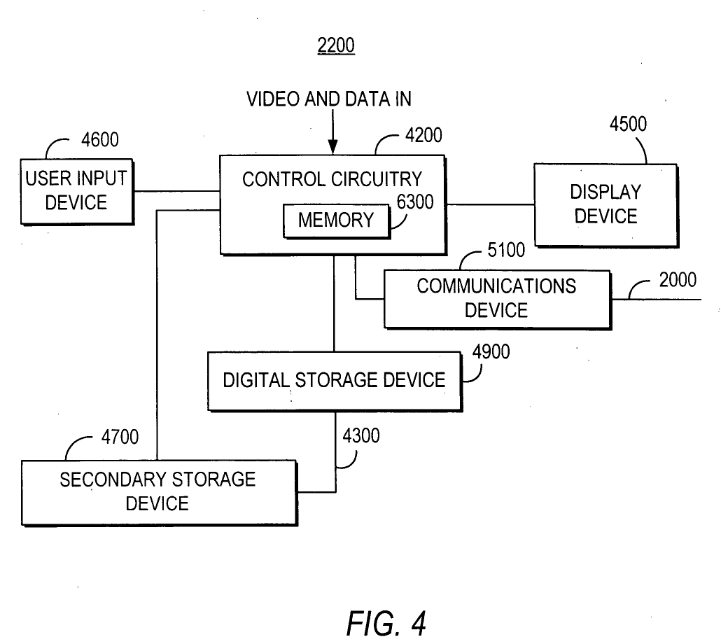

A more generalized embodiment of user television equipment 2200 of FIG. 3 is shown in FIG. 4. As shown in FIG. 4, program guide data from distribution facility 1600 (FIG. 1) is received by control circuitry 4200 of user television equipment 2200. The functions of control circuitry 4200 may be provided using the set-top box arrangement of FIGS. 2a and 2b. Alternatively, these functions may be integrated into an advanced television receiver, personal computer television (PC/TV), or any other suitable arrangement. If desired, a combination of such arrangements may be used.

User television equipment 2200 may also have secondary storage device 4700 and digital storage device 4900 for recording programming. Secondary storage device 4700 can be any suitable type of analog or digital program storage device (e.g., a videocassette recorder, a digital versatile disc (DVD), etc.). Program recording and other features may be controlled by control circuitry 4200. Digital storage device 4900 may be, for example, a writeable optical storage device (such as a DVD player capable of handling recordable DVD discs), a magnetic storage device (such as a disk drive or digital tape), or any other digital storage device.

User television equipment 2200 may also have memory 6300. Memory 6300 may be any memory or other storage device, such as a random access memory (RAM), read only memory (ROM), flash memory, a hard disk drive, a combination of such devices, etc., that is suitable for storing program guide application instructions and program guide data for use by control circuitry 4200.

User television equipment 2200 of FIG. 4 may also have communications device 5100 for supporting communications between the program guide and distribution equipment 2100, program guide server 25, or Internet service system 6100 via communications path 2000. Communications device 5100 may be a modem (e.g., any suitable analog or digital standard, cellular, or cable modem), network interface card (e.g., an Ethernet card, Token ring card, etc.), or other suitable communications device.

A user may control the operation of user television equipment 2200 with user input device 4600. User input device 4600 may be a pointing device, wireless remote control, keyboard, touch-pad, voice recognition system, or any other suitable user input device. To watch television, a user instructs control circuitry 4200 to display a desired television channel on display device 4500. Display device 4500 may be any suitable television, monitor, or other suitable display device. To access the functions of the program guide, a user instructs the program guide implemented on interactive television program guide equipment 1700 to generate a main menu or other desired program guide display screen for display on display device 4500.

Four illustrative user interface approaches are described below. While the four approaches are described separately, their features may be combined in any suitable way, modified in accordance with the other approaches, or performed instead of or in addition to the features of the approaches. For example, and not by way of limitation, the ad panels of some of the approaches may be combined with the navigational wheels or display regions of other approaches. The anchor bars may be interchanged where suitable. Any other suitable combination, substitution or exchange of features between the interface approaches described herein, or with any other suitable interface approach, may be used.

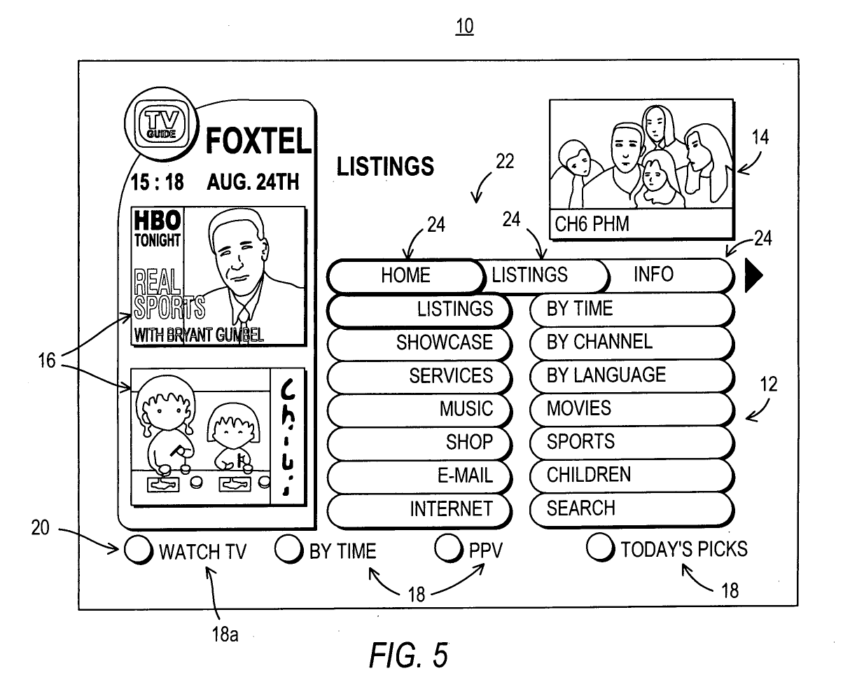

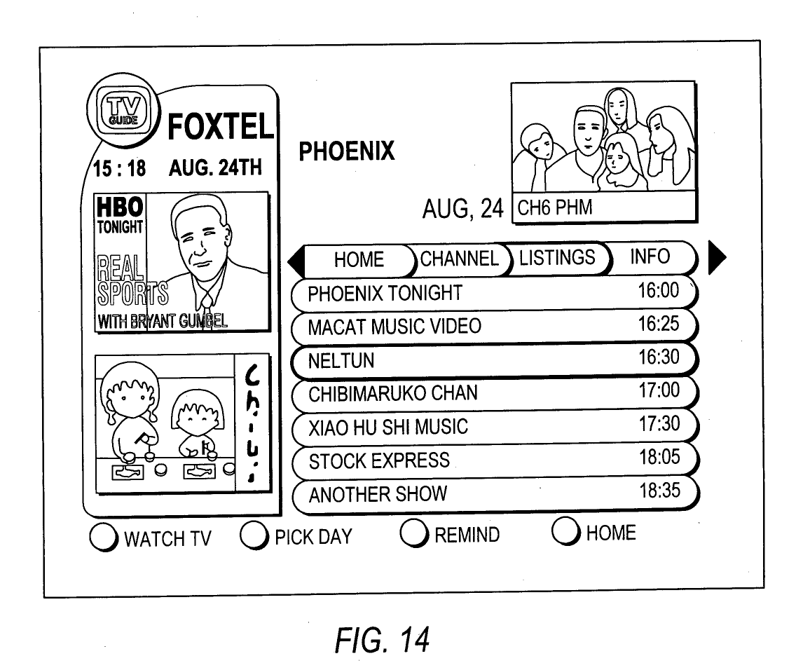

A first user interface approach in accordance with the present invention is shown in FIGS. 5-32. This approach is described, for example, in Vogh et al. U.S. provisional patent application Ser. No. 60/156,111, filed Sep. 24, 1999, which is hereby incorporated by reference herein in its entirety. An illustrative screen 10 that may be displayed by the program guide of the present invention is shown in FIG. 5. Screen 10 may be displayed when a user first invokes the program guide. Screen 10 may contain various options 12. Screen 10 may also contain a picture-in-guide window 14 that contains video for the television program on the channel to which the set-top box is currently tuned. Interactive advertisements 16 may also be displayed as part of screen 10. If desired, advertisements 16 may be passive.

Screen 10 may contain options 18 for various program guide functions. The user may select a desired one of options 18 by pressing a color-coded key on the remote control. The color of the key may match the color of the dot 20 that is associated with the option. For example, the watch TV option 18a may have an associated dot 20 that is blue. When the user presses a corresponding blue key on the remote control, the program guide may perform function 18a. In the example of FIG. 5, function 18a directs the program guide to cease displaying screen 10, so that the user may return to the television program on the channel to which the set-top box is currently tuned (i.e., watch television (TV)). The color-coded buttons on the remote control may be the same as those that are sometimes used in certain countries to access teletext functions. Any suitable type of coding may be used if desired. Color coding is merely an example.

Another feature shown in FIG. 5 relates to anchor bar 22. Anchor bar 22 contains a number of tabs 24 that correspond to different functions in the program guide hierarchy. As will be made clear from subsequent FIGS., the number of tabs 24 that are displayed and the content of the tabs 24 that are displayed may be context-sensitive. In the example of FIG. 5, the leftmost tab 24 corresponds to “home” and the tabs 24 to the right correspond to “listings” and “info.” The home tab 24 is highlighted indicating that the user is currently in the home location in the program guide. As the user navigates through the guide, different tabs may be highlighted to indicate the user's location in the guide. The highlighting of tab 24 and other display elements may include, for example, changing its letters from hollow to filled, outlining the display elements in heavier-weight outlines, changing their colors, or using any other suitable approach. The tabs may be arranged hierarchically, so that the highest level tab is displayed at the left and the lowest level (i.e., most detailed) tab is displayed on the right.

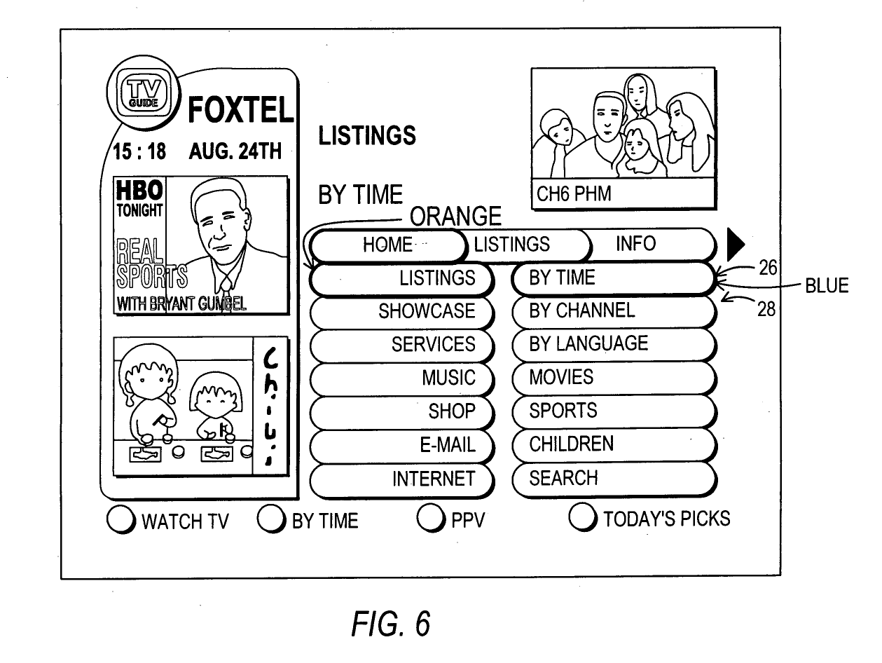

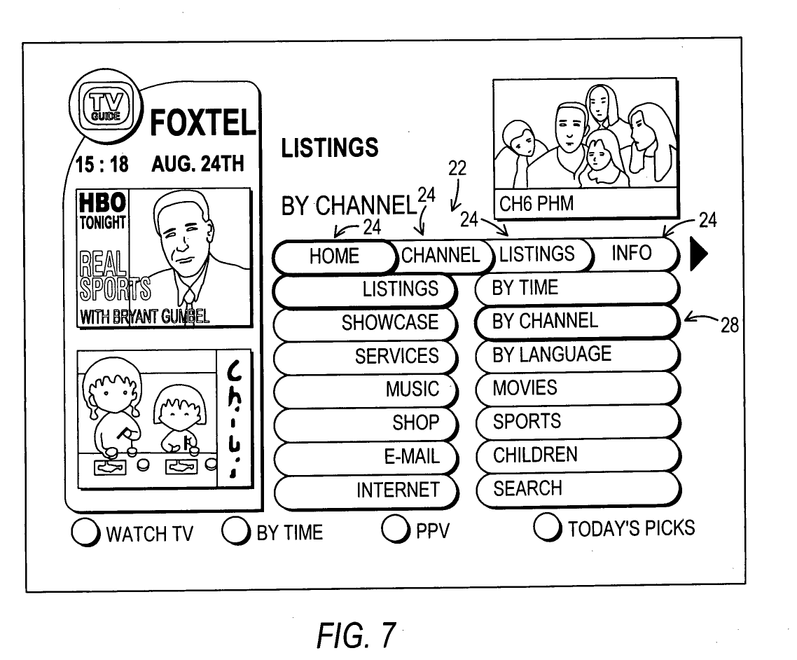

The user may move to by time option 26 by pressing a right arrow key on the remote control or by pressing select (or pressing enter or pressing OK, etc.), as shown in FIG. 6. The selected option (listings) may be displayed in a different color (e.g., orange) than the other options, or otherwise highlighted. The inactive options (e.g., the options in the left column) may be darkened relative to the active options (e.g., the options in the right column) to show that they are inactive. The user may move from by time option 26 to by channel option 28 by pressing a down arrow key on the remote control. This is shown in FIG. 7.

As shown in FIG. 7, when the user presses the down arrow key, the program guide may dynamically change anchor bar 22 to accommodate a different number of tabs 24 (e.g., four) when appropriate. This allows the anchor bar 22 to be used to display information on a relatively greater number of tabs when it is necessary to convey more information and on relatively fewer tabs when it is not necessary to convey as much information and when it is desired to reduce visual clutter on the anchor bar 22. The home tab 24, listings option 30, and by channel option 28 may be highlighted to show the user's location in the guide.

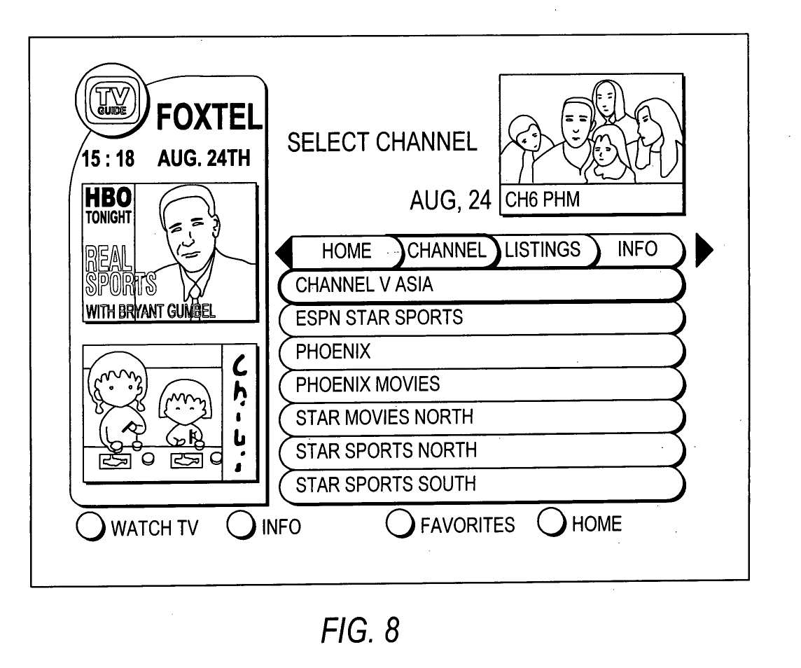

Pressing a right arrow key or select button when the by channel option 28 is highlighted directs the program guide to display the screen of FIG. 8. Note how the channel tab is highlighted.

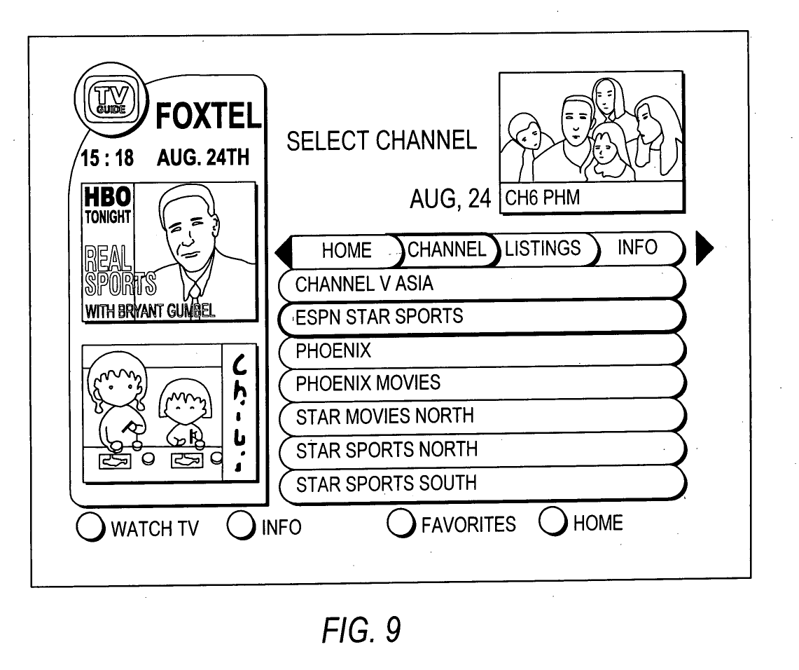

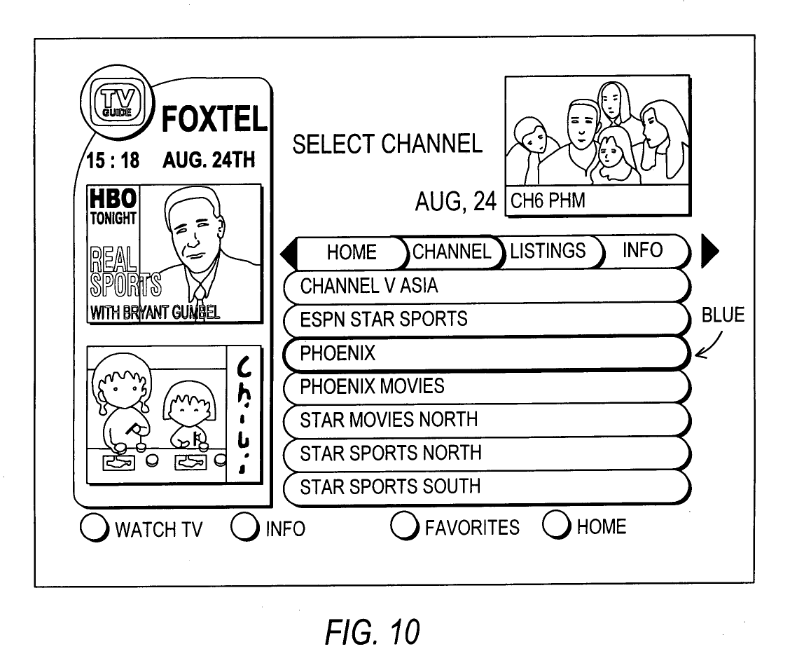

The user may select the Phoenix channel by pressing a down arrow key a first time to move the highlight to ESPN, as shown in FIG. 9, and pressing the down arrow key a second time to move the highlight to Phoenix, as shown in FIG. 10. Options and other items in the program guide may be highlighted using any suitable technique. For example, items may be highlighted by displaying them in a different or more intense color, by surrounding a given item with a border, by cross-hatching or shading the highlighted item differently than other items, by placing a pointer adjacent to an item, etc. For clarity, the present discussion will focus on one illustrative example—highlighting options using color changes.

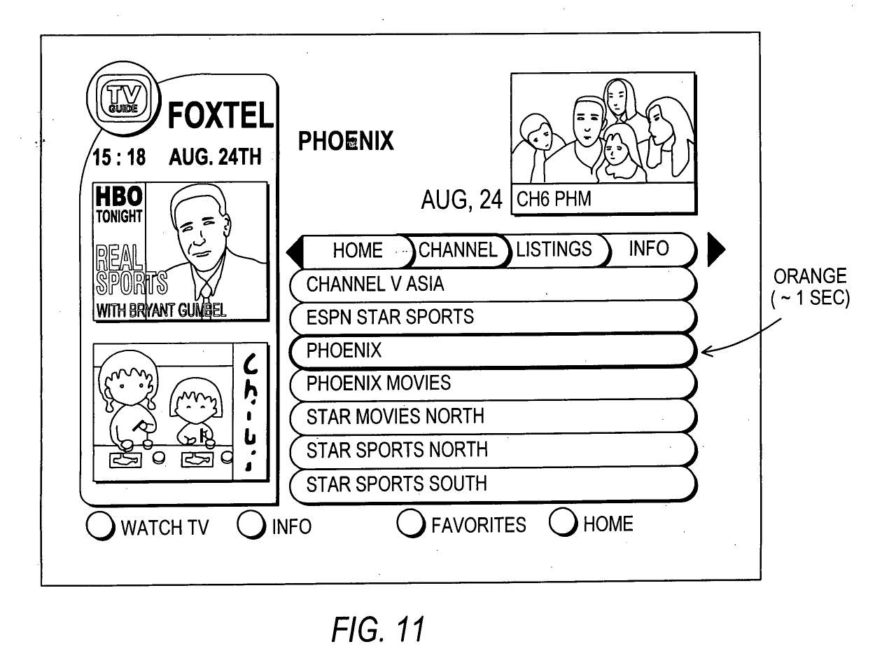

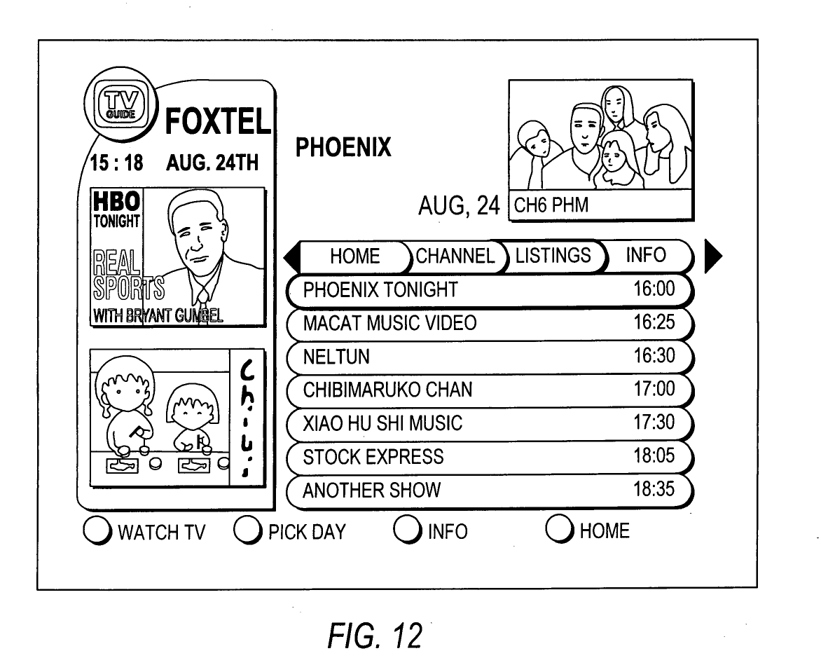

In FIG. 10, the highlighted channel listing (Phoenix) is highlighted in light blue. The light blue color stands out from the rest of the channel listings, which may be displayed in dark blue. When the user selects the Phoenix option or when the user presses a right arrow key, the program guide momentarily (e.g., for a second or so) changes the color of the Phoenix entry from light blue to orange, as shown in FIG. 11. After the momentary display of the orange-highlighted Phoenix listing of FIG. 11, the program guide proceeds to display the program listings for the Phoenix channel, as shown in FIG. 12. This feature, whereby a highlighted option is further highlighted or denoted with a special color after it has been selected may be referred to as a “sticky” highlight. The sticky highlight feature helps reassure that user that the user's choice was properly made, before the selected function is performed.

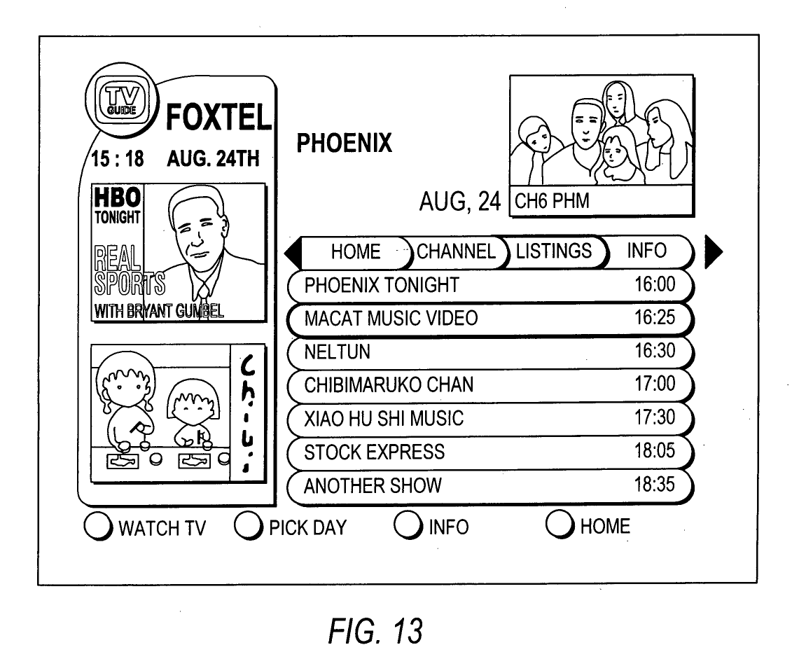

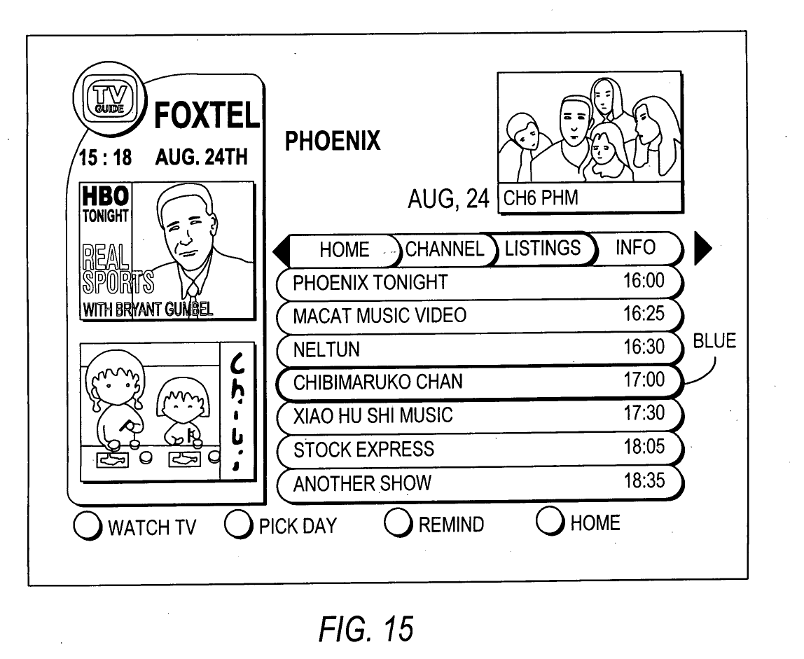

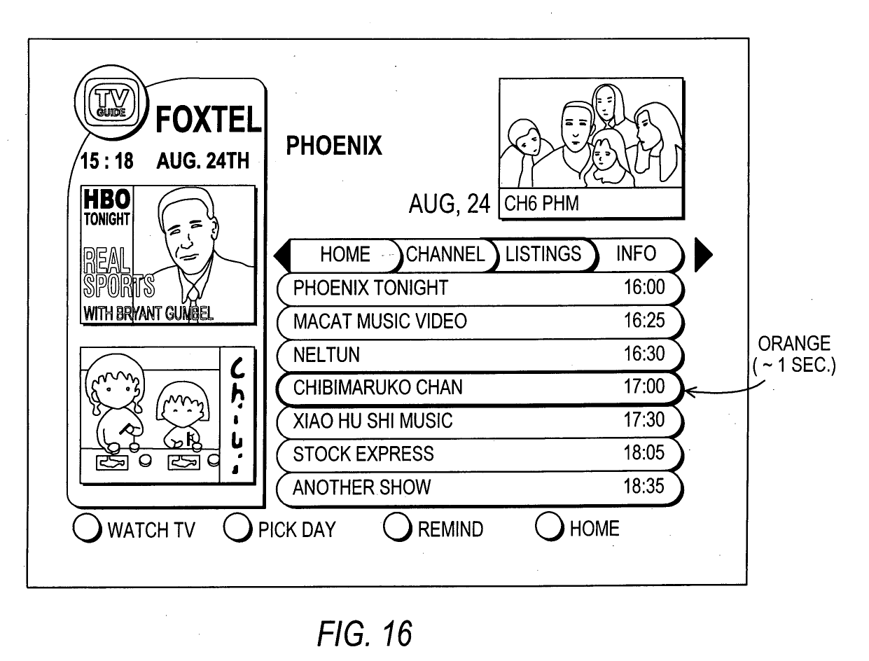

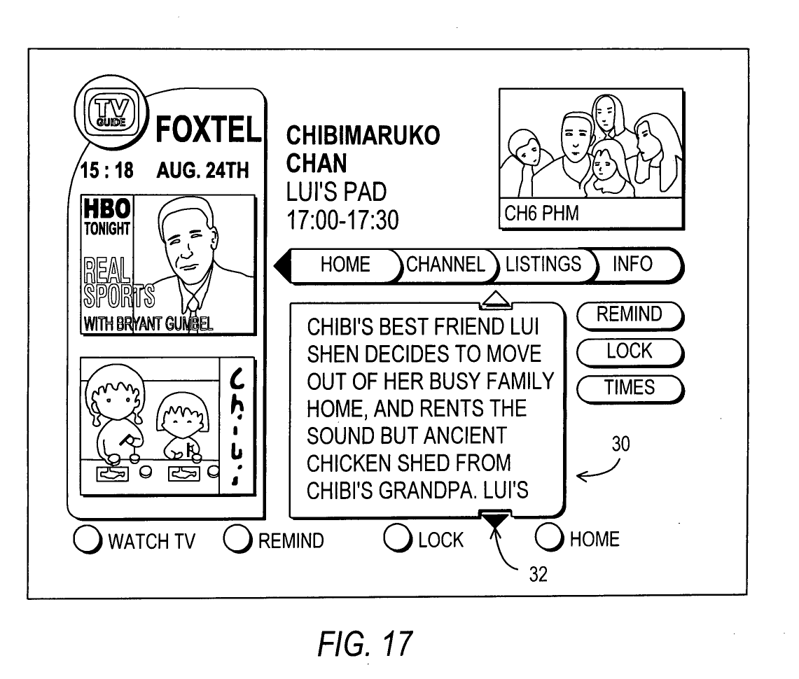

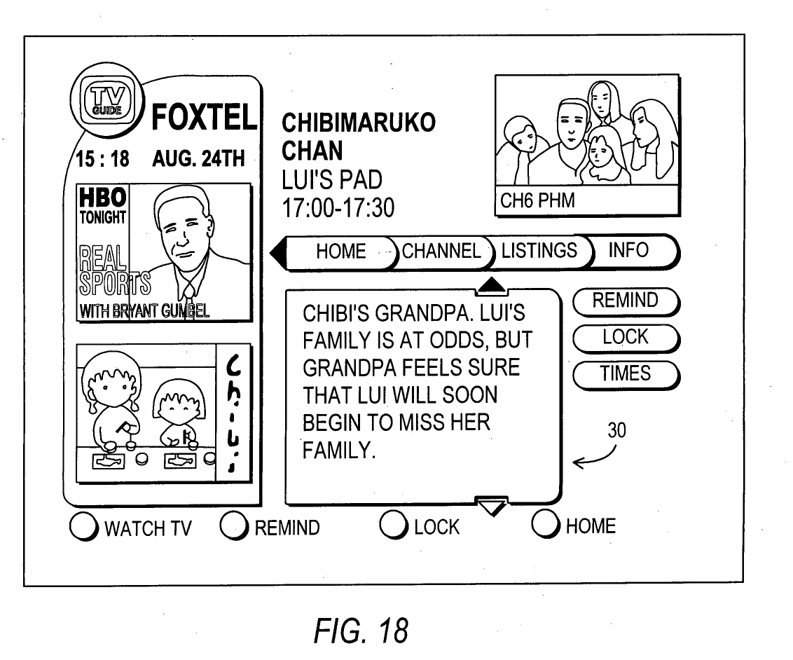

FIGS. 13, 14, and 15 show how the user may navigate to the program listing “Chibimaruko Chan” using the down arrow key. If the user then presses the right arrow key, the program guide may momentarily change the highlight color of the program listing for Chibimaruko Chan from blue (FIG. 15) to orange (FIG. 16) and then may automatically display the screen of FIG. 17, which contains information region 30. Information region 30 may contain detailed information on the selected program (“Chibimaruko Chan”). Arrow 32 indicates that the user may press a down arrow key to see more information, as shown in FIG. 18.

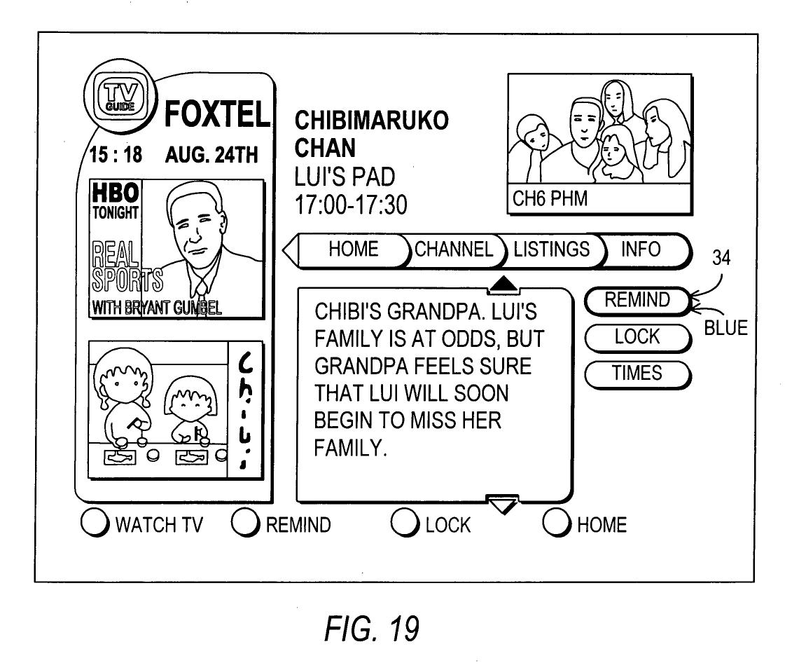

As shown in FIG. 19, the user can arrow right to highlight reminder option 34 to set a reminder.

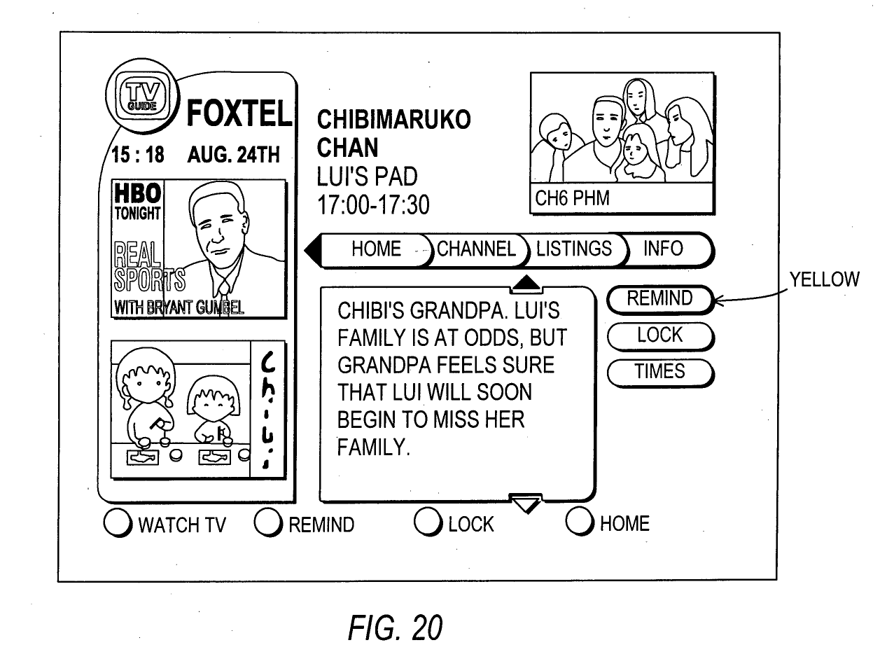

FIG. 20 shows an example of the how the program guide may handle situations in which the highlight region remains on top of a selection after it is made. In FIG. 19, the remind option is blue because it is highlighted. In FIG. 20, after the user has pressed select on the remote control to select the remind option, the program guide displays the remind option in yellow. This indicates that the highlight region is still located on the remind option and indicates that the remind option has been selected.

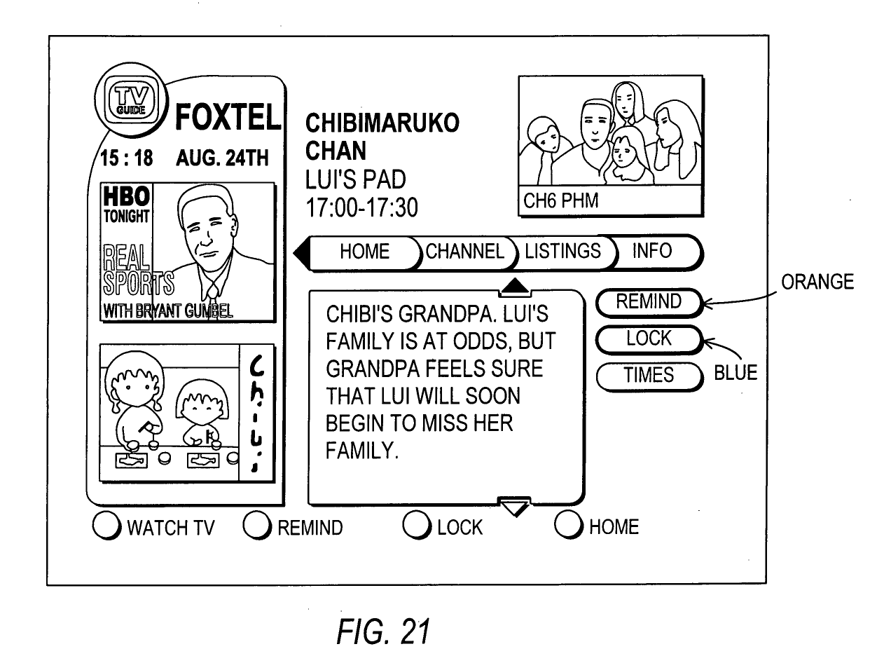

As shown in FIG. 21, if the user arrows down from the remind option, the program guide may display the remind option in orange to indicate that the remind option has been selected (but is no longer highlighted and selected) and may display the lock option in light blue to indicate that the lock button is highlighted.

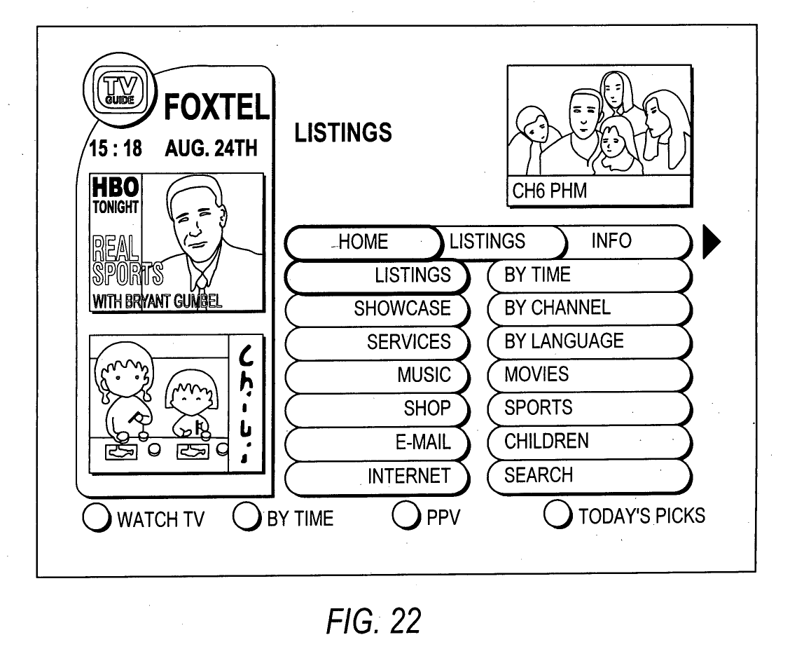

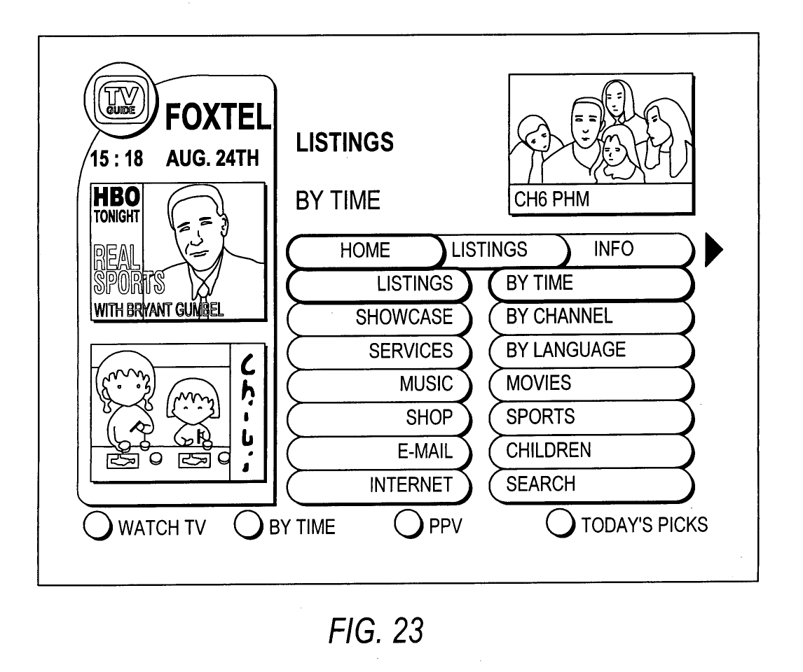

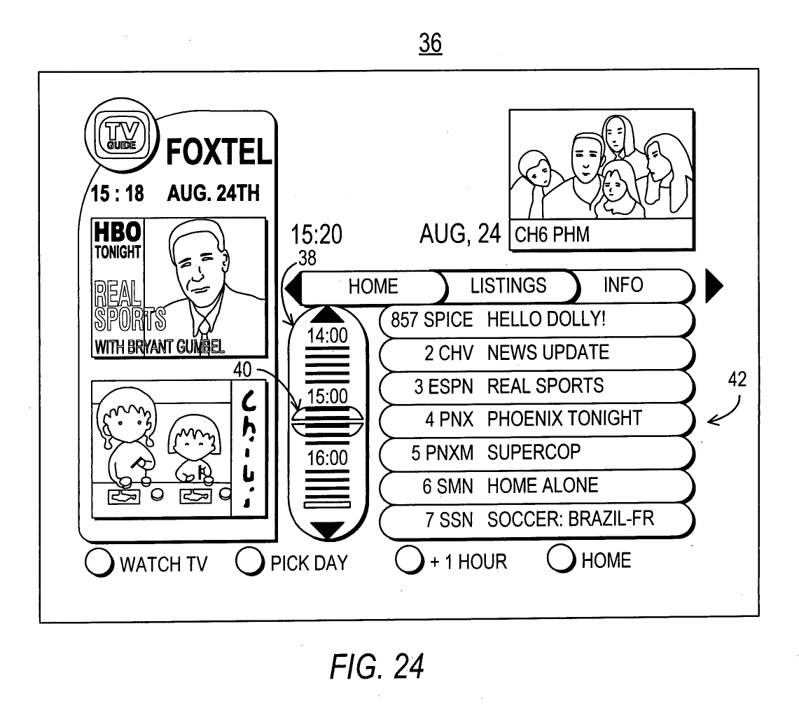

In FIG. 22, the user is at the home position. The user may select the by time option by arrowing right to highlight the by time option as shown in FIG. 23. When the user selects the by time option, the program guide displays by time screen 36 of FIG. 24. By time screen 36 contains a graphical display region 38 that visually represents the time period in which the user is interested. In graphical display region 38, times (14:00, 15:00, 16:00) are separated by dark segments that represent 10 minute increments. If desired, the middle segment between successive hours may be increased in size to mark the half-way point between the hours. Graphical display region 38 may contain a highlight region 40 (in, for example, light blue) that indicates (by its vertical midpoint) the precise time that the user is interested in. The user may position highlight 40 using up and down arrow keys. Because the segments separating the hours have 10 minute increments, the arrangement of FIG. 24 is appropriate for selecting times of interest to an accuracy of 10 minutes. This is particularly advantageous in countries that do not schedule all of their programming to begin at the top and bottom of the hour. In such countries, programs may begin at various times around the hour (e.g., 14:10, 14:17, etc.). Using highlight 40, the user may select a start time for the by time screen 36 of, for example, 15:20, as shown in FIG. 24. The corresponding listings for that time are displayed in program listings region 42.

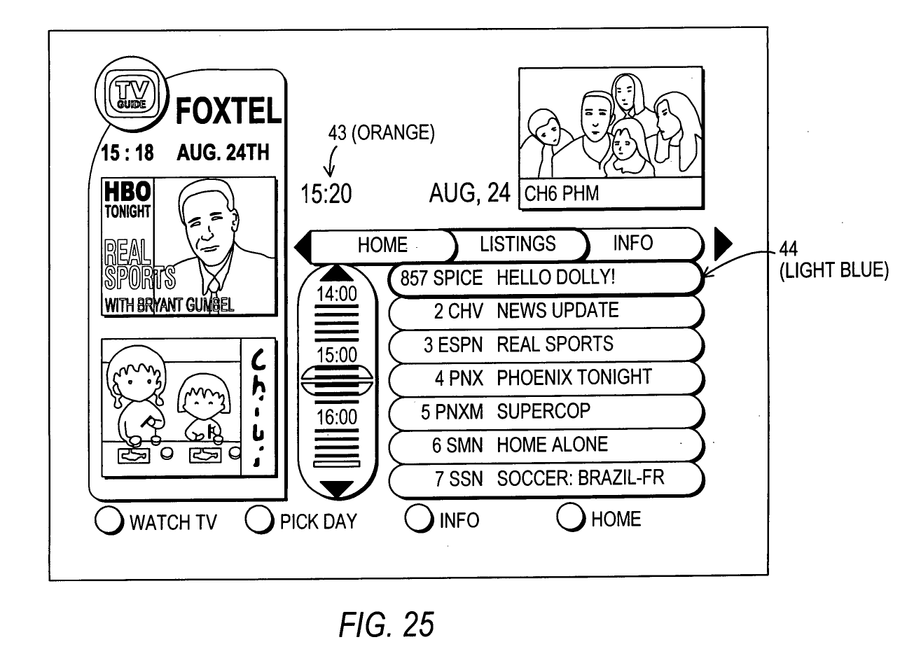

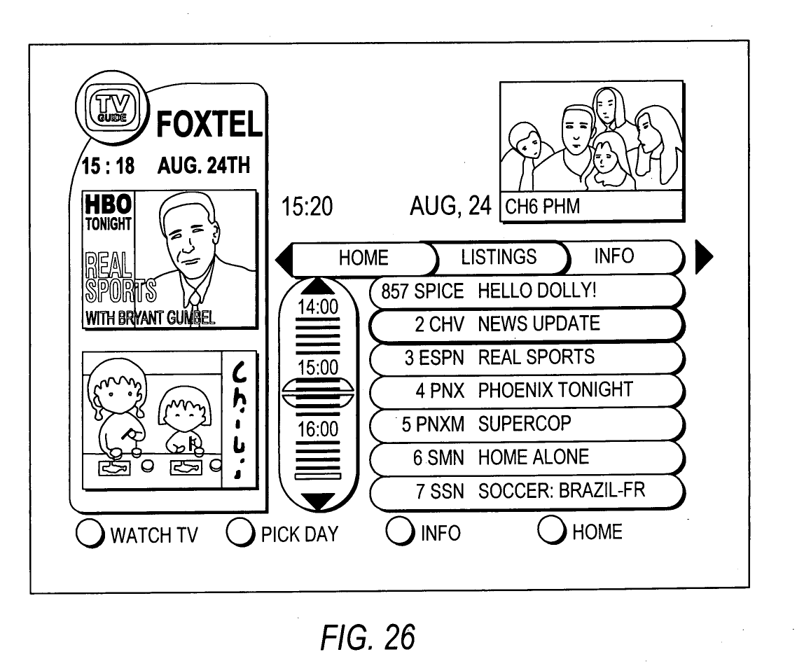

As shown in FIG. 25, the user may select a desired listing by arrowing to the right. This directs the program guide to display time information 43 in orange to indicate that a time of interest has been selected. The highlighted listing 44 may be displayed in light blue. FIG. 26 illustrates how the user may scroll through listings.

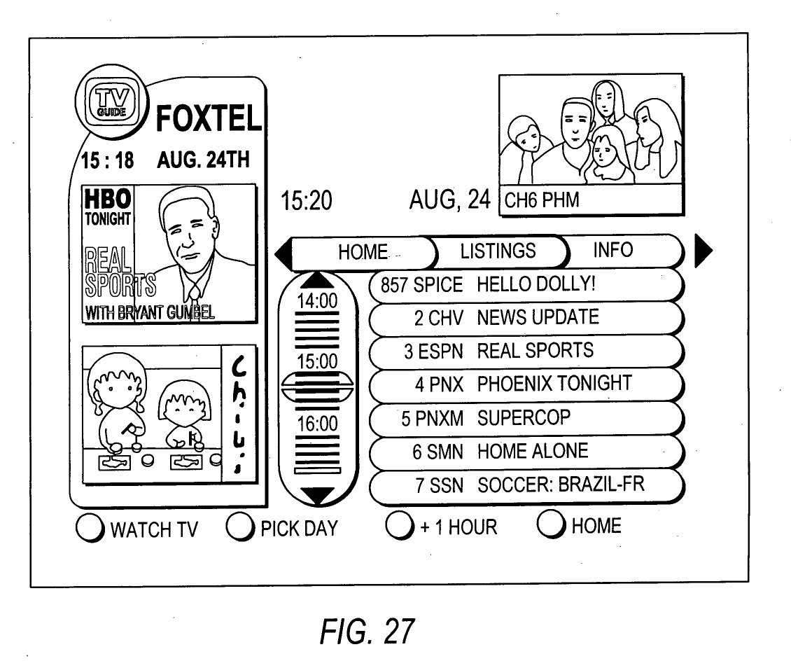

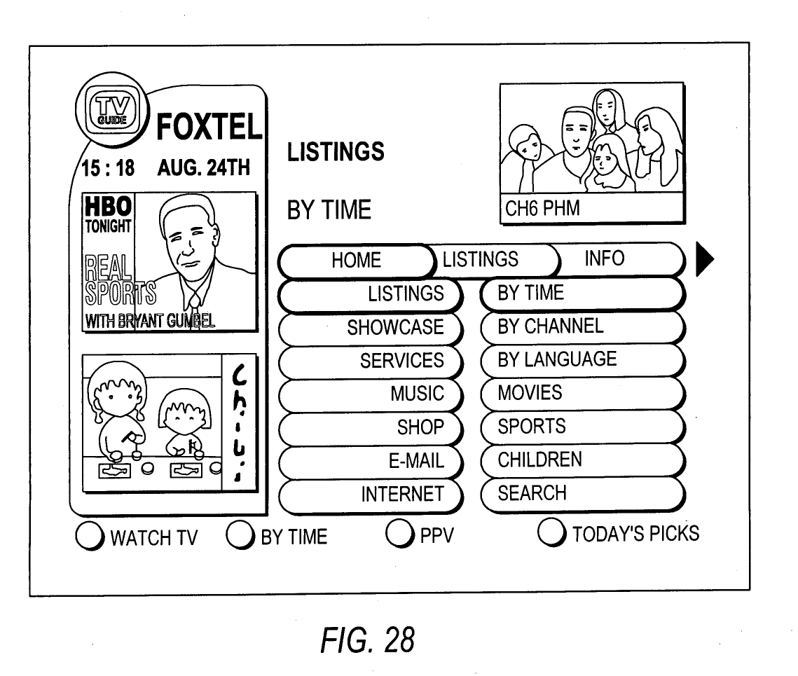

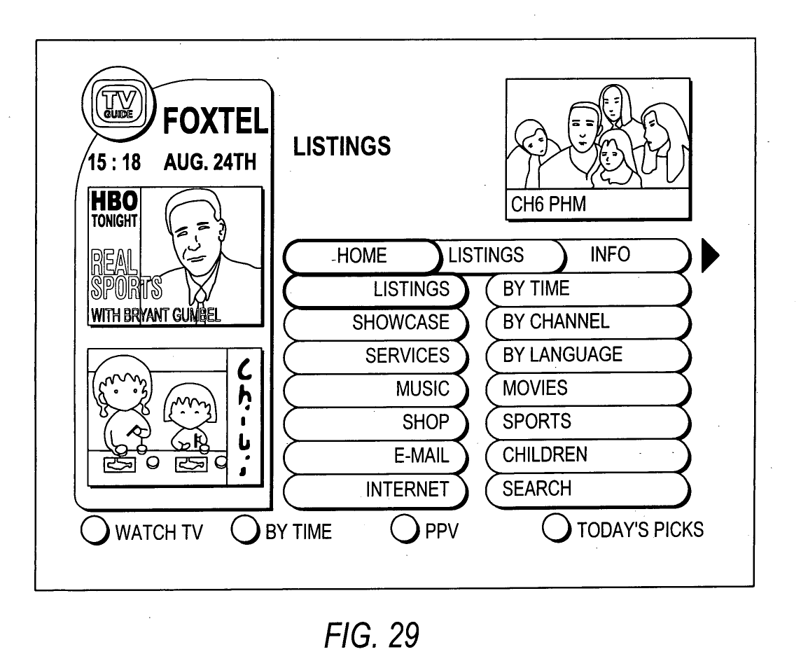

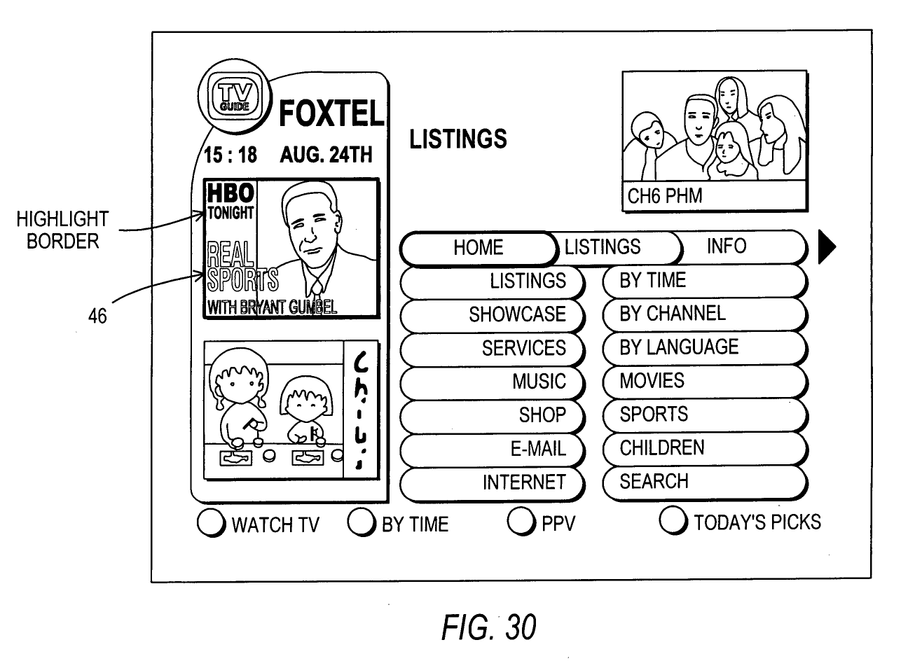

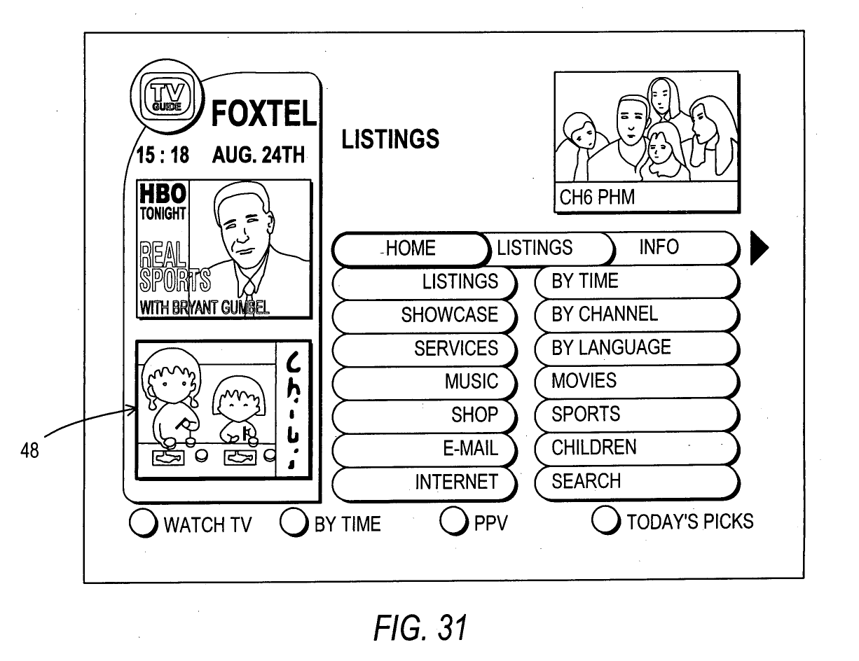

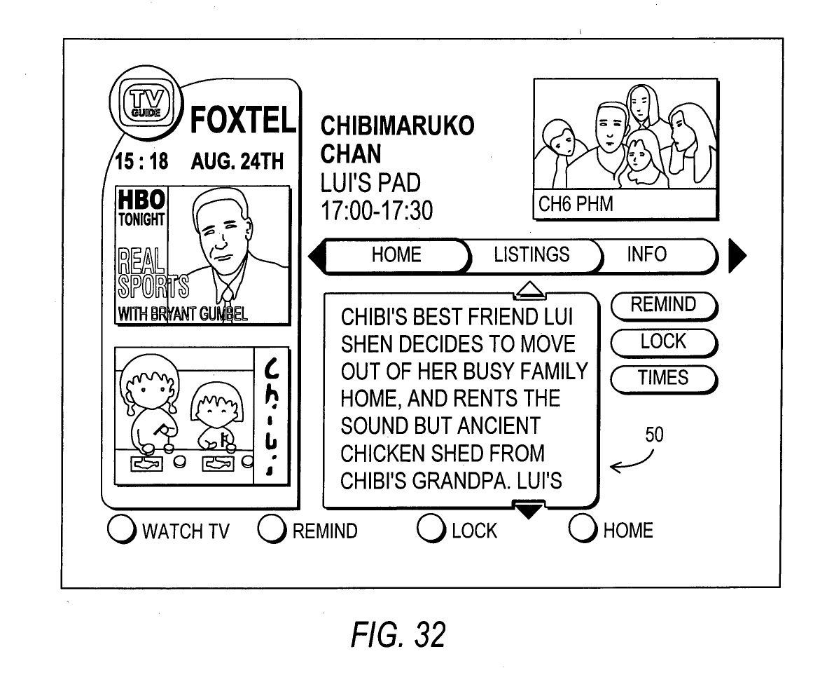

If the user arrows to the left, the program guide may display the screen of FIG. 27. If the user arrows left from the screen of FIG. 27, the user is presented with the screen of FIG. 28. Pressing a left arrow key once more directs the program guide to display the screen of FIG. 29. From the screen of FIG. 25, the user may reach advertisement 46 by arrowing left again, as shown in FIG. 30. If the user arrows down, the program guide highlights the lower advertisement—advertisement 48, as shown in FIG. 31. If the user presses select when the user has highlighted an advertisement, the program guide may display advertising information related to the advertisement such as advertising information 50 of FIG. 32. If desired, the space normally used by the upper advertisement may be replaced (e.g., by additional information relating to the selected advertisement, etc.). If desired, selecting the interactive advertisements may direct the program guide to provide an opportunity to purchase a pay-per-view program, purchase a premium service, purchase a product related to the advertisement, or provide any other suitable e-commerce rebate feature.

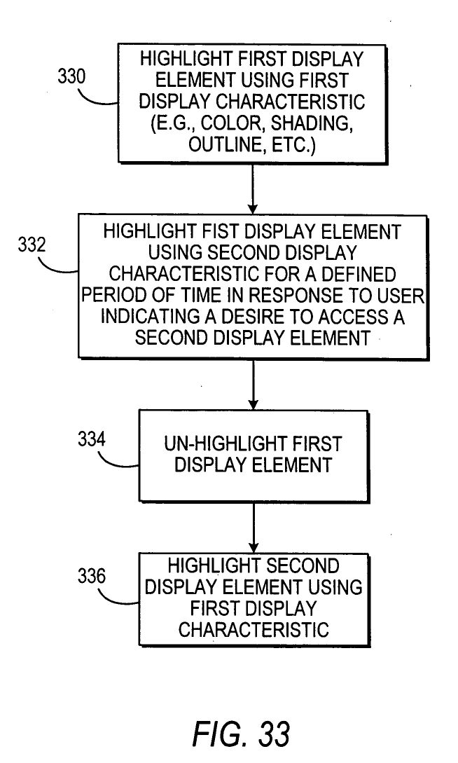

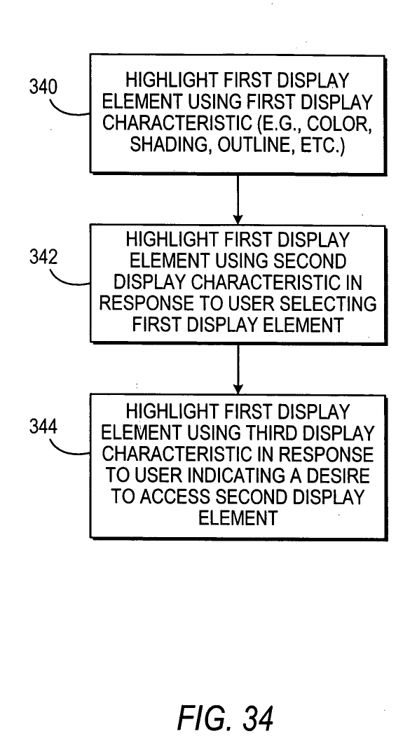

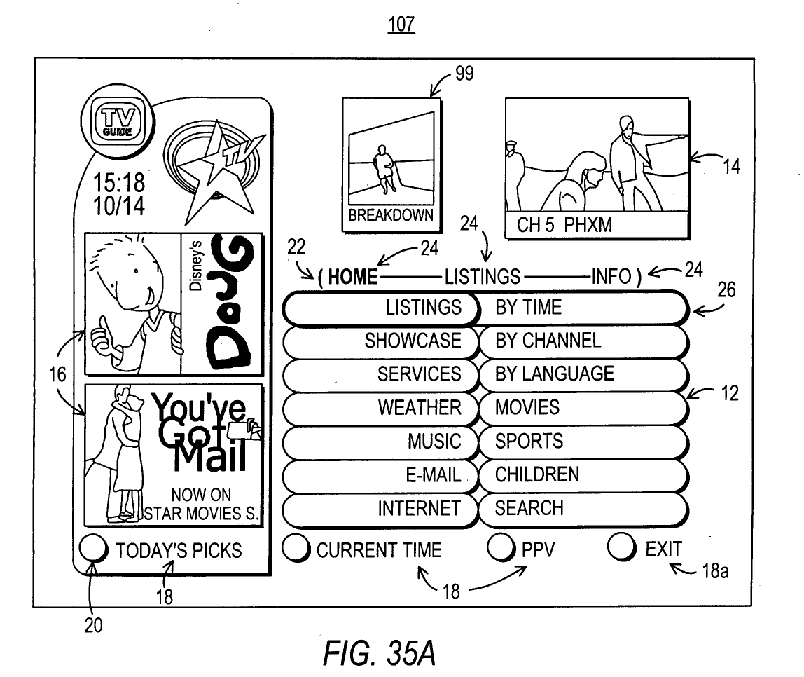

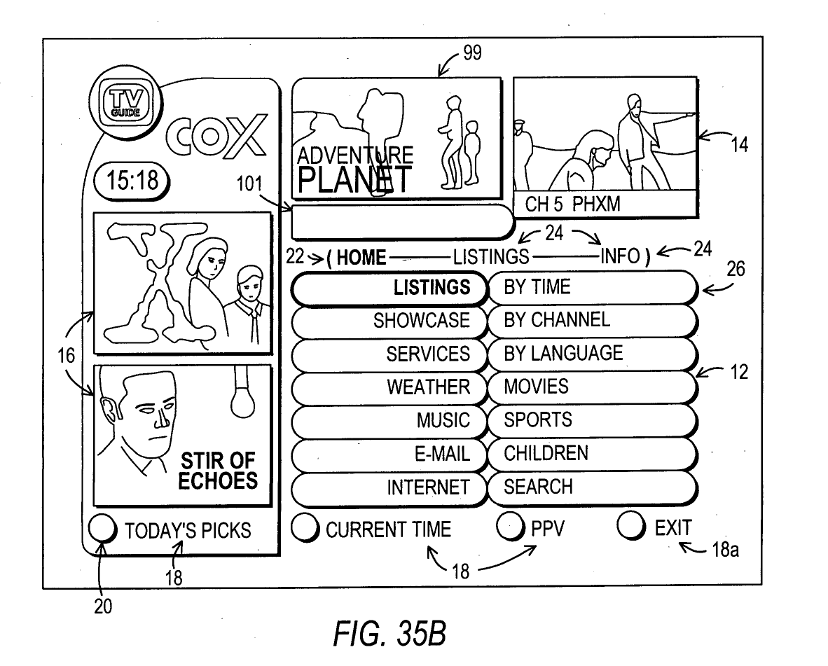

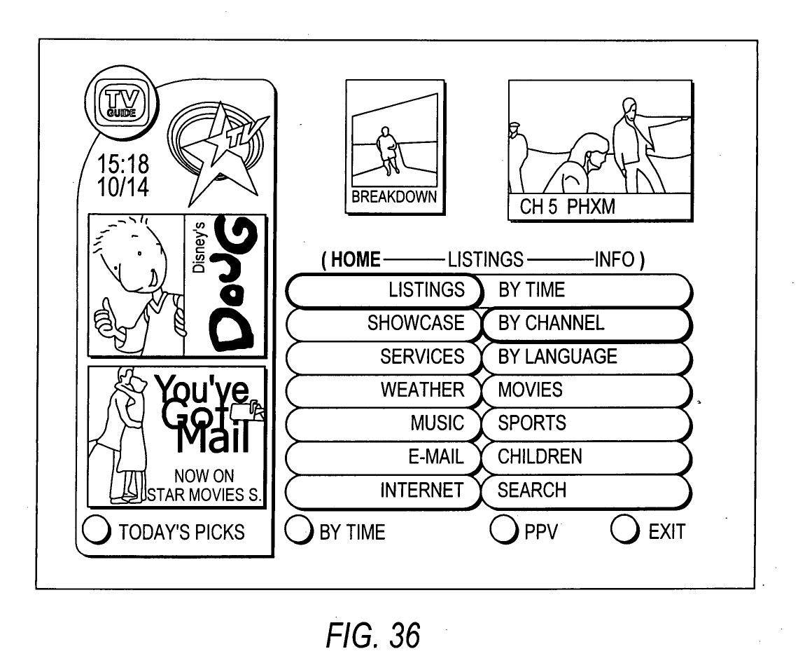

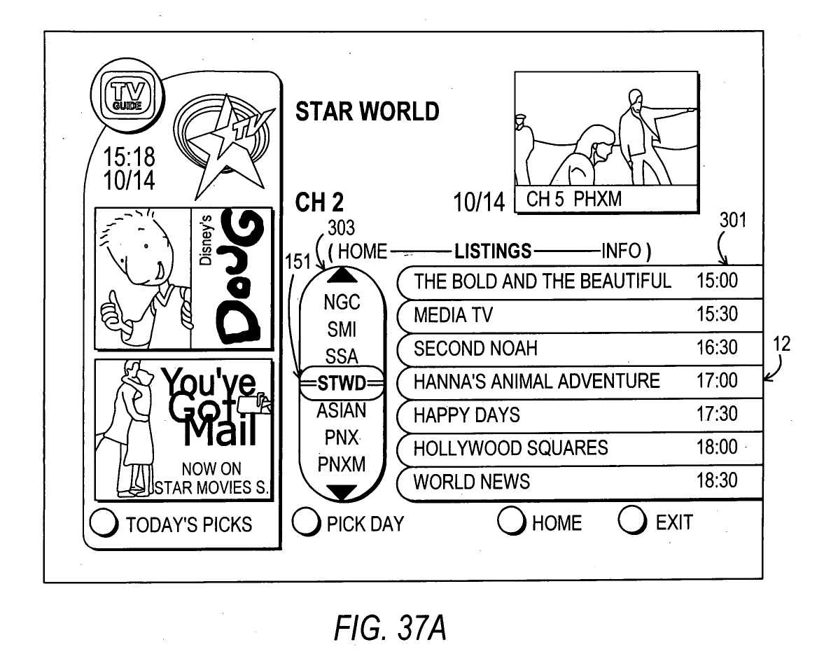

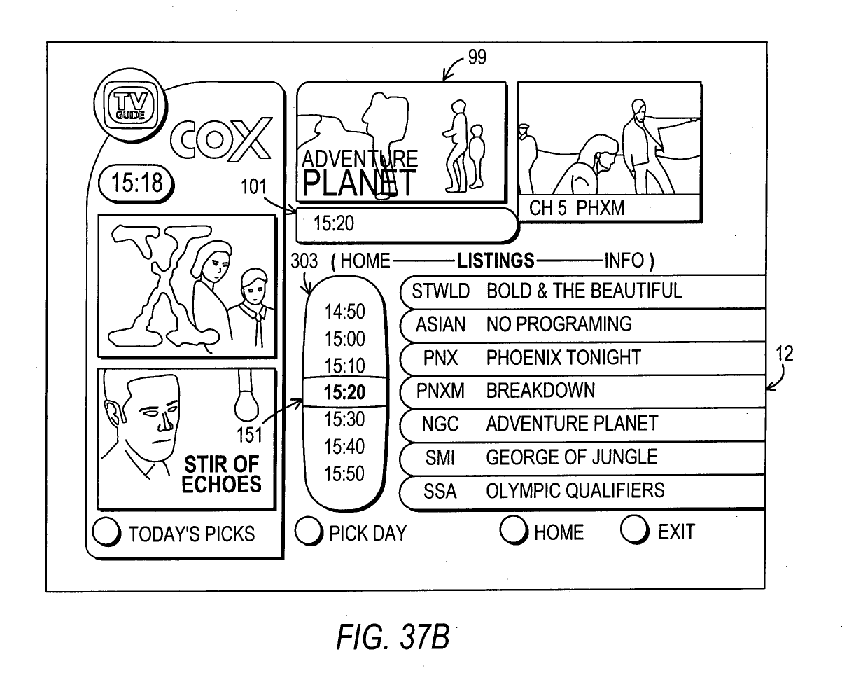

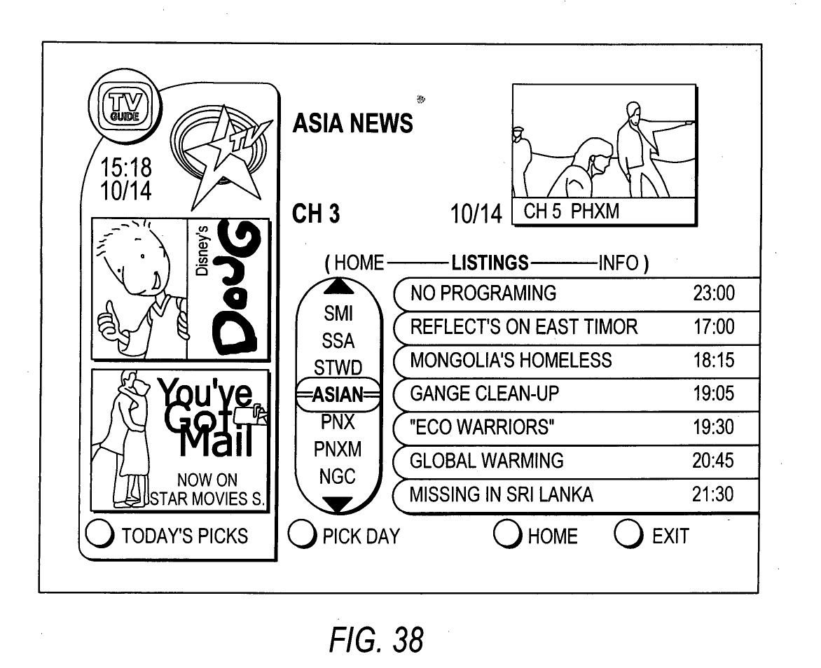

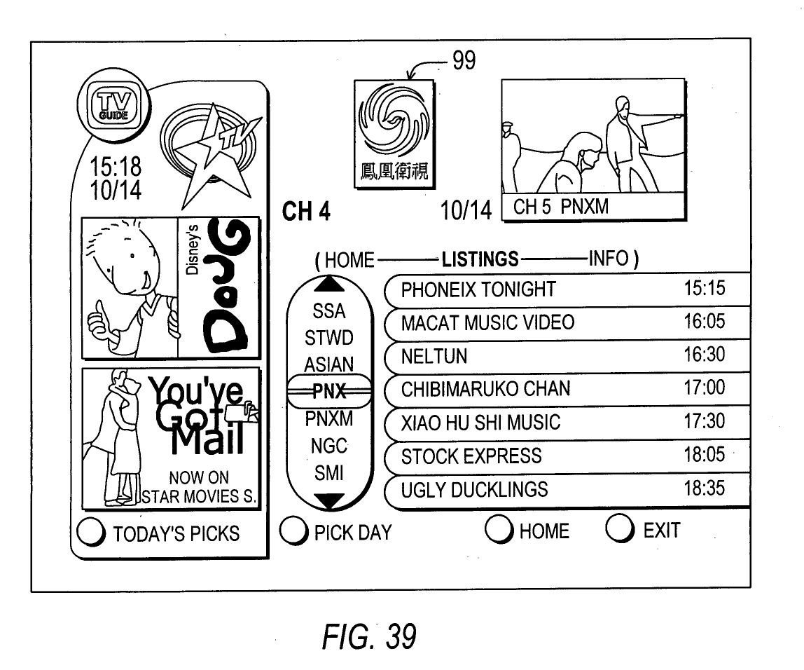

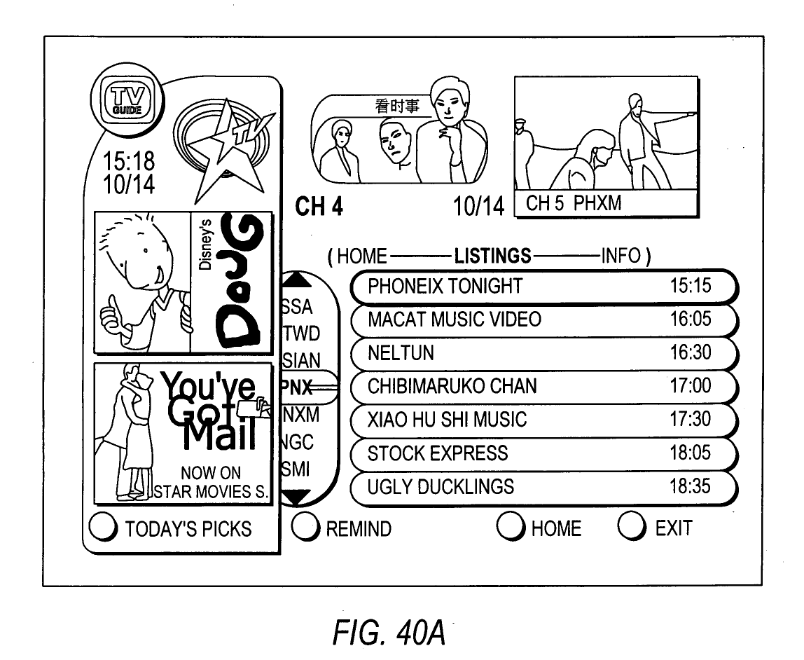

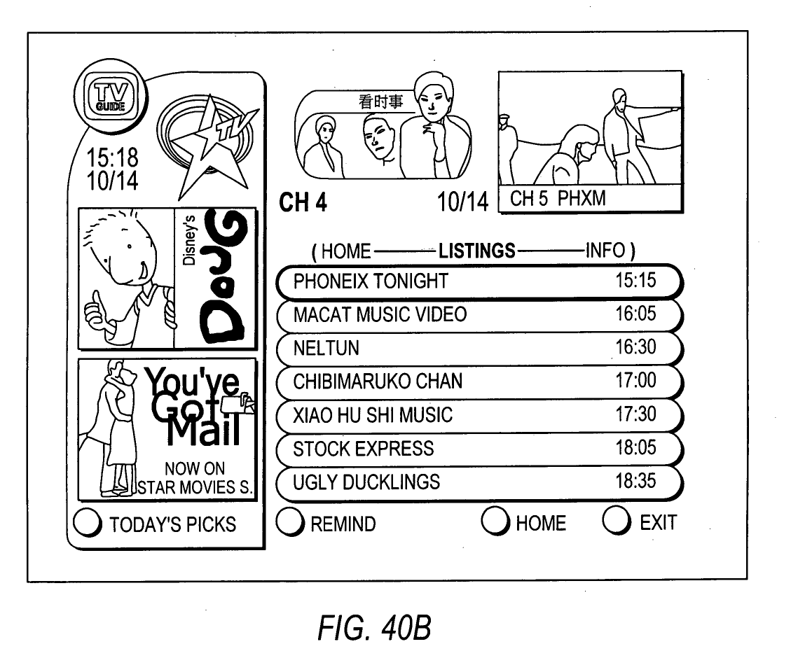

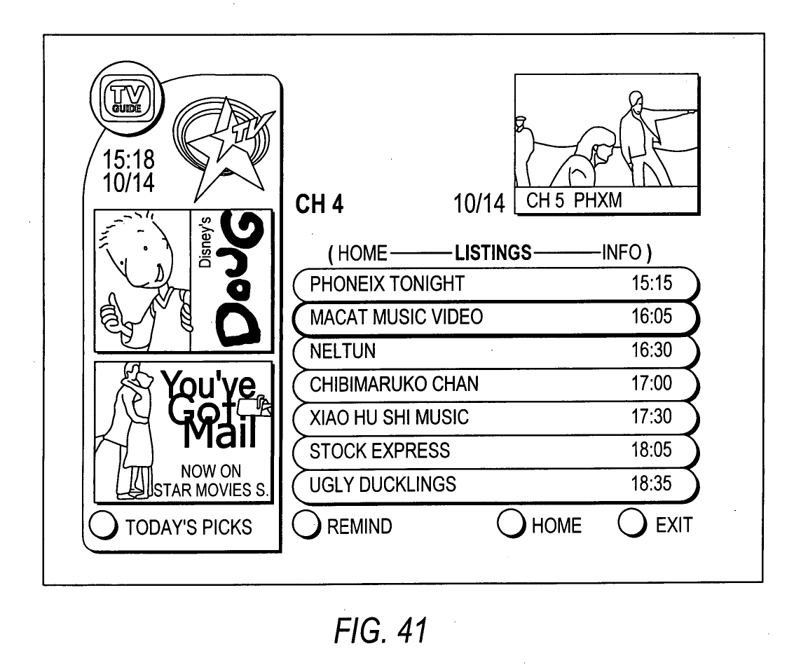

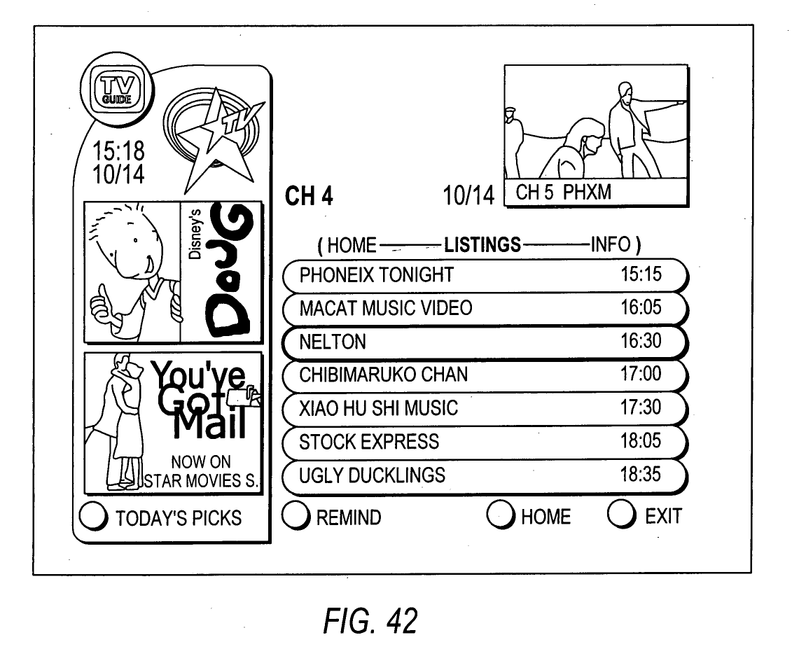

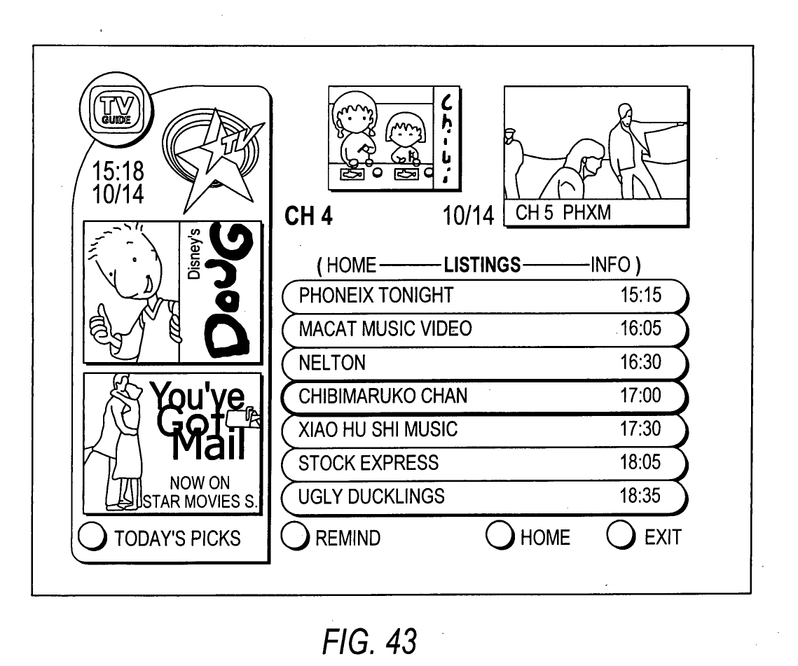

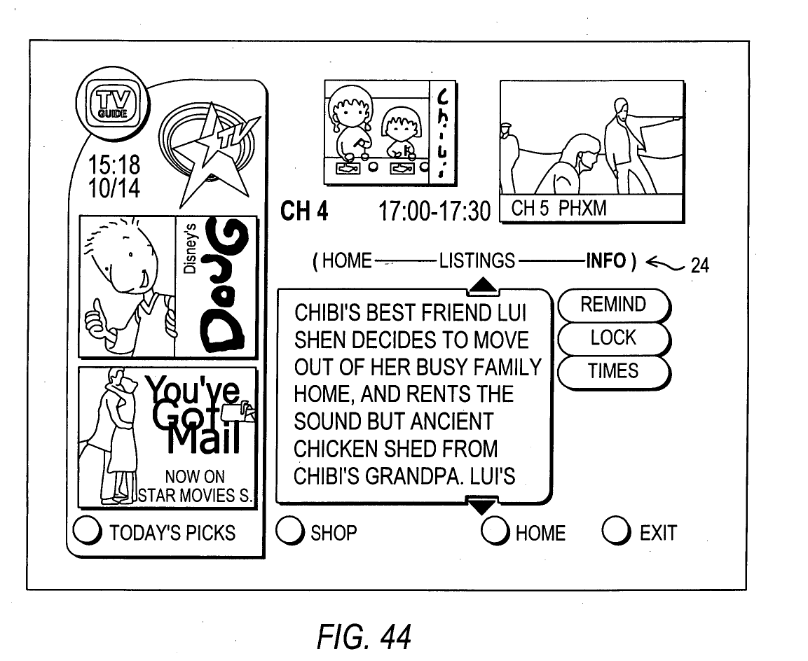

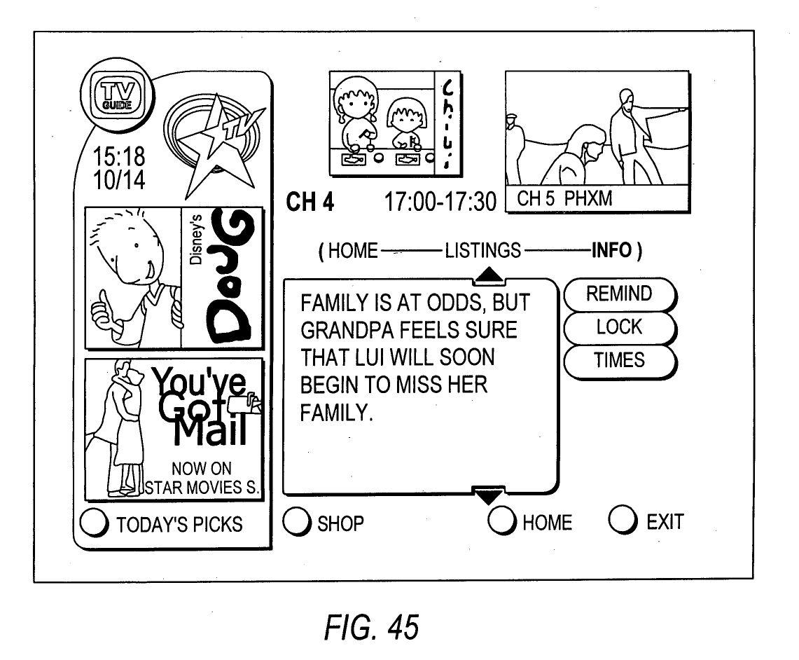

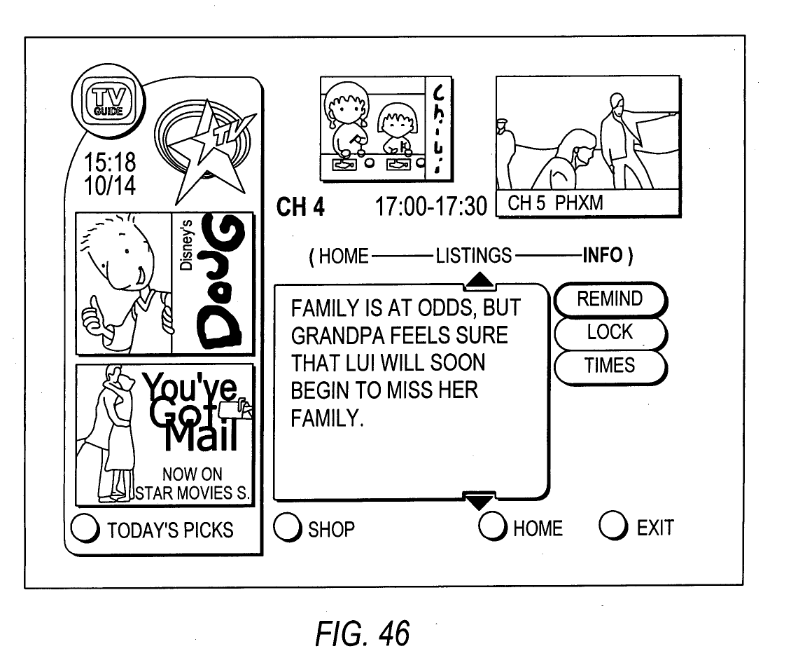

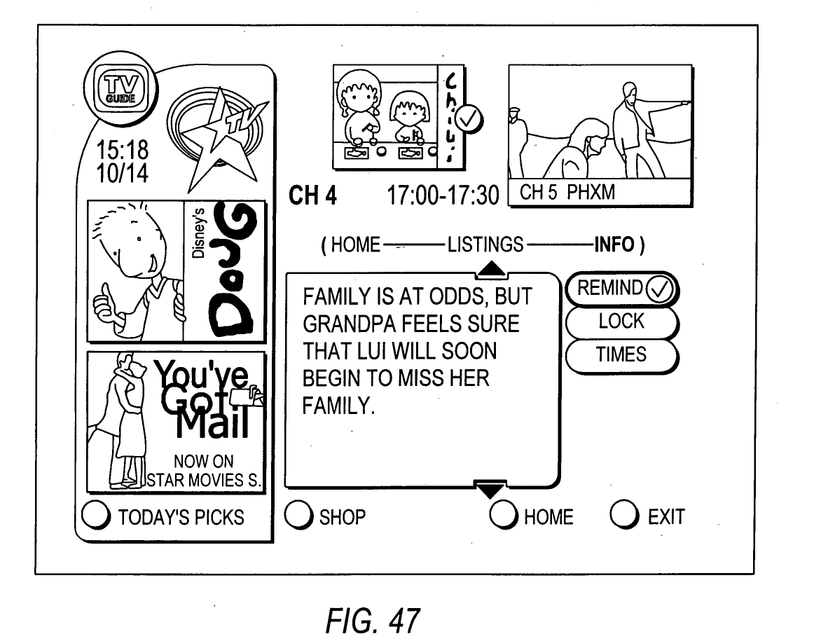

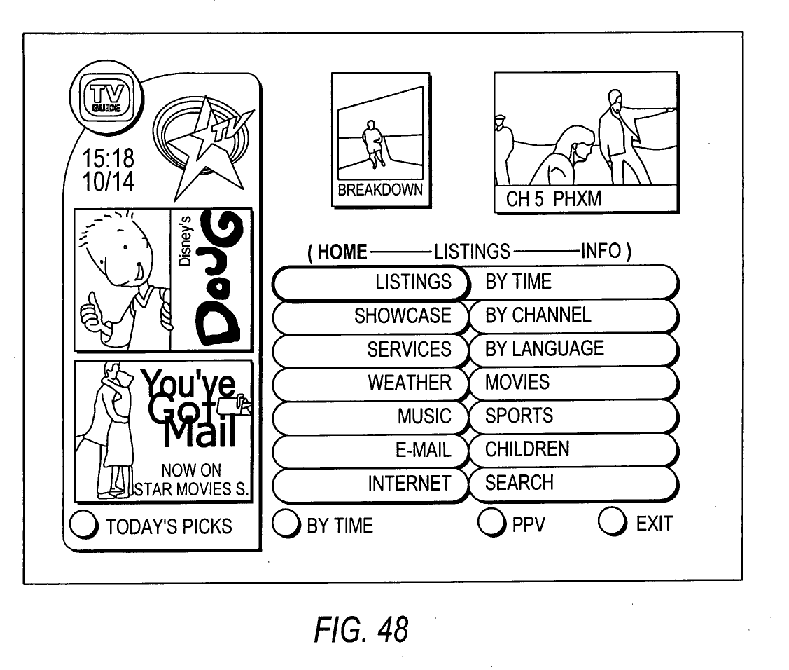

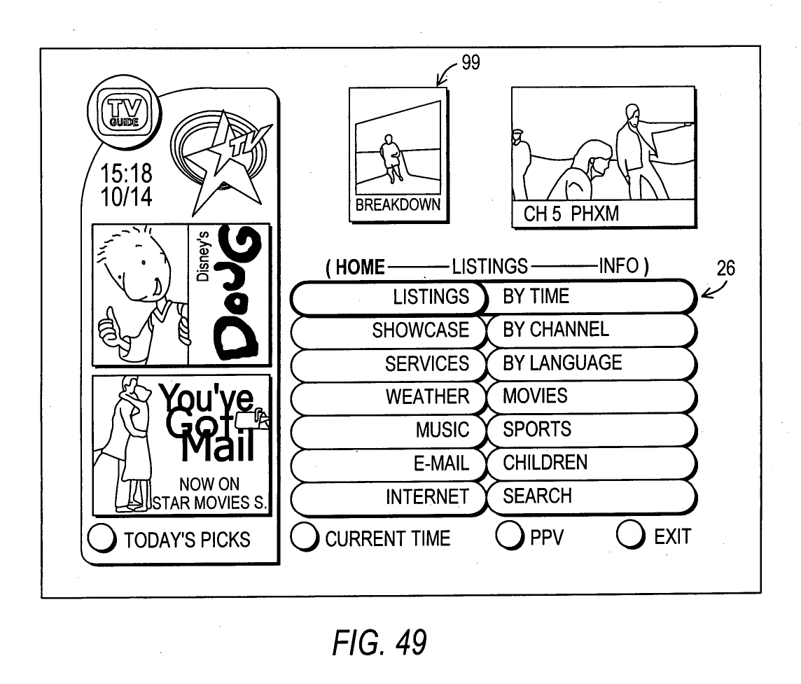

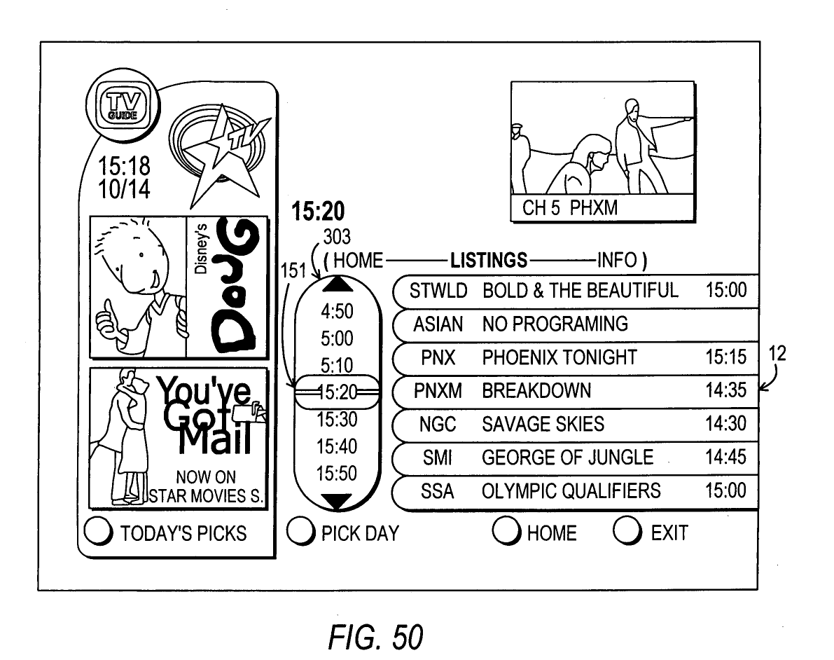

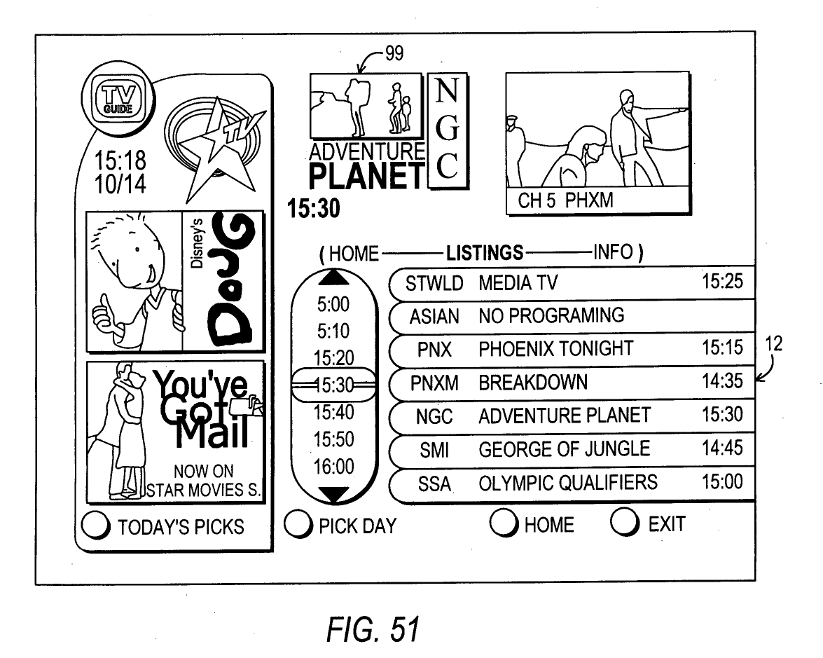

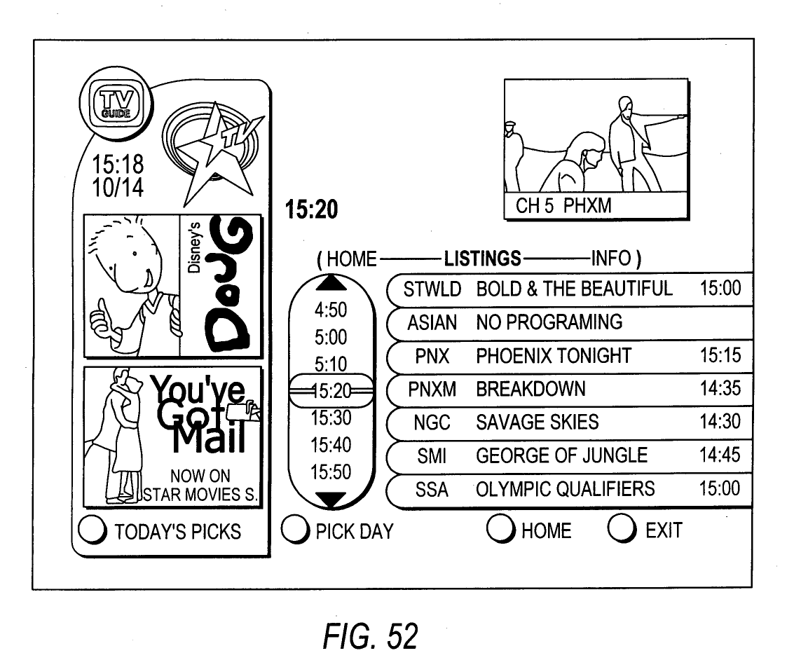

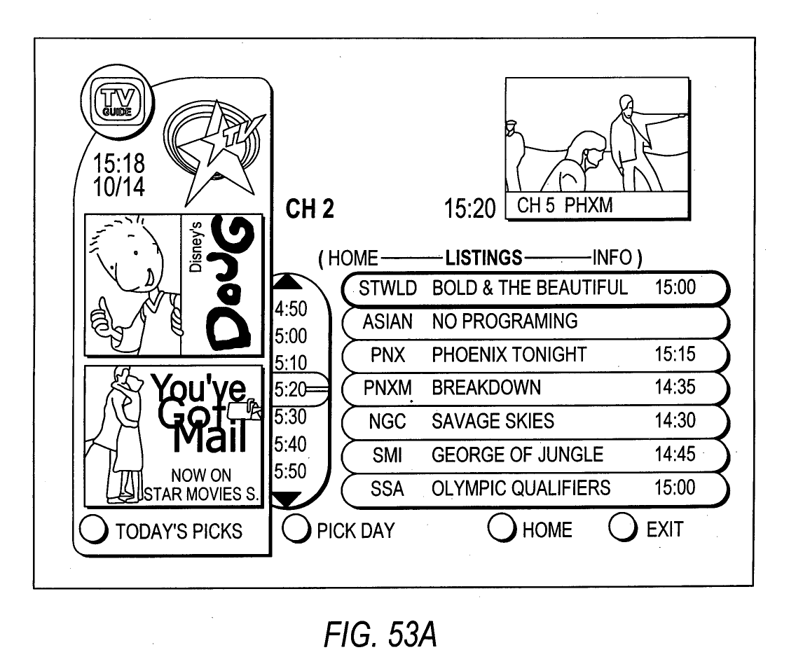

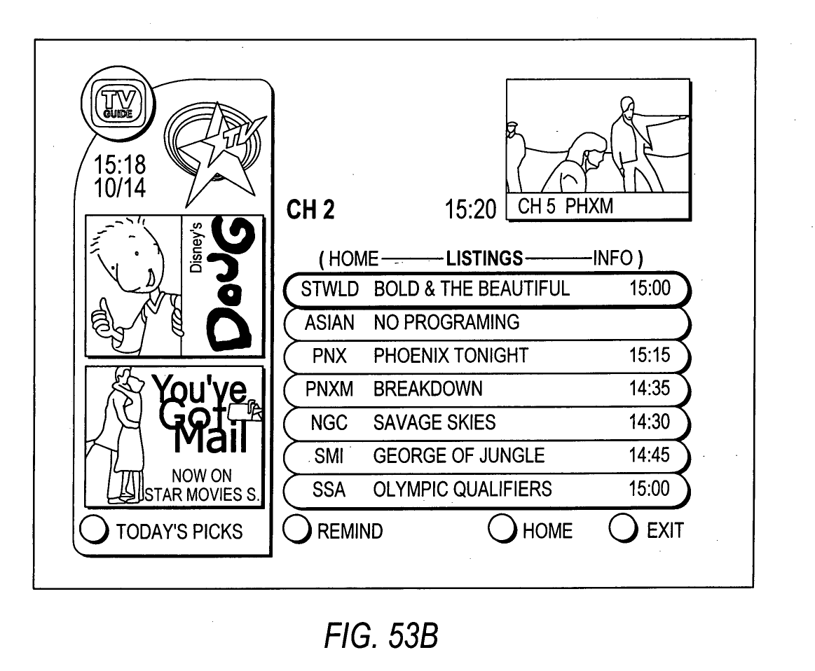

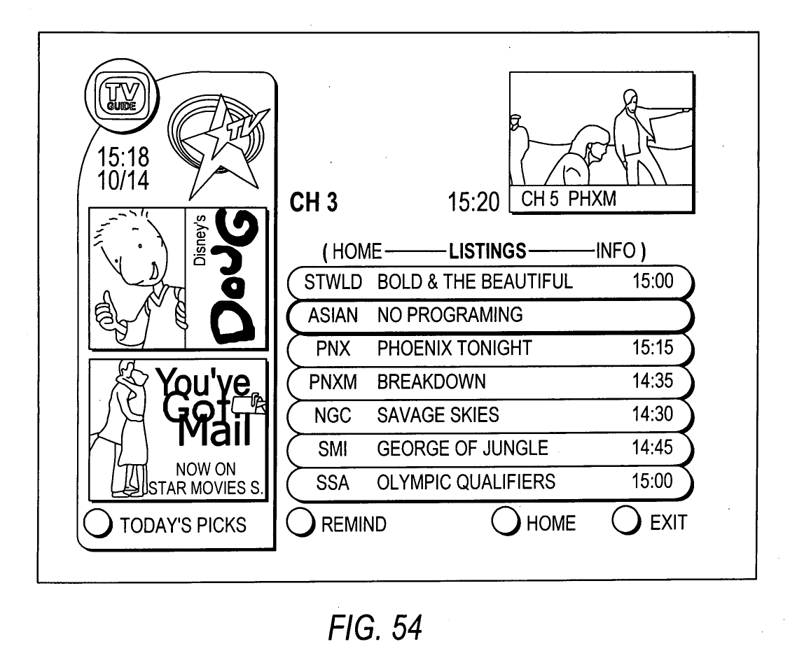

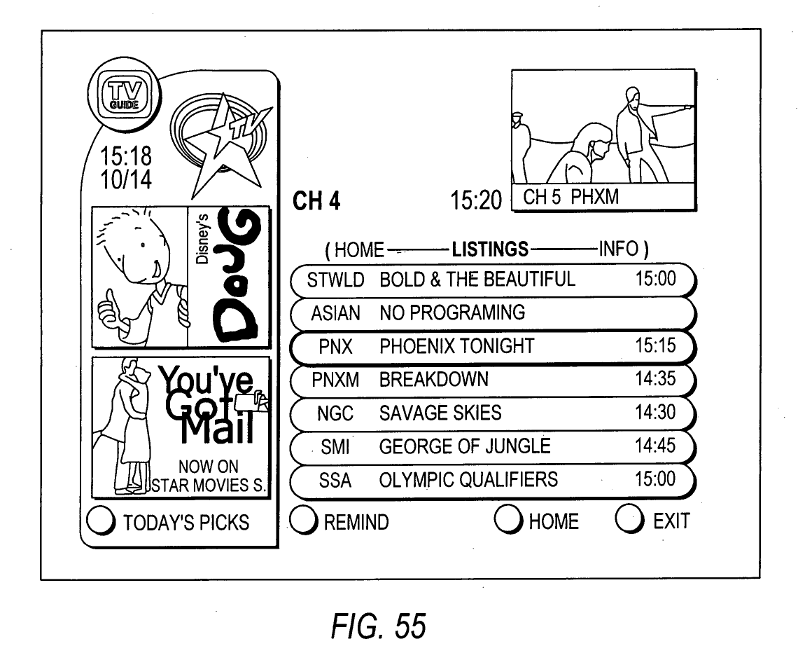

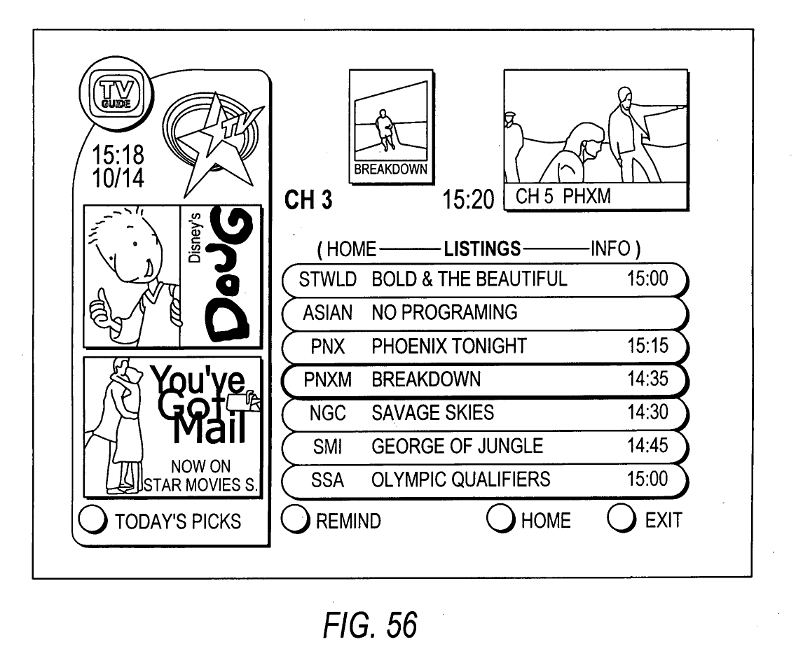

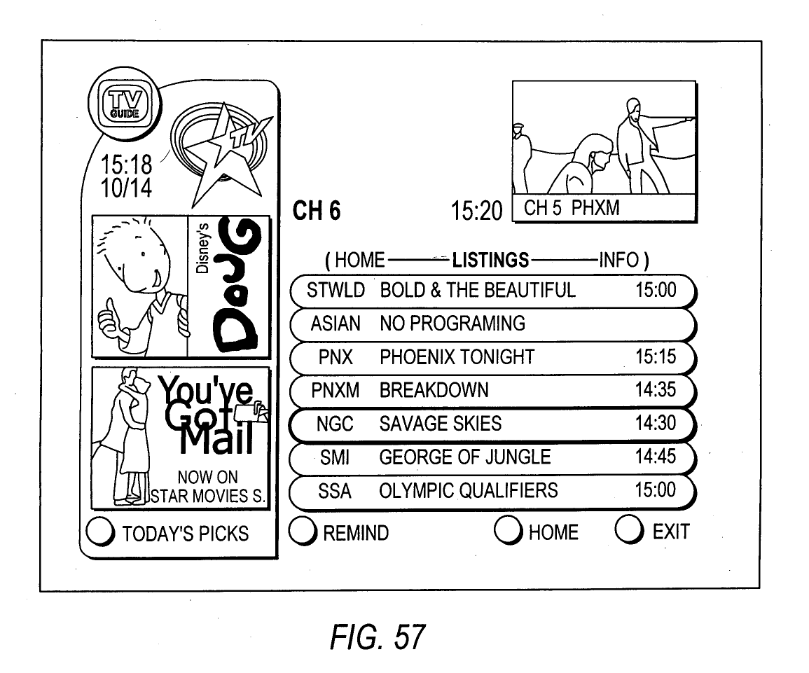

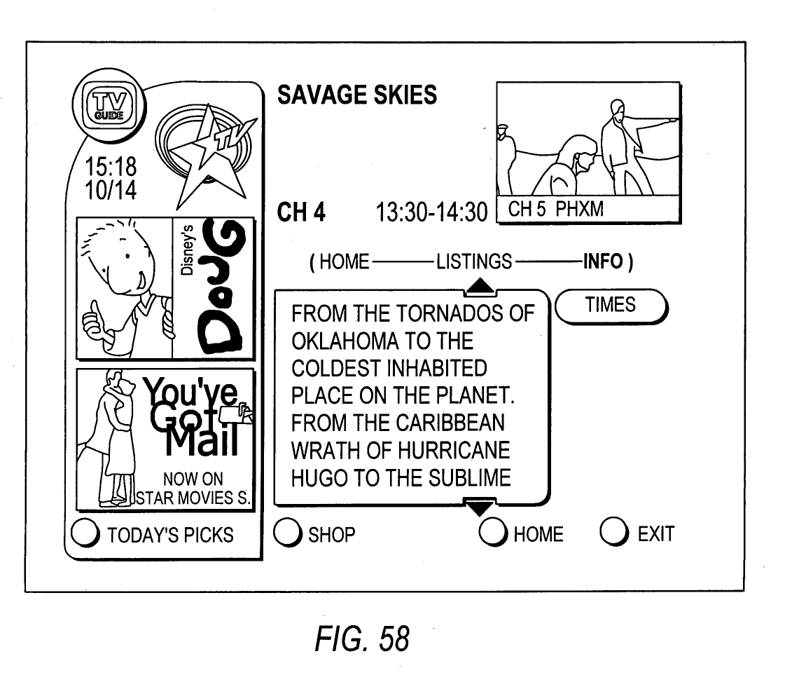

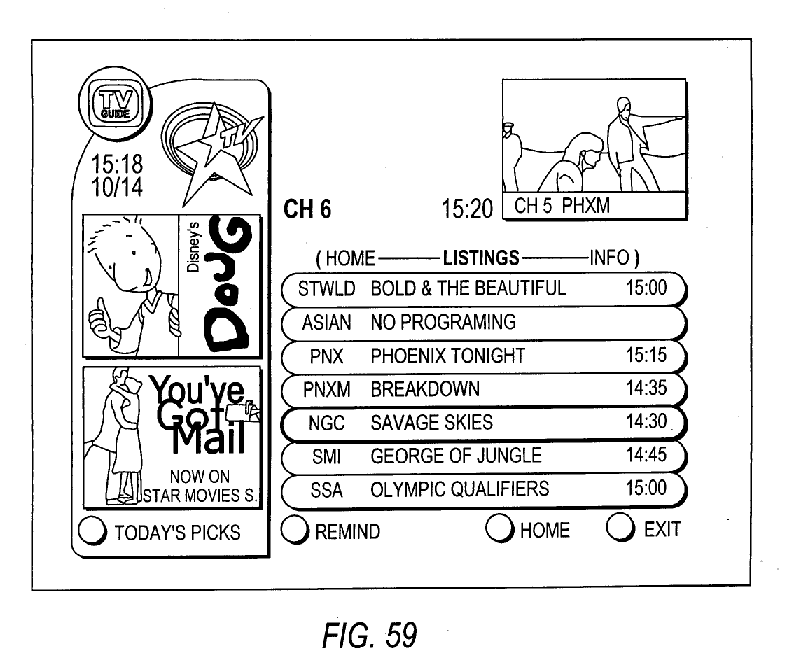

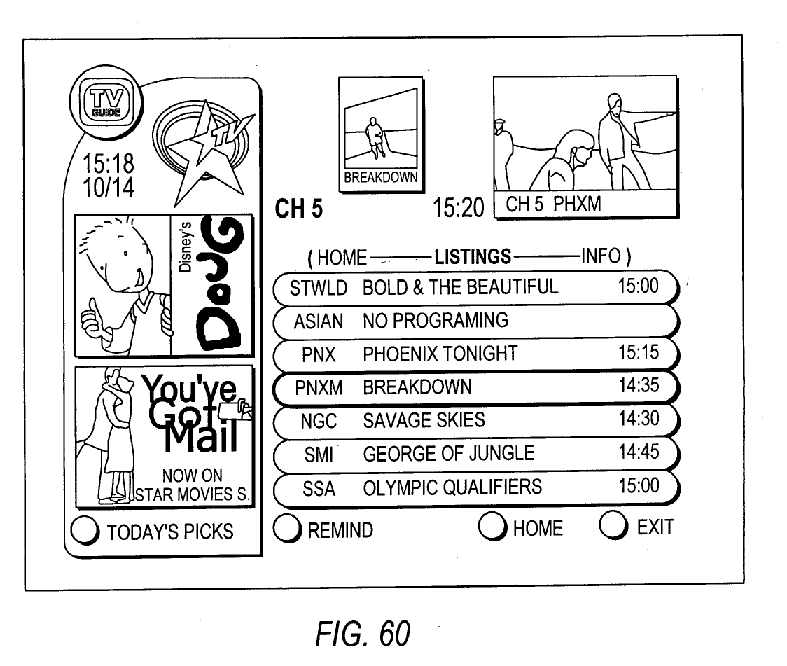

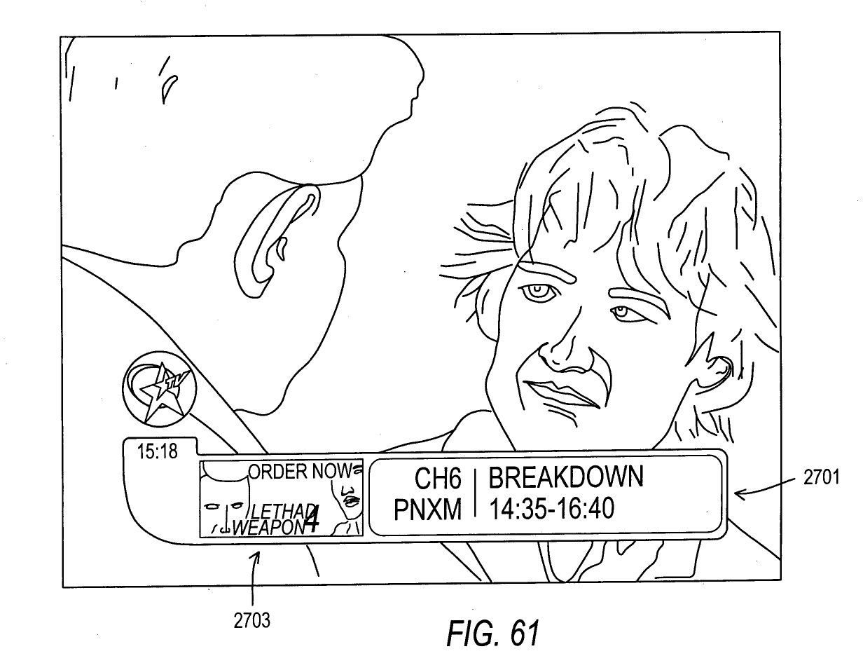

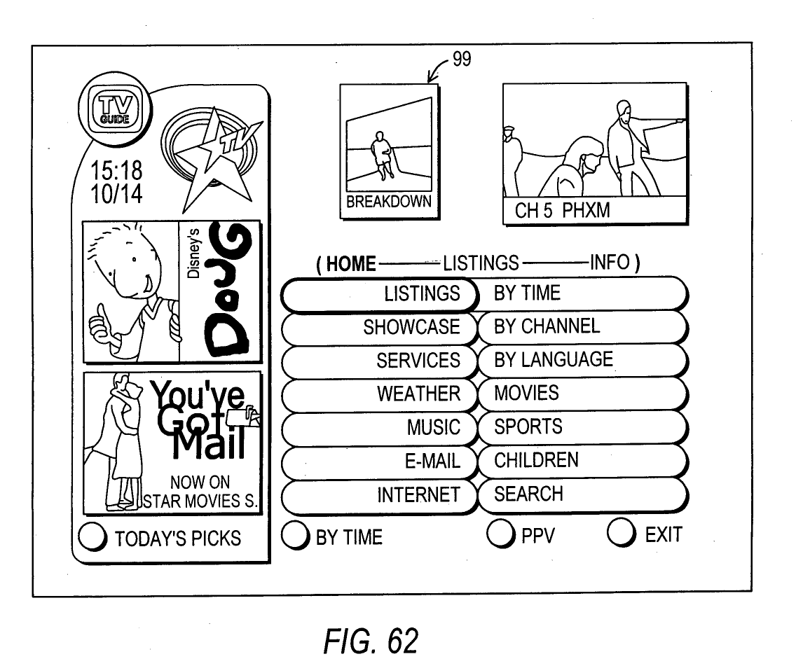

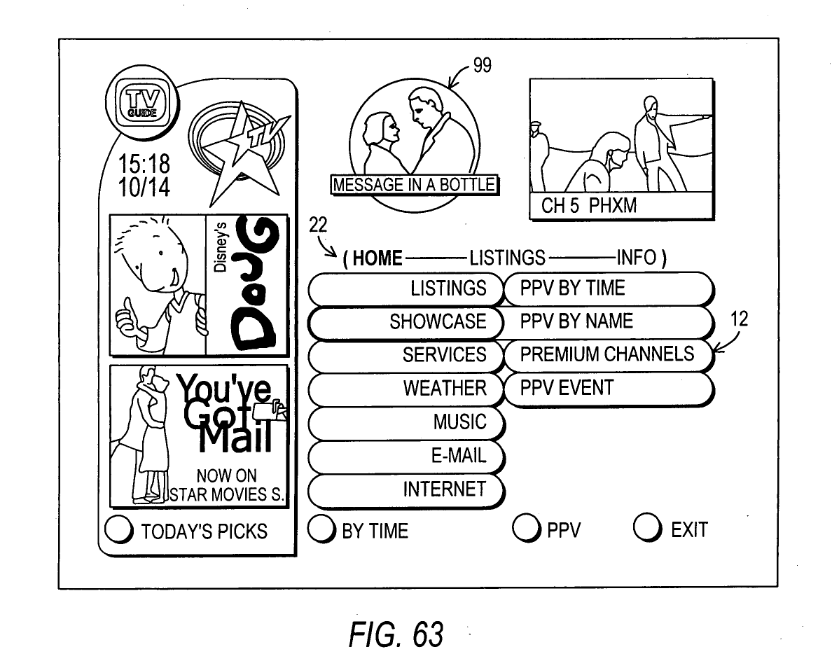

FIGS. 33 and 34 are flowcharts of illustrative steps involved in providing various features of the present invention. In practice, one or more of the steps shown may be combined with other steps, performed in any suitable order, or deleted. FIG. 33 is a flowchart of illustrative steps involved in the “sticky” highlight feature of the present invention. At step 330, the interactive program guide highlights a first display element, such as a program listing, option, information display, advertisement, or other display element from its original display of characteristics, using a first display characteristic, such as, for example, a first color shading scheme, outline or other suitable display characteristic. At step 332, the program guide highlights the first display element using a second display characteristic for a predefined period of time, in response to a user indicating a desire to access a second display element. At step 334, the program guide unhighlights the first display element after the predefined period of time, returning it to its original display characteristic. The program guide highlights the second display element using the first display characteristic at step 336.

FIG. 34 is a flowchart of illustrative steps involved in the feature of the present invention whereby display elements are highlighted using different display characteristics depending on whether they are selected. At step 340, the program guide highlights a first display element using a first display characteristic, such as, for example, a first color, shading scheme, outline or other display characteristic. This may be performed in response to the user indicating a desire to access the display element. At step 342, the program guide highlights the first display element using a second display characteristic in response to the user selecting the first display element. At step 344, the program guide highlights the first display element using a third display characteristic in response to the user indicating a desire to access a second display element.

A second suitable interface approach in accordance with the present invention is shown in FIGS. 35A-101. This approach is described, for example, in Vogh et al. U.S. provisional patent application Ser. No. 60/161,896, filed Oct. 27, 1999, which is hereby incorporated by reference herein in its entirety. The approach shown in FIGS. 35A-101 includes some of the same elements of the other approaches described herein. Some of these display elements such as, for example, anchor bar 22 and display region 38 have different display characteristics. An illustrative screen 107 that may be displayed by the program guide of the present invention is shown in FIG. 35A. Screen 107 may be displayed when a user first invokes the program guide. Screen 107 may contain various options 12. Screen 107 may also contain a picture-in-guide window 14 that contains video for the television program on the channel to which the set-top box is currently tuned. Interactive advertisements 16 may also be displayed as part of screen 107.

Screen 107 may contain options 18 for various program guide functions. The user may select a desired one of options 18 by pressing a color-coded key on the remote control. The color of the key may match the color of the dot 20 that is associated with the option. For example, the watch TV option 18a may have an associated dot 20 that is blue. When the user presses a corresponding blue key on the remote control, the program guide may perform function 18a. In the example of FIG. 35A, function 18a directs the program guide to cease displaying screen 107, so that the user may return to the television program on the channel to which the set-top box is currently tuned (i.e., watch television (TV)). The color-coded buttons on the remote control may be the same as those that are sometimes used in certain countries to access teletext functions. Any suitable type of coding may be used if desired. Color coding is merely an example.

Another feature shown in FIG. 35A relates to anchor bar 22. Anchor bar 22 contains a number of indicators 24 that correspond to different functions in the program guide hierarchy. As will be made clear from subsequent FIGS., the number of indicators 24 that are displayed and the content of the indicators 24 that are displayed may be context-sensitive. In the example of FIG. 35A, the leftmost indicator 24 corresponds to “home” and the indicators 24 to the right correspond to “listings” and “info.” The home indicator 24 is highlighted indicating that the user is currently in the home location in the program guide. As the user navigates through the guide, different indicators may be highlighted to indicate the user's location in the guide. The indicators may be arranged hierarchically, so that the highest level indicator is displayed at the left and the lowest level (i.e., most detailed) indicator is displayed on the right.

Another feature in FIG. 35A relates to advertisement tray 99. Advertisement tray 99 may display any suitable passive or interactive graphic, text, video, animation, or other advertisement for a program, product, or service within the scope of the subject matter of a given feature, option, or function of the guide. If desired, a third party may purchase advertising space in the guide that corresponds to a given feature, option, or function. In FIG. 35A, for example, the movie “Breakdown” is being advertised. This may indicate, for example, that Breakdown is listed somewhere in program listings, which in this example is the feature corresponding to the currently active indicator. Tying advertisements in advertisement tray 99 may provide users with an increased awareness of guide content, as opposed to simply subjecting users to advertisements for products or services without providing them with additional information related to the guide.

An alternative display that may be used for providing the features of FIG. 35A is shown in FIG. 35B. FIG. 35B shows the addition of sliver 101. Sliver 101 may display, for example, information related to the currently active option. This may include, for example, channel names, start times, program names, or any other suitable information.

The user may move to by time option 26 by pressing a right arrow key on the remote control or by pressing select (or pressing enter or pressing OK, etc.), as shown in FIG. 36. The selected option (listings) may be displayed in a different color (e.g., orange) than the other options. When any element on the display is active so that the user may select or otherwise interact with the element, that element may be, for example, lightened. Any inactive element (e.g., the options in the left column or the unselected advertisements) may be darkened relative to the active elements (e.g., the options in the right column) to show that they are inactive. The currently highlighted active element is the current selection among the active elements (e.g., the options in the right column). The user may move from by time option 26 to by channel option 28 by pressing a down arrow key on the remote control.

FIGS. 37A and 37B show display screens that the guide may display in response to the user selecting “by channel” option 12 or “by time” option 12, respectively. As shown, anchor bar 22 may highlight the listings indicator to indicate that the user is currently viewing listings. A navigational paradigm is provided by the guide in which the user may, for example, arrow to the right in order to obtain additional information for display in options 12. The guide indicates that additional information is available by, for example, displaying options 12 so that they appear to extend beyond the right portion of the screen. In FIG. 37A, for example, the start times of the programs are shown as being cut-off. In FIG. 37B, for example, options 12 are cut-off and the user may arrow right to view additional information (e.g., program start times) in the options 12.

Another feature shown in FIGS. 37A and 37B relates to navigational wheel 303. Navigational wheel 303 may provide users with an opportunity to view options 12 that correspond to the currently selected option in wheel 303. In the example of FIG. 37A, the user has positioned highlight region 151 of wheel 303 over channel STWD. Options 12 display programs for channel STWD accordingly. To view listings for additional channels, the user may position highlight region 151 (e.g., by pressing up or down keys on a remote control) to the desired channel. Highlight region 151 may, for example, maintain its central position relative to wheel 303 and the channel number may scroll up and down. Alternatively, highlight region 151 may move.

FIG. 37B shows an alternative display for wheel 303 and highlight region 151. FIG. 37B also shows the display of advertisement panel 99 and sliver 101. In this example, advertisement panel 99 includes an advertisement for “Adventure Planet”, which is a program included within the listings for aired at 15:20 as shown.

The display of additional features (e.g., advertisement panel 99, sliver 101, wheel 303, etc.) and alternate display characteristics as shown in the display screens of FIGS. 35B and 37B may be applied to any other suitable guide display screen and to other interface approaches. For clarity, the following discussion is limited to describing the features and displays having the display characteristics shown in FIGS. 35A and 37A as applied to other guide display screens.

Returning to FIG. 37A, information about the channel currently highlighted by highlight region 151 is displayed at the top of the display screen as shown. The user may indicate a desire to view listings for other channels by, for example, repositioning highlight region 151. In response to the user repositioning highlight region 151, the guide may dynamically display listings for the currently highlighted channel. Alternatively, the guide may provide the user with an opportunity to position highlight region 151 and display listings in response to the user selecting a given channel. FIG. 38 shows the display of program listings (i.e., options 12 containing program listings) in response to the user indicating a desire to view program listings for the Asian News channel, ASIAN.

FIG. 39 shows the display of program listings in response to the user indicating a desire to view program listings for channel 4, PNX. In this example, an advertisement is available for a program within the listings for channel PNX (e.g., an advertisement for Phoenix Tonight), and is displayed in advertisement tray 99. As shown, the navigational paradigm of the present invention may include indicating to the user that additional information is available for display in option 12 by extending options 12 past or into the right side of the screen. The user may access this information by, for example, arrowing right to enter the program listings.

FIGS. 40A and 40B show an illustrative change of display screens in accordance with one mode of the navigational paradigm of the present invention. In the examples of FIGS. 40A and 40B, the display screen is slid or shifted to the left to provide for the display of the additional information and to provide the user with an opportunity to navigate the program listings. In this example, the only additional information is the parts of the start times of the programs that did not fit in options 12 initially. Wheel 303 may be slid to the left and eventually obscured as shown. In an alternative mode, the guide may change screens statically, i.e., by changing screens instantly without the sliding effect.

As seen when comparing FIGS. 40A and 40B to FIG. 39, the advertisement in advertisement tray 99 may change. In this example, the new advertisement indicates to the user additional information related to the PNX channel. The advertisement may, for example, relate to the program Phoenix Tonight. Alternatively, the advertisement may be related to the PNX channel, or the PNX channel and Phoenix tonight, and may be an advertisement assigned to that particular option 12. If desired, advertisements may be designated for each option 12. In this approach, every option of the program guide may be used to generate advertisement revenue. If desired, a combination of both approaches may be used. For example, certain graphics may make it inappropriate to provide for the sliding effect. This may be based in part on the limitations of the hardware on which the guide is implemented. Displays with the graphics may be statically replaced (i.e., replaced without sliding). The guide may, for example, provide the user with an opportunity to select which display mode the guide uses.

FIGS. 41, 42, and 43 show the user navigating within the program listings. As shown in FIGS. 41 and 42, for example, there are no advertisements designated for the options 12 corresponding to the listings for the programs “Macat Music Video” and “Nelton”. FIG. 43 illustrates the display an advertisement related to Chibimaruko Chan in advertisement tray 99.

FIGS. 44-46 show display screens for the additional information feature of the guide. A user may indicate a desire to access additional information for a listing by, for example, selecting the listing. In response, the guide may provide a display of information as shown in the FIGS., and may highlight (e.g., change the color of) info indicator 24. The user may page or scroll up or down to see previous or additional information, as shown when comparing FIGS. 44 and 45. The additional information display may have replaced the listings of FIG. 43 statically, or with a sliding effect.

The guide may also provide the user with an opportunity to access other guide features from within an additional information screen. The guide may, for example, provide the user with an opportunity to schedule a reminder for a program, lock a program, see additional air times for a program, or access any other suitable feature. Program guide systems in which user are provided with an opportunity to access additional features from an information screen are described, for example, in Rudnick et al. U.S. patent application Ser. No. 09/356,268, filed Jul. 16, 1999, which is hereby incorporated by reference herein in its entirety. The user may access additional features by, for example, arrowing right and selecting the desired feature. In FIG. 47, for example, the user has set a reminder for the program. The guide may display a reminder indicator on advertisement tray 99 to indicate a program associated with the reminder has a reminder scheduled. The user may return to a main menu screen, such as the illustrative display screen shown in FIG. 48 (which in this example is the display screen shown in FIGS. 37A and 37B) by arrowing left. The guide may highlight (e.g., change the color of) an appropriate indicator 24 in anchor bar 22 as the user arrows left.

The guide may provide users with an opportunity to access listings by time. Users may indicate a desire to access listings by time by, for example, selecting time option 26 as shown in FIG. 49. FIG. 49 shows the display of an advertisement in advertisement tray 99. In this example, “Breakdown” is being listed in one of the listings. In response to the user indicating a desire to view listings by time, the guide may display a listings by time screen as shown in FIG. 50.

In the example of FIG. 50, the user has positioned highlight region 151 of wheel 303 over time 15:20. The highlighted time is also displayed at the top of the screen as shown. Options 12 display programs airing at time 15:20, accordingly. To view listings for additional times, the user may position highlight region 151 (e.g., by pressing up or down keys on a remote control) to the desired time. Highlight region 151 may, for example, maintain its central position relative to wheel 303 and the channel number may scroll up and down. Alternatively, highlight region 151 may move, or a combination of these approaches may be used. As discussed, FIG. 37B shows an alternative display for wheel 303 and highlight region 151. FIG. 37B also shows the display of advertisement panel 99 and sliver 101.

Returning to FIG. 50, the user may indicate a desire to view listings for other times by, for example, repositioning highlight region 151. In response to the user repositioning highlight region 151, the guide may dynamically display listings for the currently highlighted time. Alternatively, the guide may provide the user with an opportunity to position highlight region 151 and display listings in response to the user selecting a given time.

FIG. 51 shows the display of program listings in response to the user indicating a desire to view program listings for 15:30. In this example, an advertisement is available for a program within the listings for 15:30 (e.g., an advertisement for “Adventure Planet”), and is displayed in advertisement tray 99. As shown, the navigational paradigm of the present invention may include indicating to the user that additional information is available for display in option 12. The user may access this information by, for example, arrowing right to enter the program listings. FIG. 52 shows the user returning to time 15:20.

FIGS. 53A and 53B show an illustrative change of display screens in accordance with one mode of the navigational paradigm of the present invention. In the examples of FIGS. 53A and 53B, the display screen is slid or shifted to the left to provide for the display of the additional information and to provide the user with an opportunity to navigate the program listings. In this example, the only additional information is the parts of the start times of the programs that did not fit in options 12 initially. Wheel 303 may be slid to the left and eventually obscured as shown. In an alternative mode, the guide may change screens statically, i.e., by changing screens instantly without the sliding effect.

FIGS. 54-57 show the user navigating within program listings displayed for the time 15:20. As shown in FIGS. 54, 55, and 57, for example, there are no advertisements designated for the options 12 related to the channels ASIAN, PNX, or NGC, or related to the programs aired on those channels at 15:20. FIG. 56 illustrates the display an advertisement related to the movie “Breakdown” in advertisement tray 99.

FIG. 58 shows an illustrative information screen that the guide may display in response to the user indicating a desire to view additional information for the program “Savage Skies”. In this example, the user may not set a reminder or lock the program because the program has started already. FIG. 59 illustrates the guide displaying a listings by time display for the time 15:20 in response to the user arrowing left while in the display screen of FIG. 58.

FIGS. 60 and 61 illustrate a guide feature in which users are provided with an opportunity to tune to a program from program listings display. As seen when comparing FIG. 60 and 61, for example, the user has positioned the highlight region over the listing for “Breakdown”, and a suitable advertisement is displayed in advertisement panel 99. The user may indicate a desire to watch “Breakdown” by, for example, pressing an OK key on a remote control. In response to the user indicating a desire to tune to a program, the guide may direct the user's equipment to tune to the channel on which the program is carried. In addition, the guide may display browse overlay, such as browse overlay 2701 shown in FIG. 61. Browse overlay 2701 may also include advertisement tray 2703 in which an advertisement related to the scope of the browse display is displayed. In this example, an advertisement for a pay-per-view is displayed because the featured movie, “Lethal Weapon”, is being provided on a channel to which the user may browse.

The user may return to the menu display of FIG. 62 by, for example, by pressing a “Guide” key on their remote control. As shown in FIG. 62, a suitable advertisement is displayed in advertisement panel 99.

FIG. 63 shows options 12 that the guide may display in response to the user selecting a showcase option. In practice, the number of options 12 available may be dynamically configurable. In this example, the showcase feature only requires four options. FIG. 63 also illustrates the display of an advertisement in advertisement tray 99. The advertisement shown may, for example, be for a pay-per-view program that is featured in the showcase feature. In this example, anchor bar 22 indicates that the next group of options that the user may access (e.g., by arrowing right when showcase is selected) is a group of options related to listings. As shown, the user may access pay-per-view listings by time and name, and may also access premium channels and pay-per-view events. The user may arrow right again (or press OK) to access an information display.

FIG. 64 shows the display of options 12 in response to the user selecting a services option. The services may include services such as games, home shopping applications, screening rooms, access to on-line guides, local information services, and non-guide applications (e.g., banking application). A services option may be used, however, to provide users with links to any other suitable services. In the example of FIG. 64, an advertisement for TV Guide On-Line is displayed because TV Guide On-Line is a feature provided under the services option. As indicated by anchor bar 22, the user may arrow right (or press OK) to access a group of trailers options, and may arrow right again (or press OK again) to watch trailers.

As shown in FIGS. 65 and 66, the user has selected services option 12, highlighted merchandise option 12. A suitable advertisement is displayed in advertisement tray 99 (which in this example is still a TV Guide On-Line advertisement), and anchor bar 22 indicates features the user may access by arrowing right (or pressing OK).

In FIG. 67, the user has highlighted TV Games option 33. A suitable advertisement is displayed in advertisement tray 99 (which in this example is still a TV Guide On-Line advertisement), and anchor bar 22 indicates features the user may access by arrowing right (or pressing OK). In this example, there are no additional features the user may access because by selecting TV Games the user launches (or otherwise accesses) a TV Games application. An illustrative menu for a TV Games application is shown in FIG. 68. FIGS. 68-74 illustrate the user navigating within the menu. As illustrated in FIGS. 68-74, a third party application, in this example the TV Games application, may include a link back to the guide (e.g., link 3401). The user may return to a main menu as shown in FIG. 75 by, for example, arrowing left.

The guide may also provide users with an opportunity to select an advertisement 16 and obtain information for the advertised program, product, or service. Users may indicate a desire to select an advertisement by, for example, pressing the button on a remote control that is color coordinated with Today's Picks option 18. In response to the user indicating a desire to select an advertisement, the guide may highlight one of the advertisements 16, as shown in FIG. 76. Anchor bar 22 may change to reflect the available option (e.g., today's pick). The user may position highlight region 151 over the other advertisement 16 and select the desired advertisement by, for example, pressing an OK key on the remote control (FIG. 77). In response to the user selecting an advertisement 16, the guide may display an information screen as shown in FIG. 78. The user may scroll or page up or down to read the provided information. The user may view information for additional picks (e.g., advertisements) by selecting more picks option 18 (e.g., by pressing a button on the remote control that corresponds to the color of the more picks button 18). The user may return home by, for example, pressing a button on the remote control that corresponds to the color of the home button 18 (FIG. 78). Anchor bar 22 and advertisement tray 99 may change accordingly.

FIGS. 79-83 illustrate the user navigating to and selecting a weather option (e.g., by arrowing right or pressing OK). Comparing FIGS. 79-83 shows how anchor bar 22 and advertisement panel 99 may change as the user navigates within the options.

FIGS. 84-89 show illustrative display screens that the guide may display when providing access to a weather information service. The weather information provided may be national or local information. The guide may provide a user with an opportunity to access, for example, local weather information such as forecasts, satellite views, radar views, maps, archives of weather information, or other suitable weather related features. The user may, for example, choose a geographic location for which these or other features provide weather information. The guide may also provide the user with an opportunity to search for cities, access weather watches and warnings, access radar information, satellite information and other information, access a television based weather product such as the Weather Channel, access an on-line Weather Channel, or access any other suitable weather related feature. FIGS. 85, 86, and 87 illustrate the display of screens for such features using a sliding effect. FIGS. 88 and 89 illustrate the display of screens for such features without using cutoffs and a sliding effect. The user may return from the weather feature by, for example, arrowing left (FIG. 90).

FIGS. 91-94 illustrate the user navigating to and selecting the showcase option (e.g., by arrowing right or pressing OK). Comparing FIGS. 91-94 shows how anchor bar 22 and advertisement panel 99 may change as the user navigates within the options. The guide may provide the user with an opportunity to search through pay-per-view programs by name. Users may indicate a desire to search through pay-per-view programs by name by, for example, selecting “ppv by name” option 12 (FIG. 94). In response to the user indicating a desire to search pay-per-view programs by name, the guide may display a search screen as shown in FIG. 95.

In the example of FIG. 95, highlight region 151 of wheel 303 is initially positioned over the letter “A”. Options 12 display pay-per-view program listings that begin with the letter “A” accordingly. To view pay-per-view program listings that begin with other letters, the user may position highlight region 151 (e.g., by pressing up or down keys on a remote control) to the desired letter. Highlight region 151 may, for example, maintain its central position relative to wheel 303 and the letters may scroll up and down. Alternatively, highlight region 151 may move. The user may also view pay-per-view program listings for a particular day by, for example, pressing a button on the remote control that is color coordinated to the pick day option 18. FIG. 95 also illustrates the display of an advertisement in advertisement panel 99 that corresponds to a particular position in wheel 303. In this example, an advertisement for “The Prince of Egypt”, a pay-per-view program within the listings (although not currently displayed in an option 12), has been assigned to the current position of wheel 303.

FIGS. 96-98 illustrate the user navigating within wheel 303. As shown in FIGS. 96-98, advertisement panel 99 does not change because, for example, the advertisement shown has been assigned to the positions in wheel 303 for the letters “A”, “B”, “C”, and “D”. Alternatively, one advertisement may be assigned to the entire wheel 303. Options 12 extend past the right edge of the screen to indicate that the user may, for example, arrow right to view additional information.

FIGS. 99-101 illustrate the guide providing the user with an opportunity to navigate within listings after the user has selected a particular letter (e.g., the letter “D”). As shown in FIGS. 99 and 100, the listings may be displayed using a sliding effect to replace wheel 303. Alternatively, wheel 303 may be statically replaced if desired.

FIG. 102 illustrates an information screen that the guide may display in response to a user selecting a listing (e.g., the listing for “Deep End of the Ocean”). The information screen may display additional air times 681 for the pay-per-view. As illustrated in FIGS. 103-106, the user may navigate the additional air times 681, select an air time (e.g., 23:15), and order the pay-per-view. When the ordering process is complete, the user may return to the information screen (FIG. 107). The information screens of FIGS. 102-107 may also provide a user with an opportunity to shop a TV Guide Store.

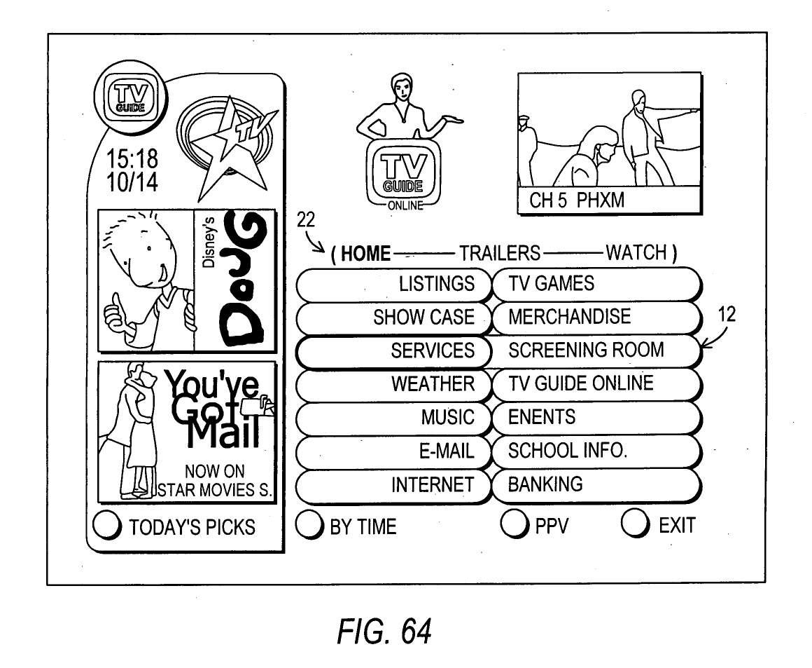

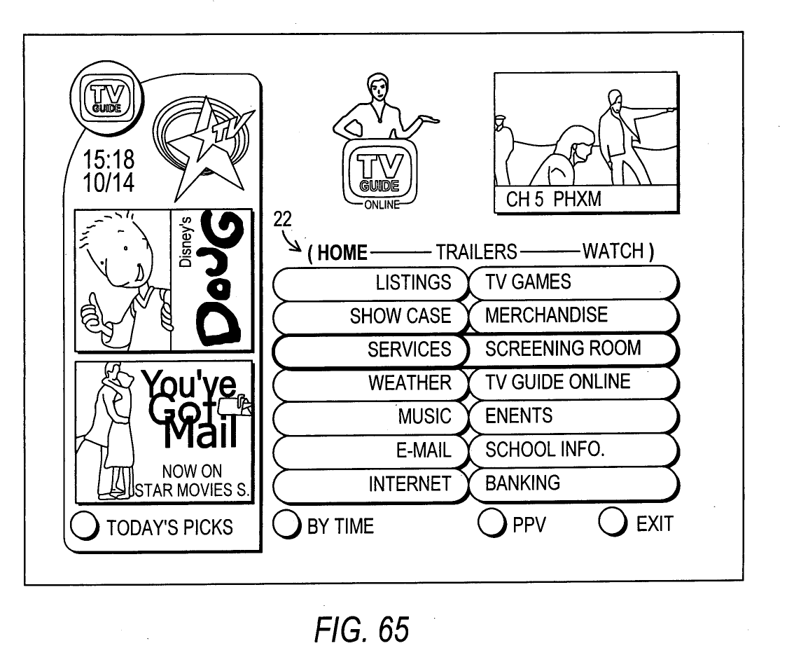

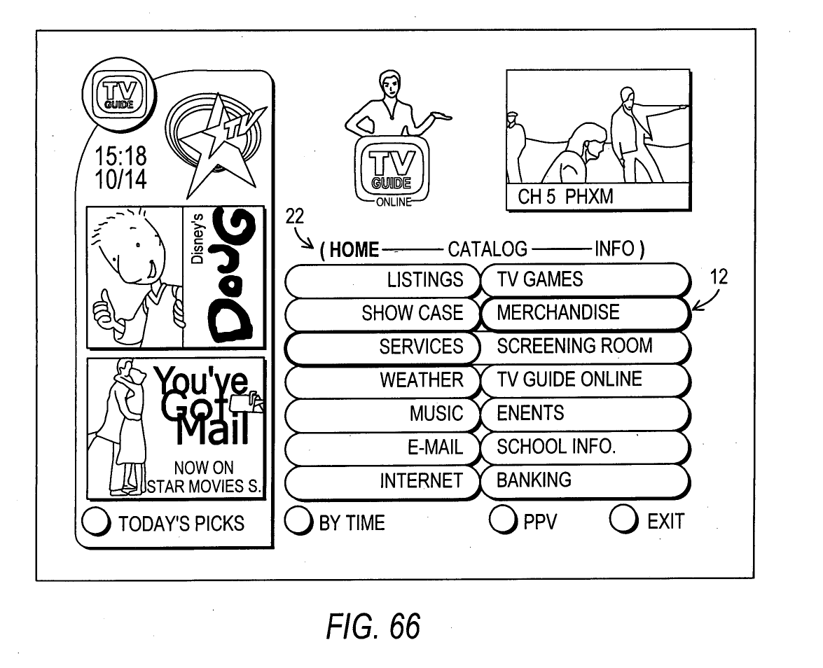

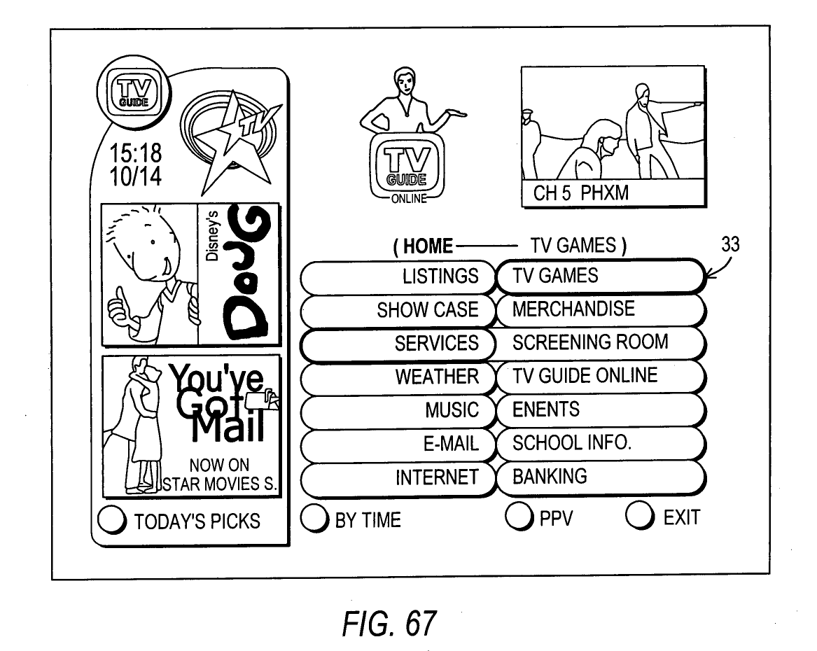

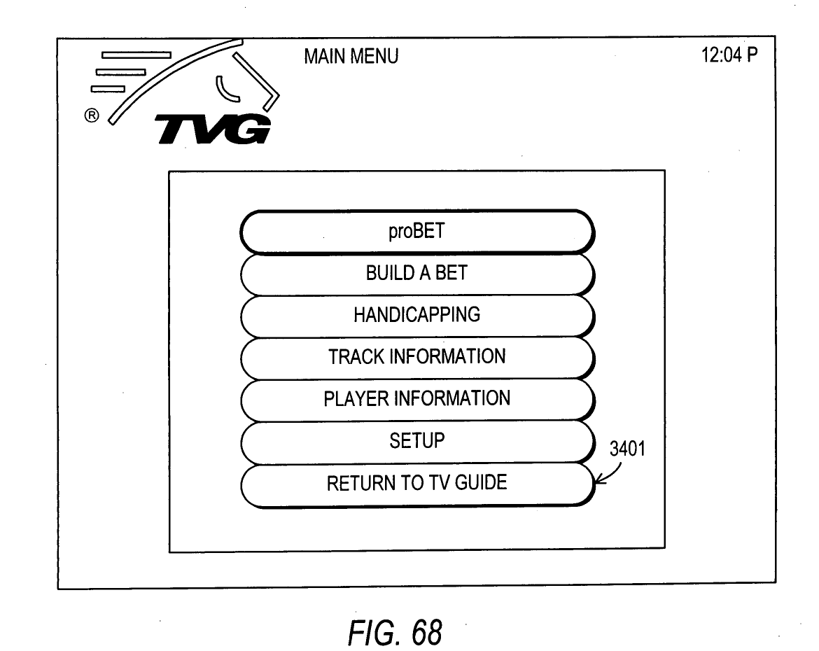

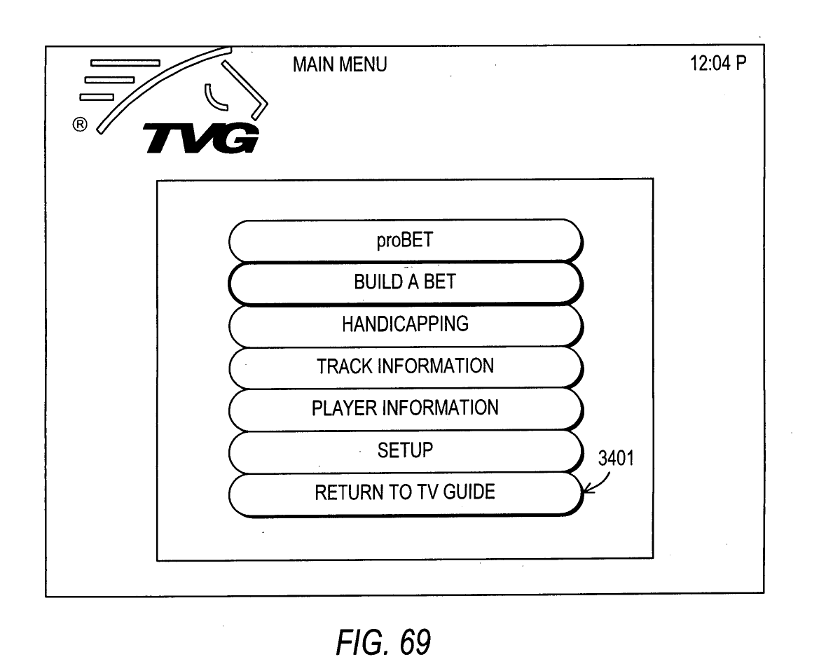

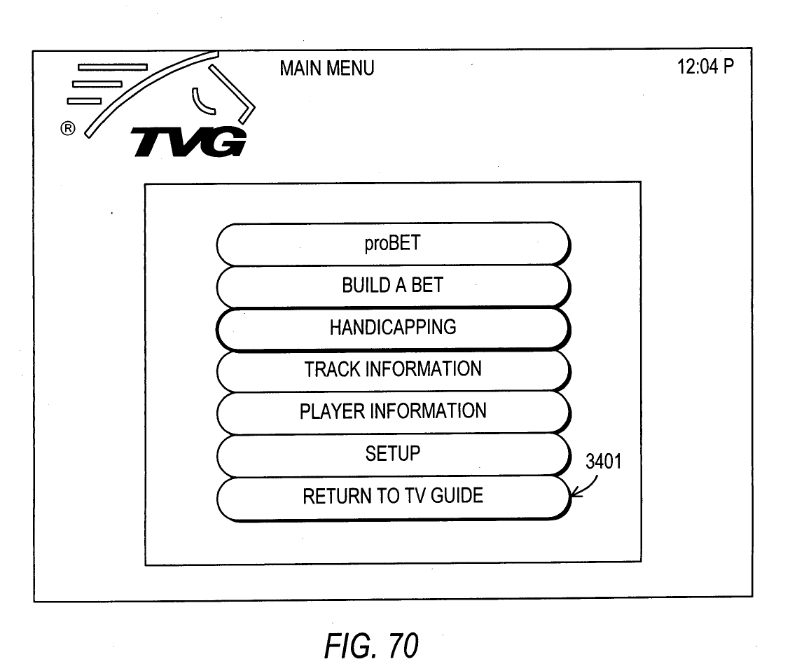

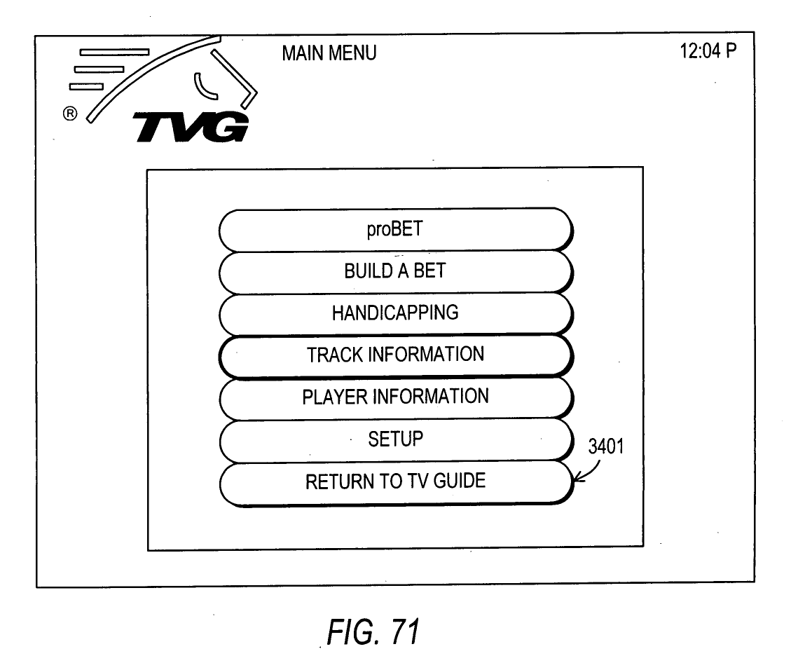

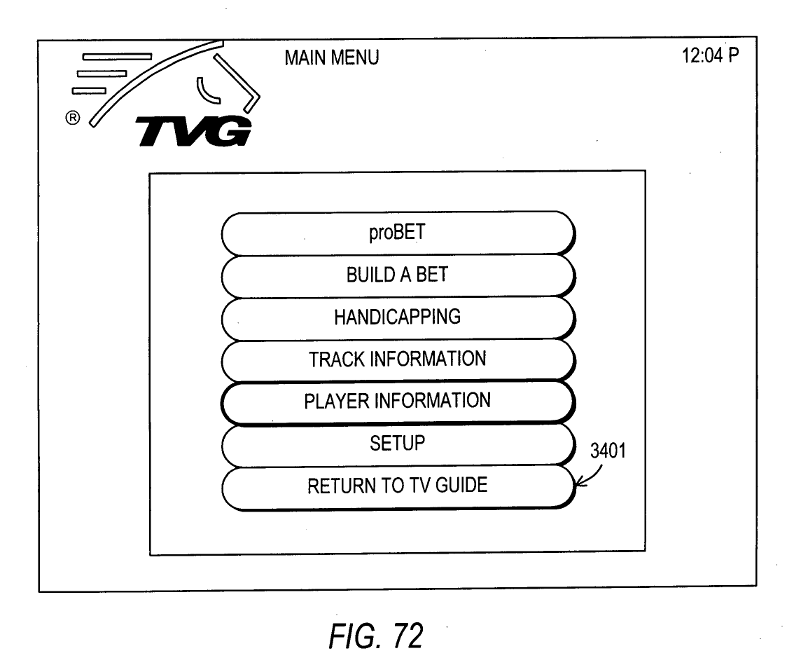

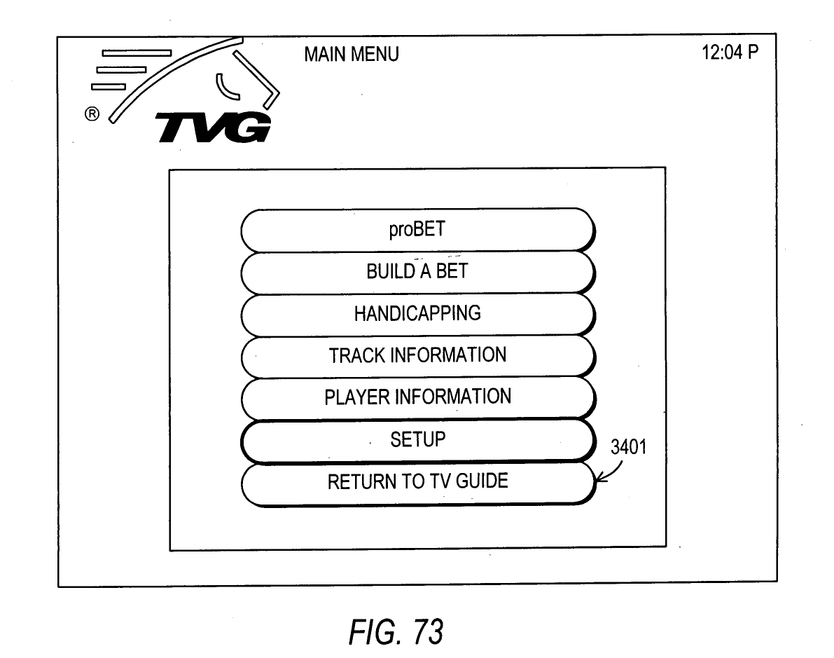

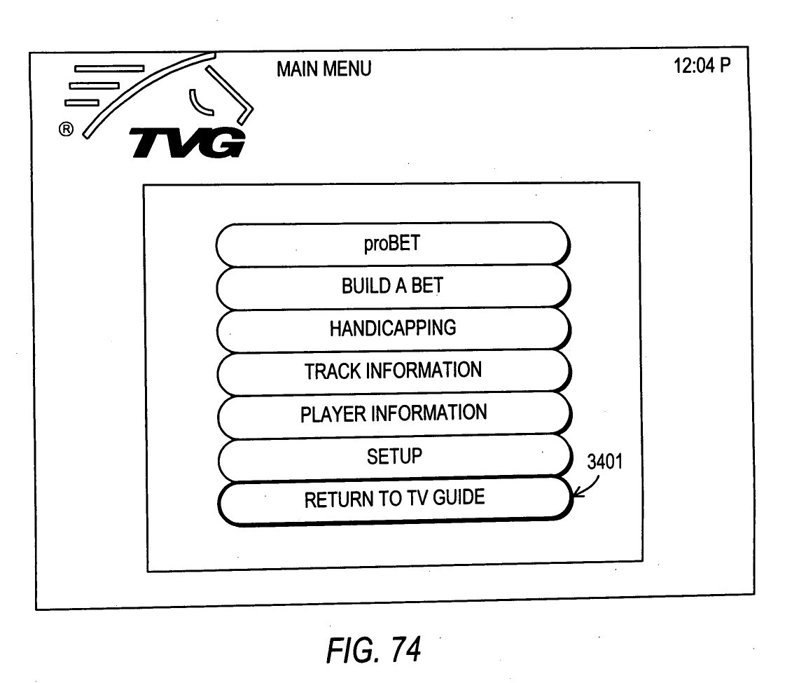

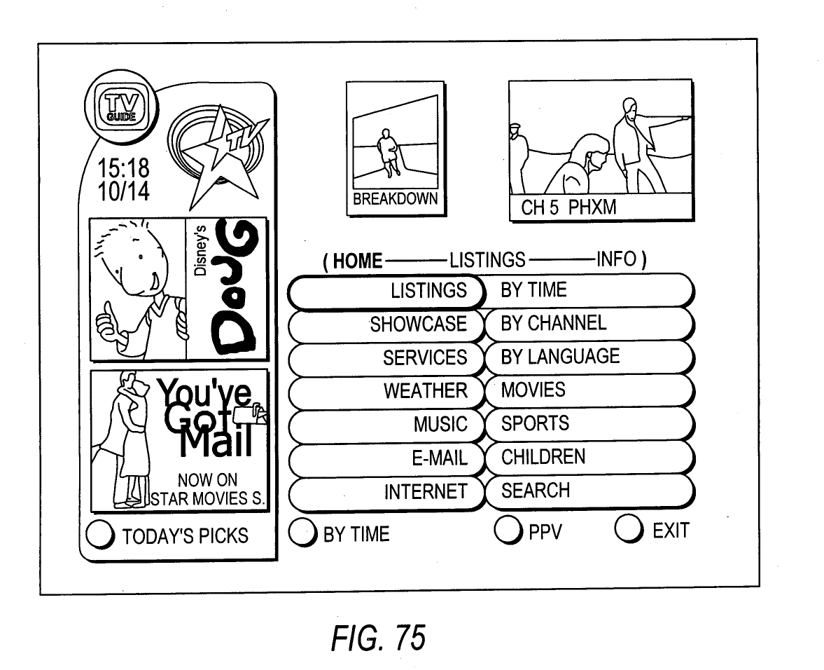

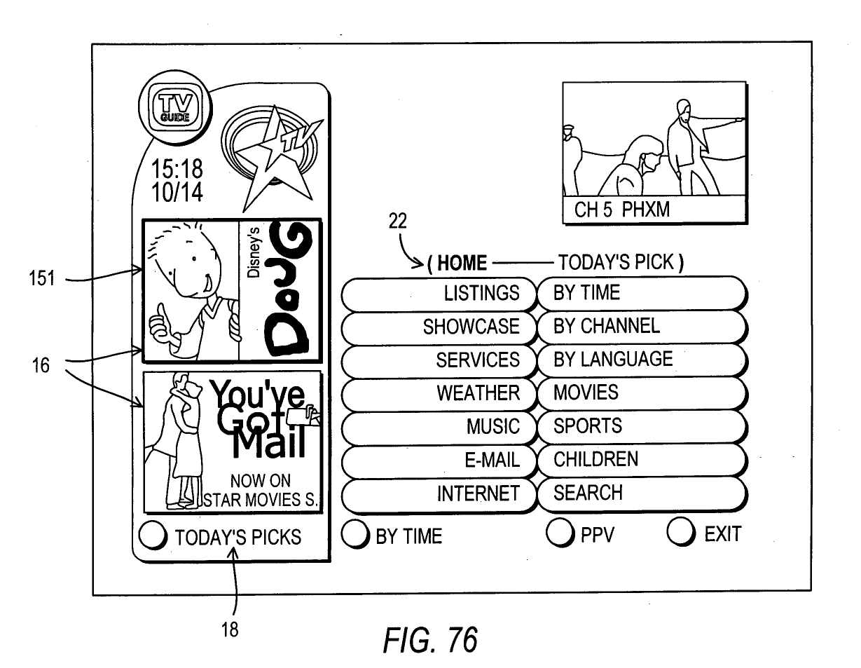

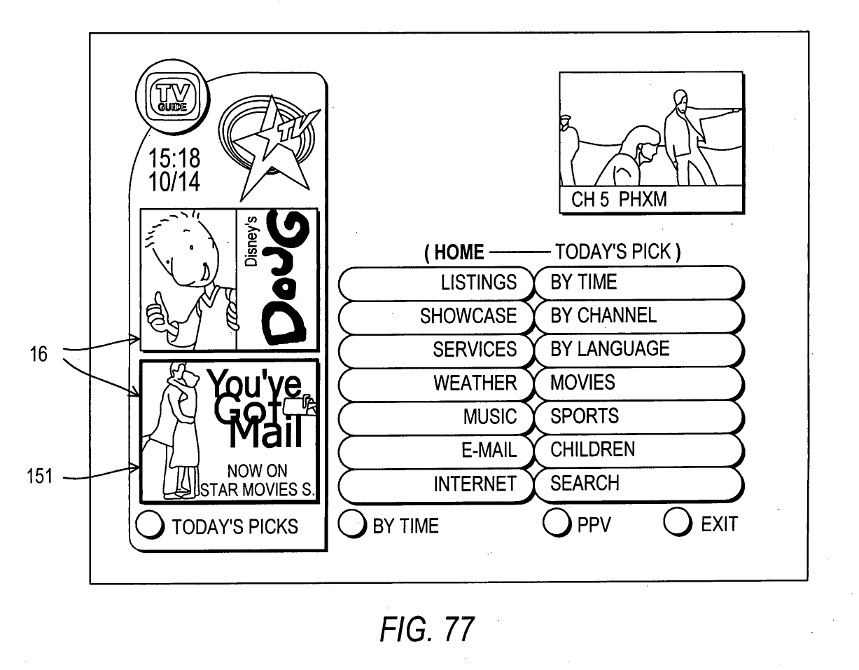

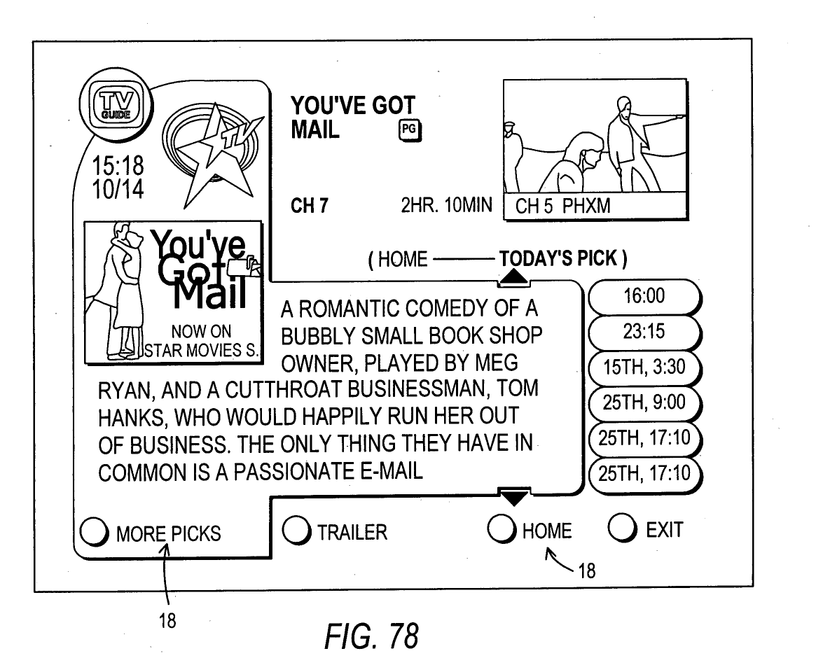

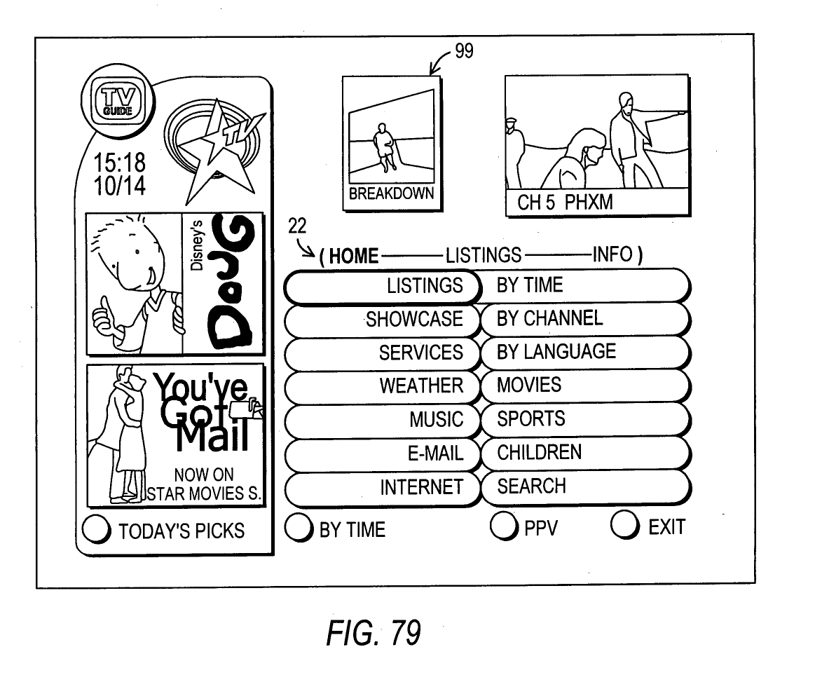

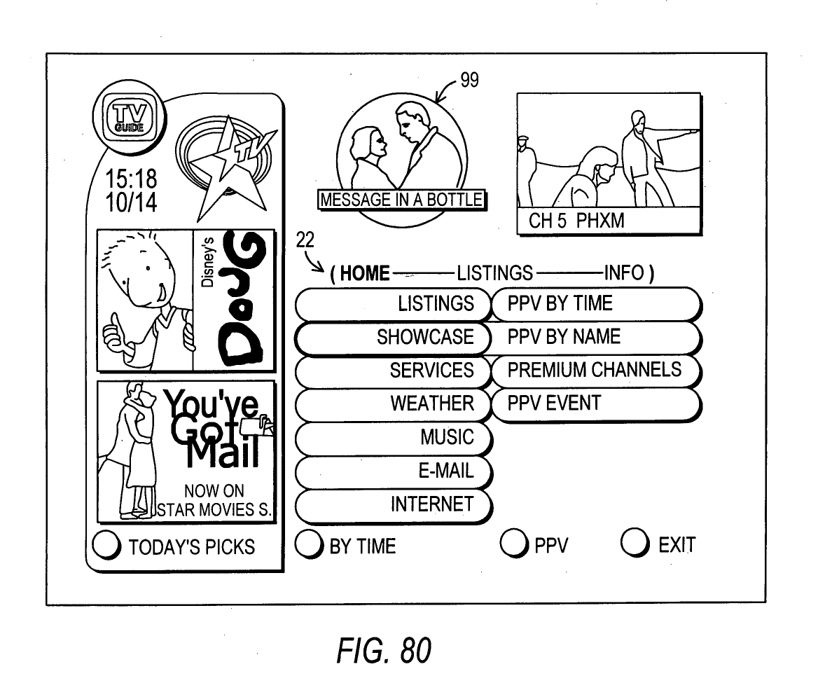

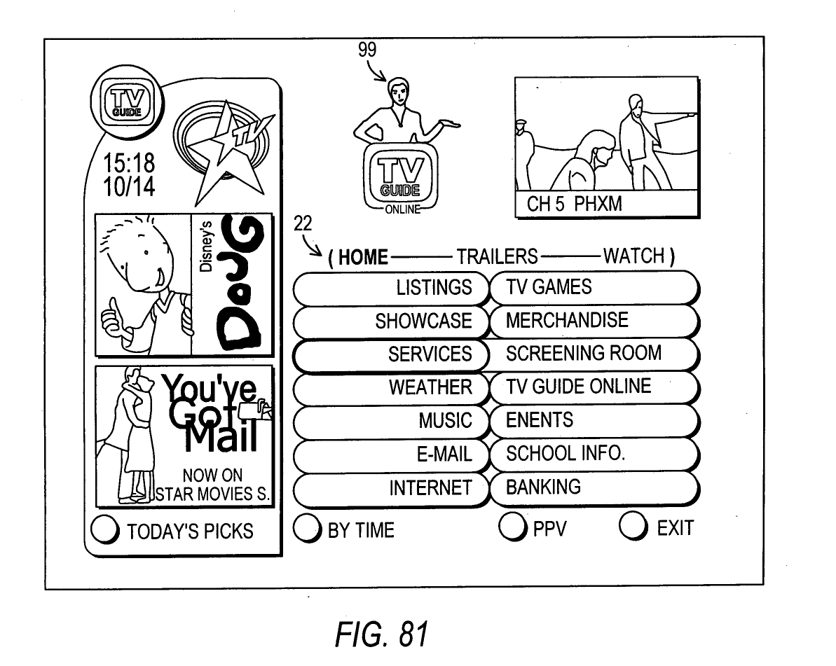

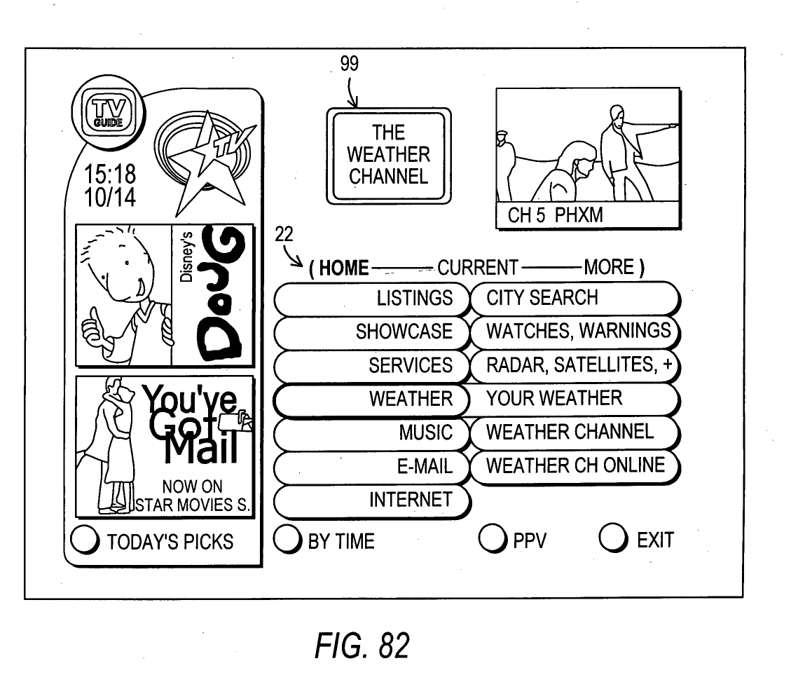

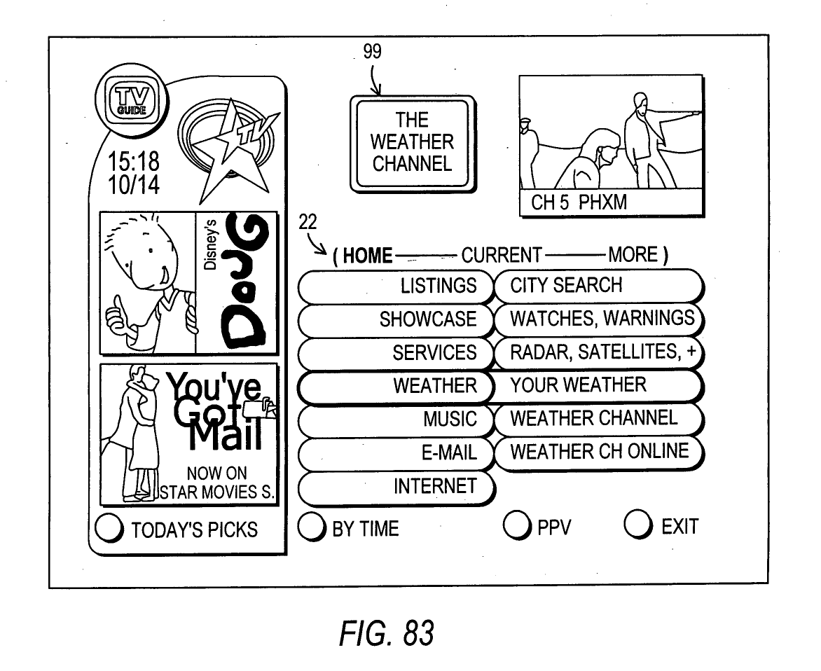

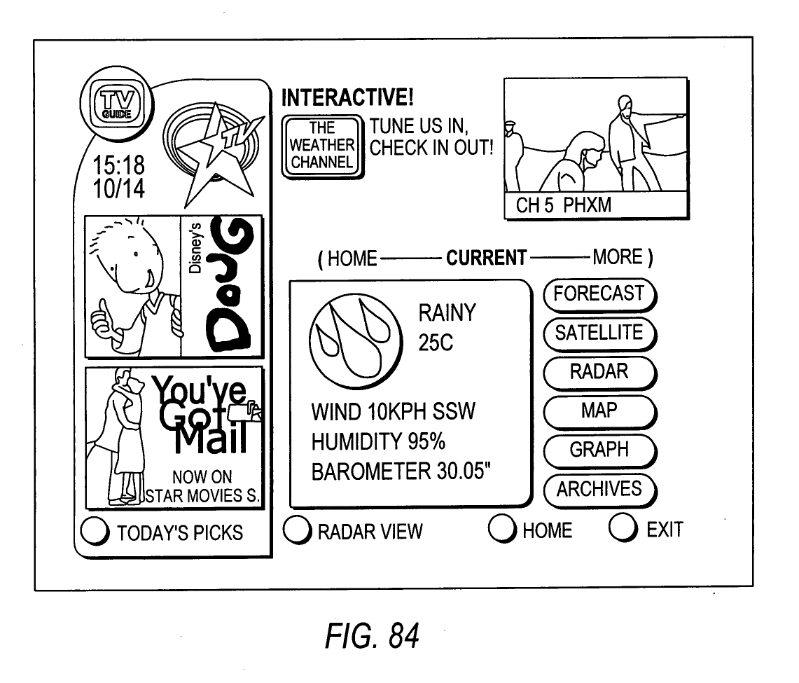

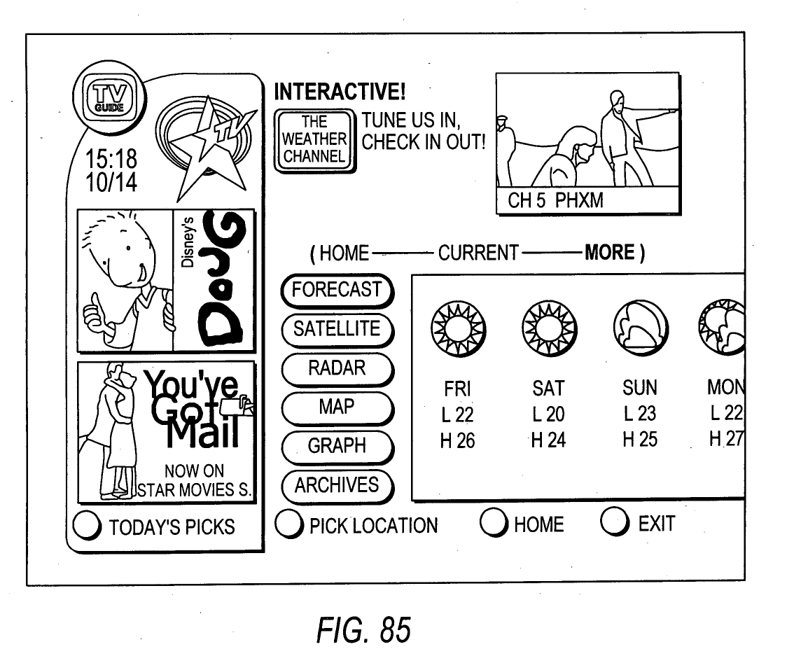

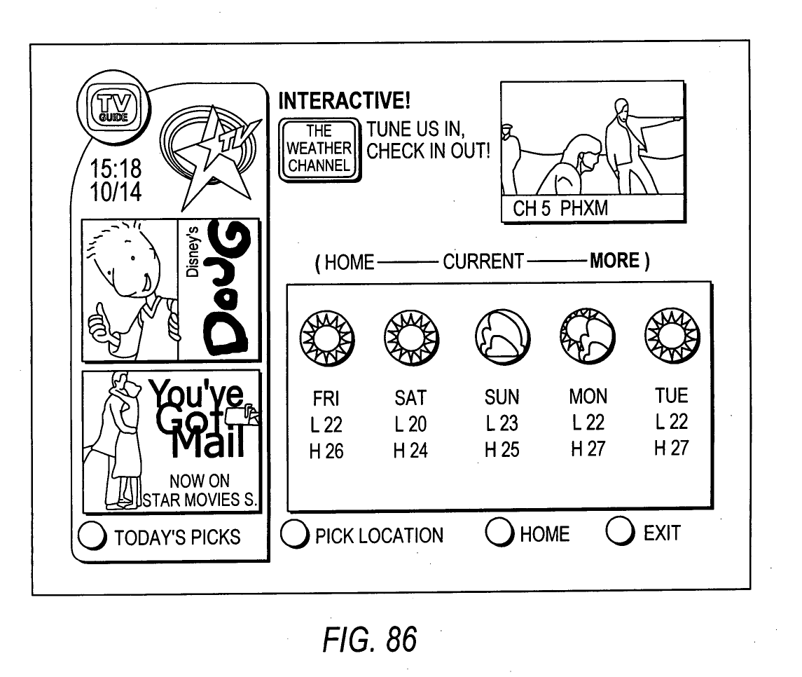

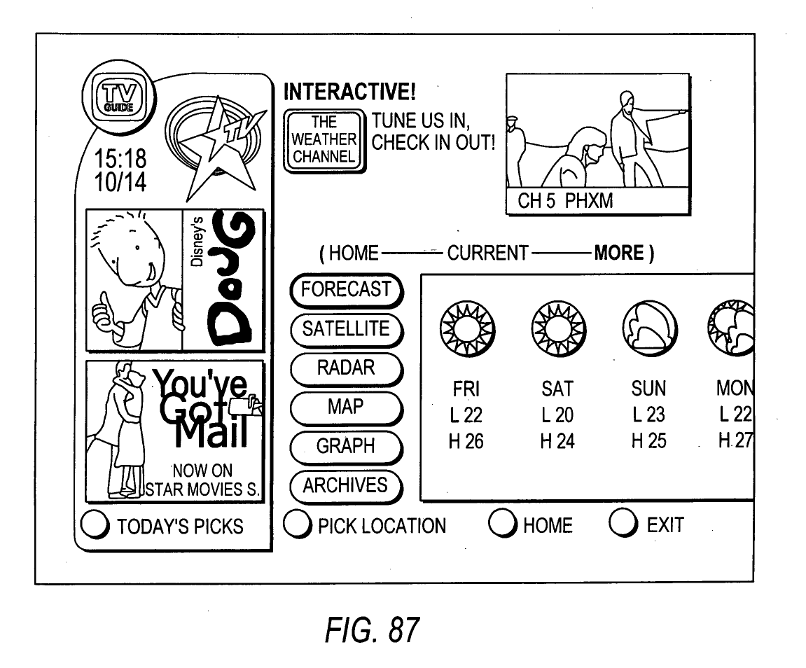

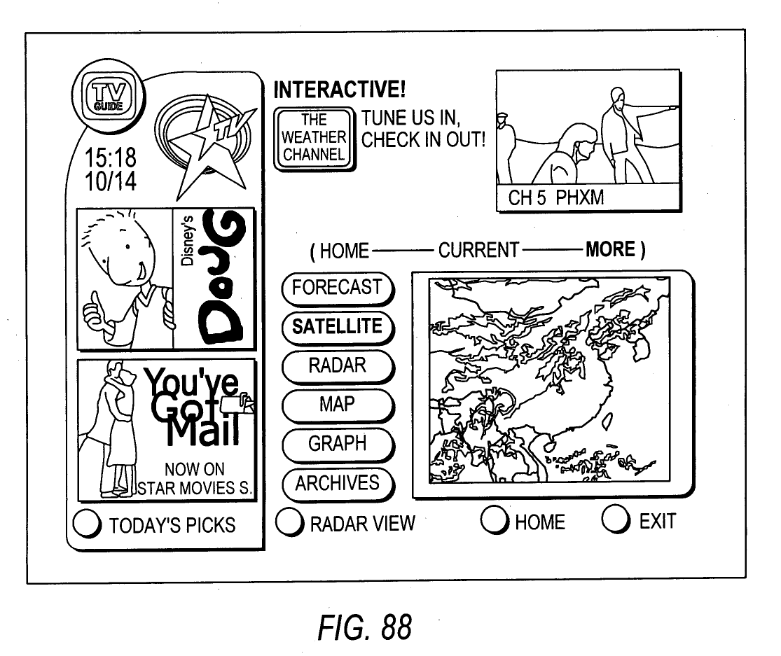

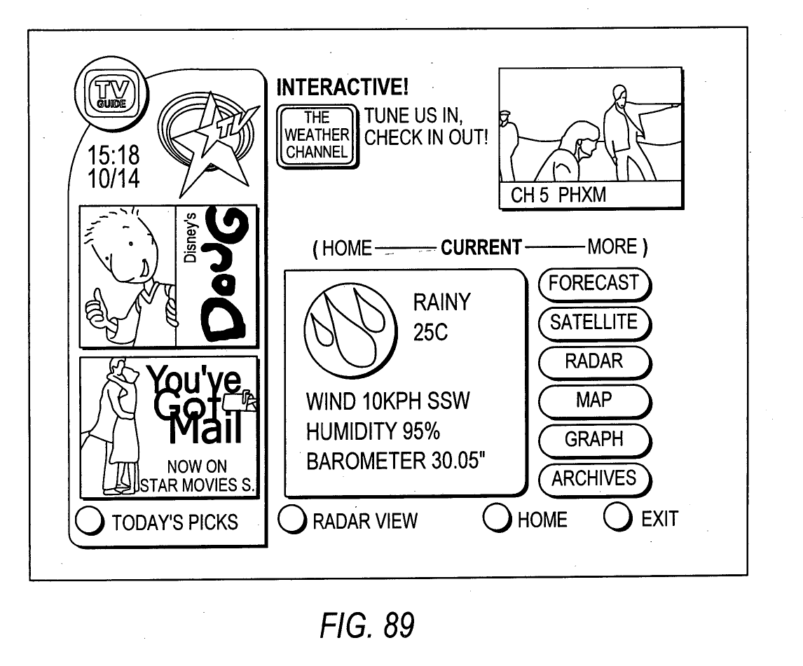

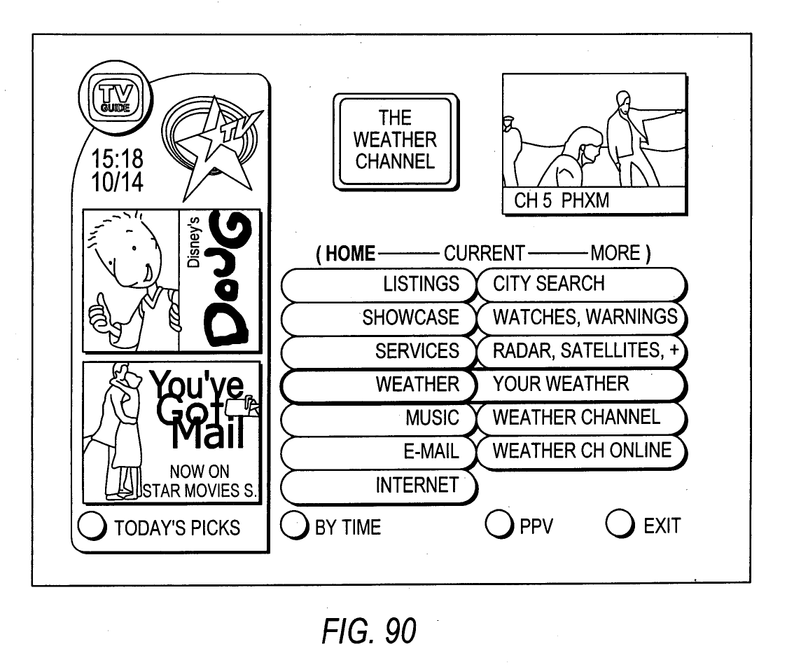

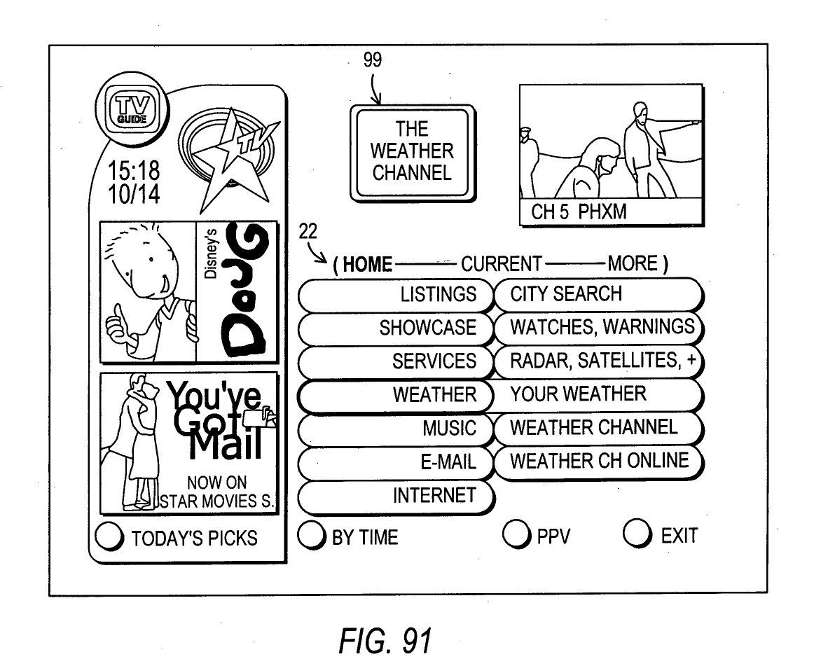

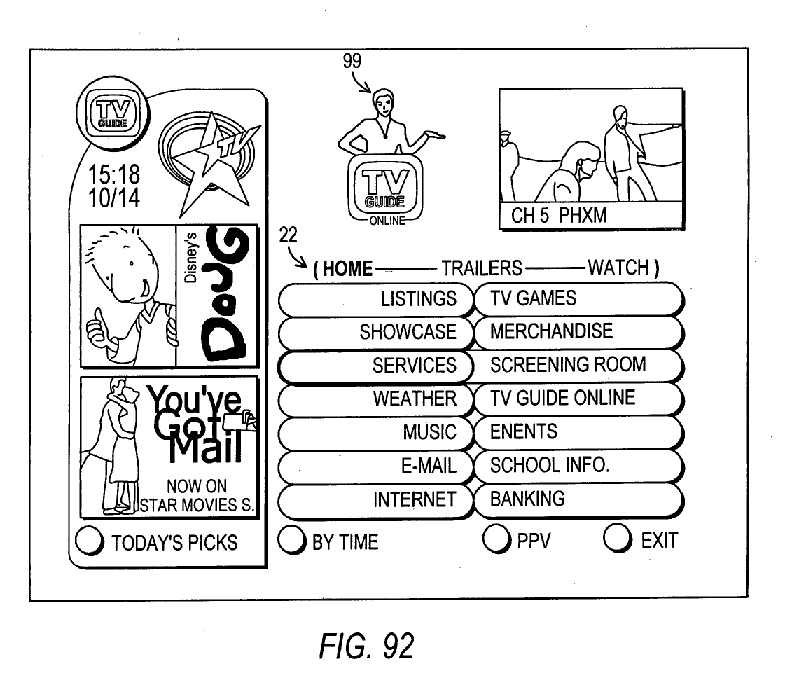

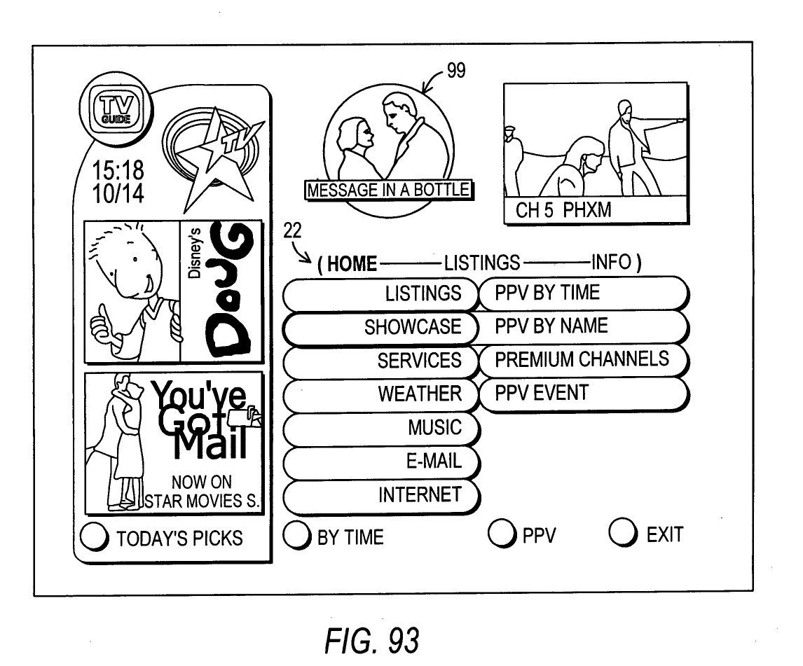

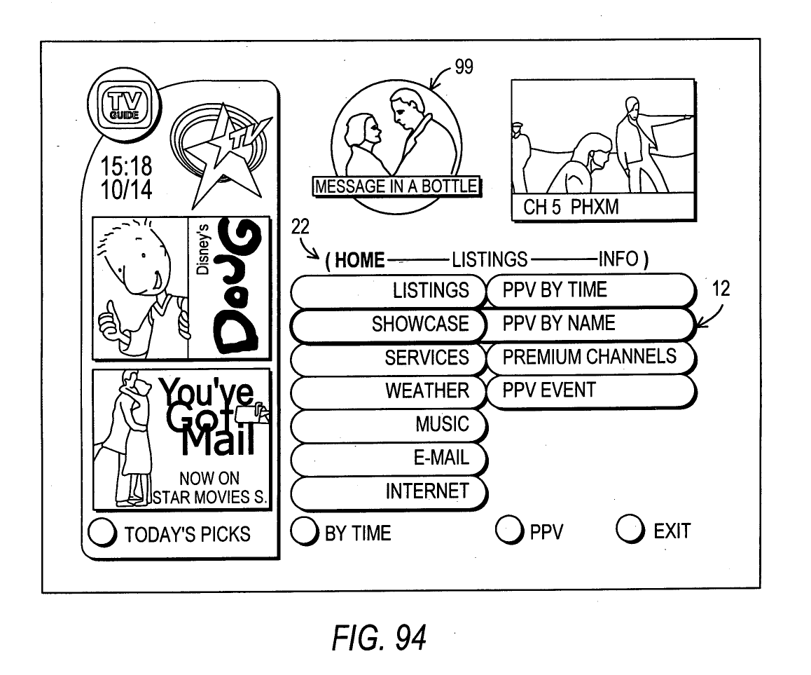

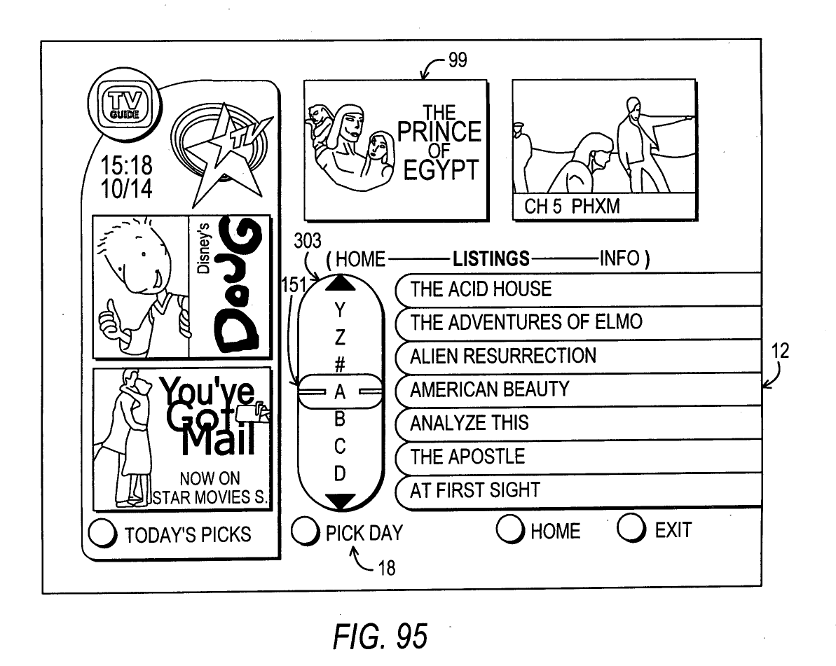

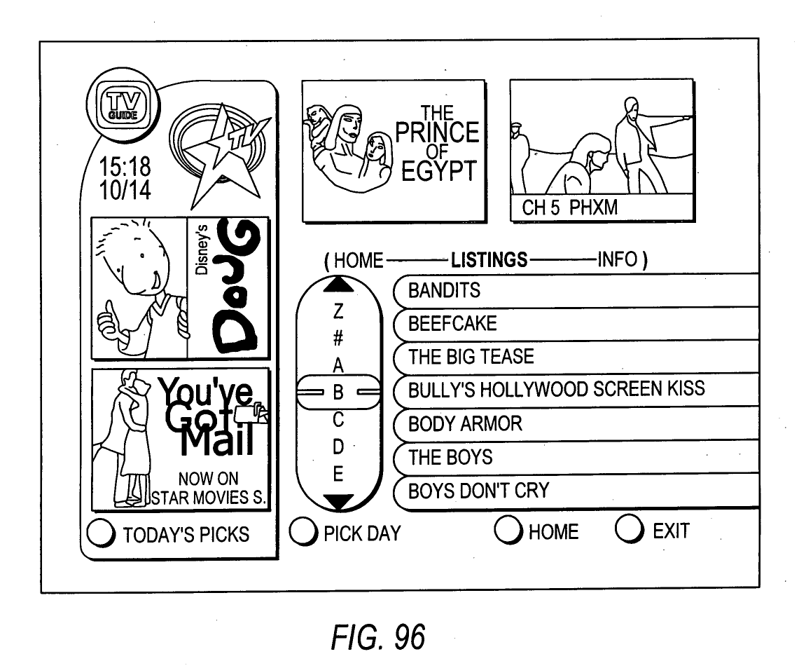

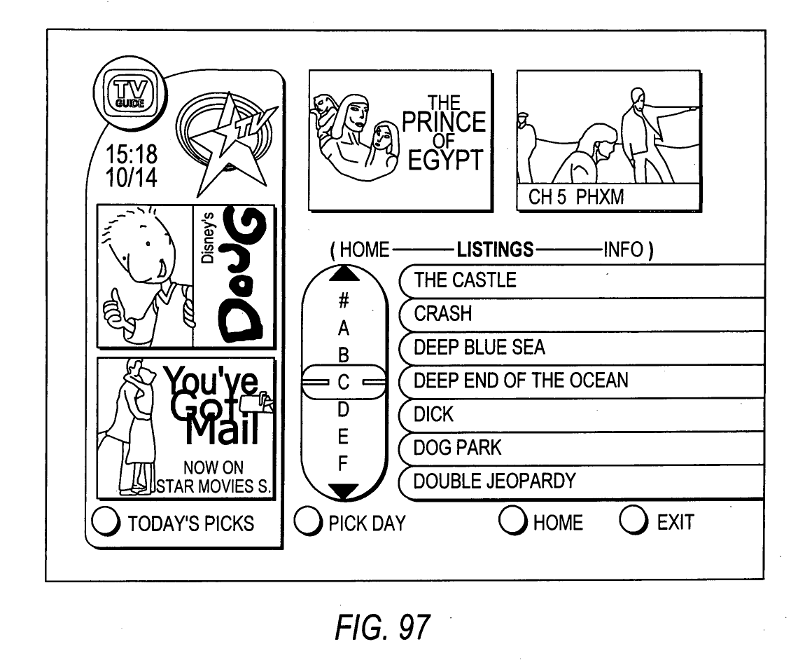

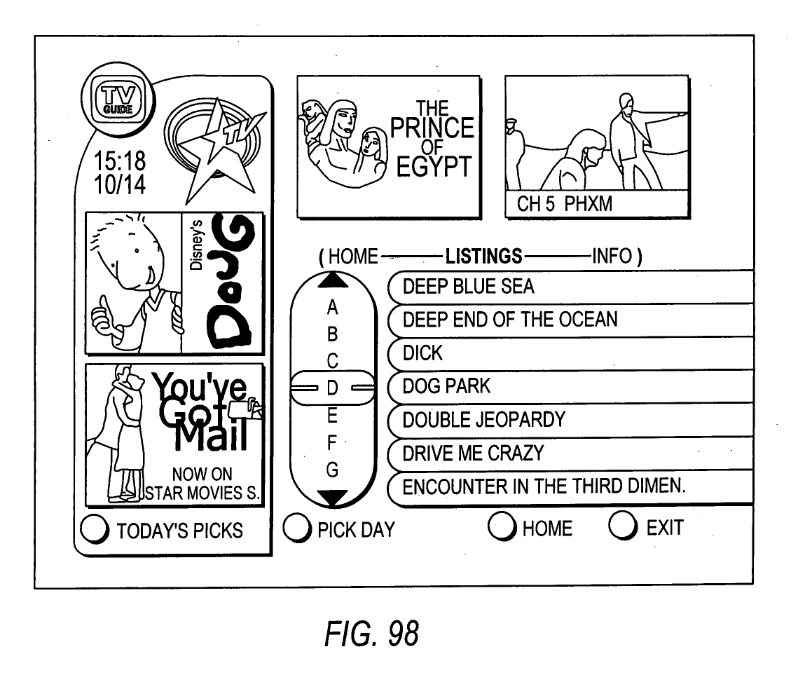

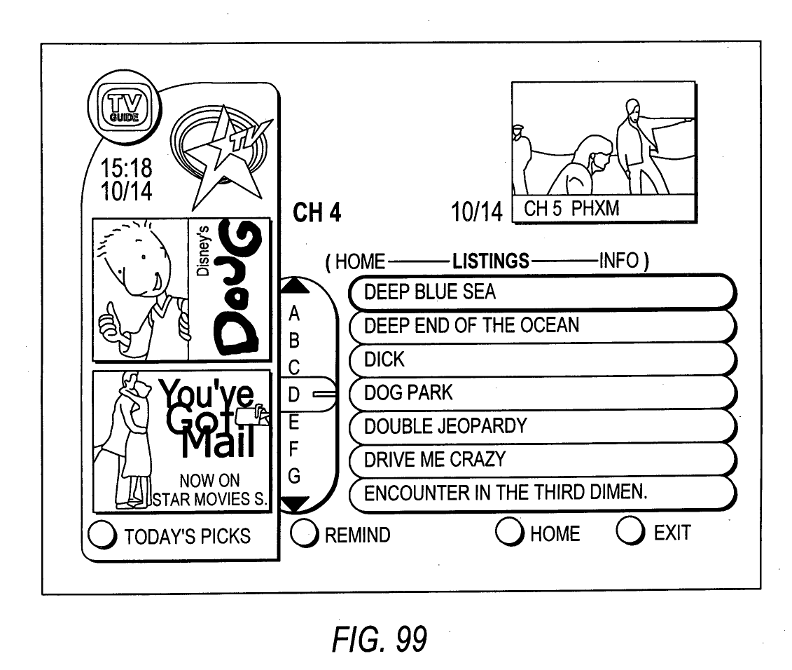

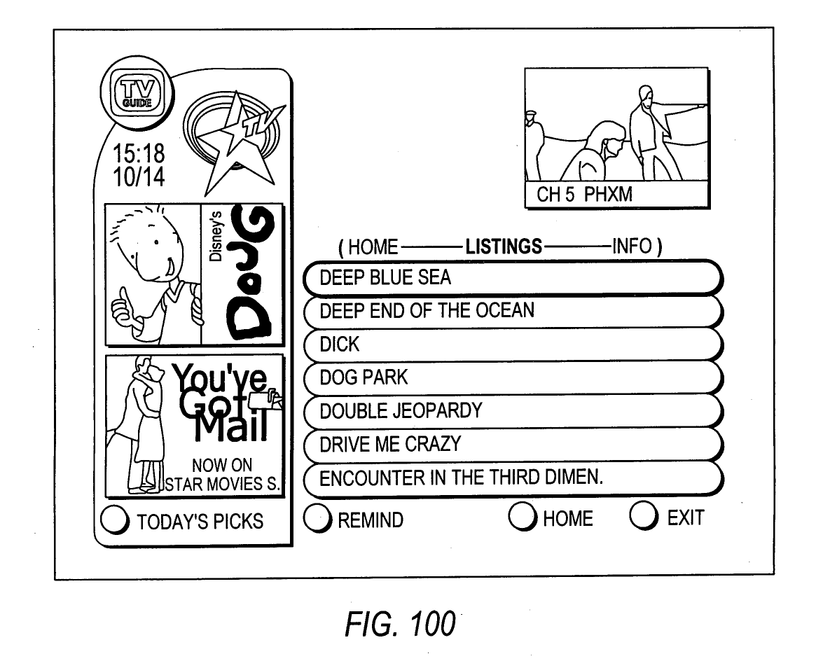

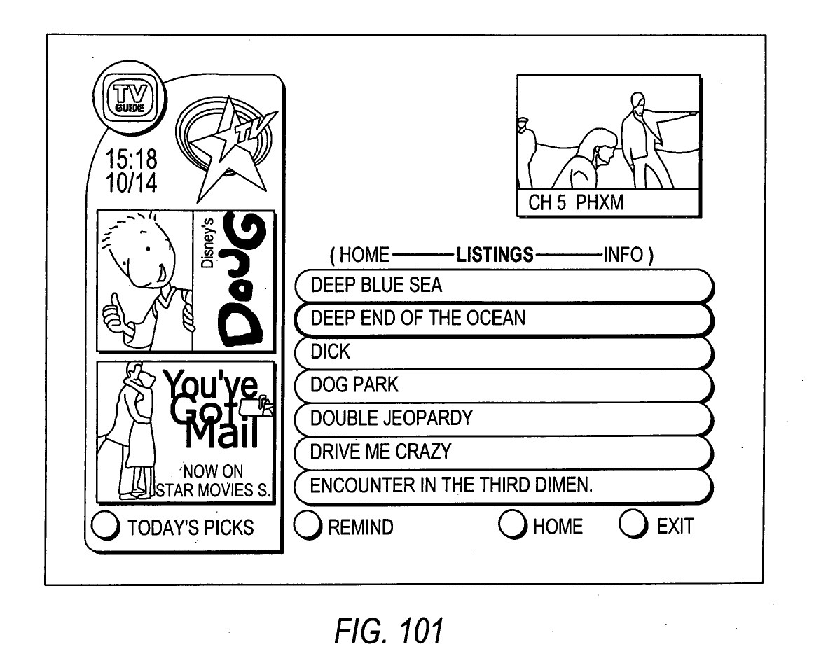

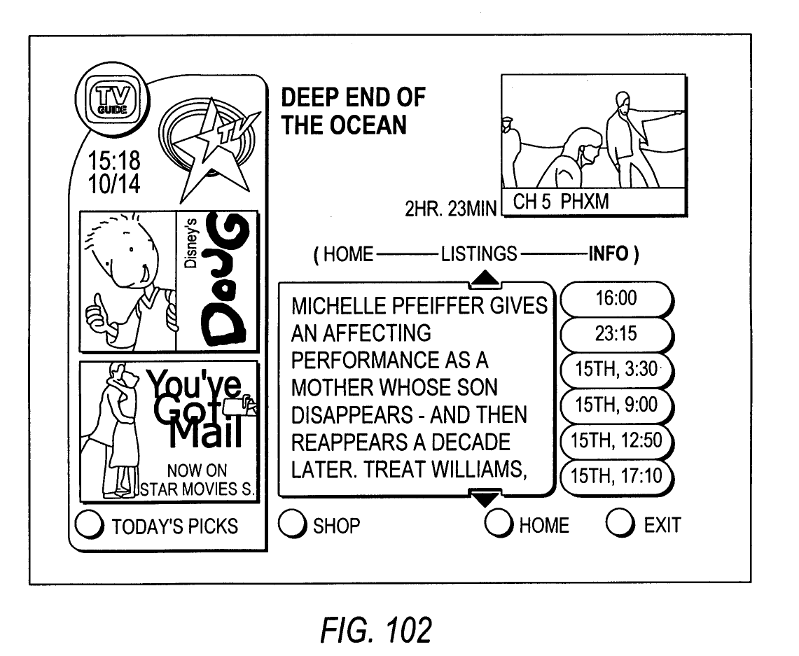

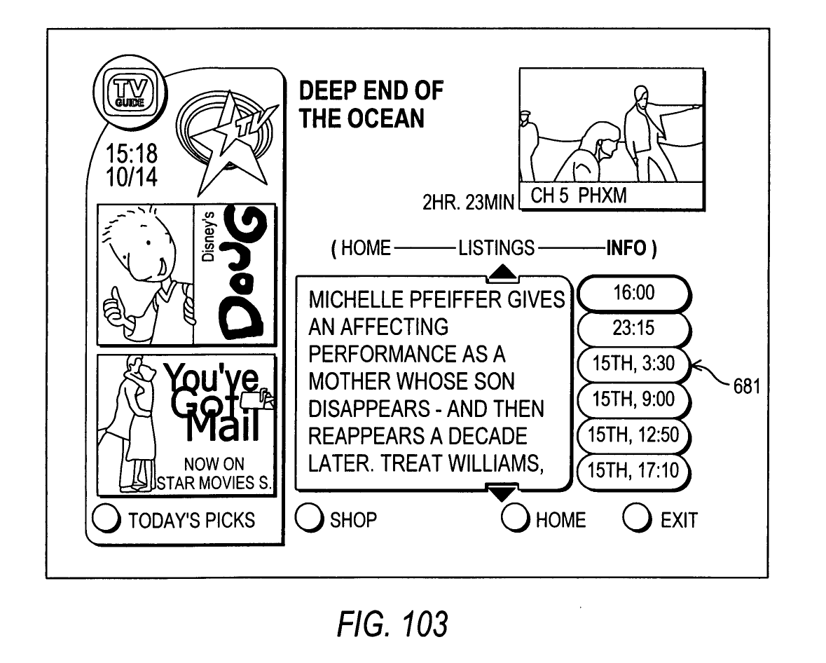

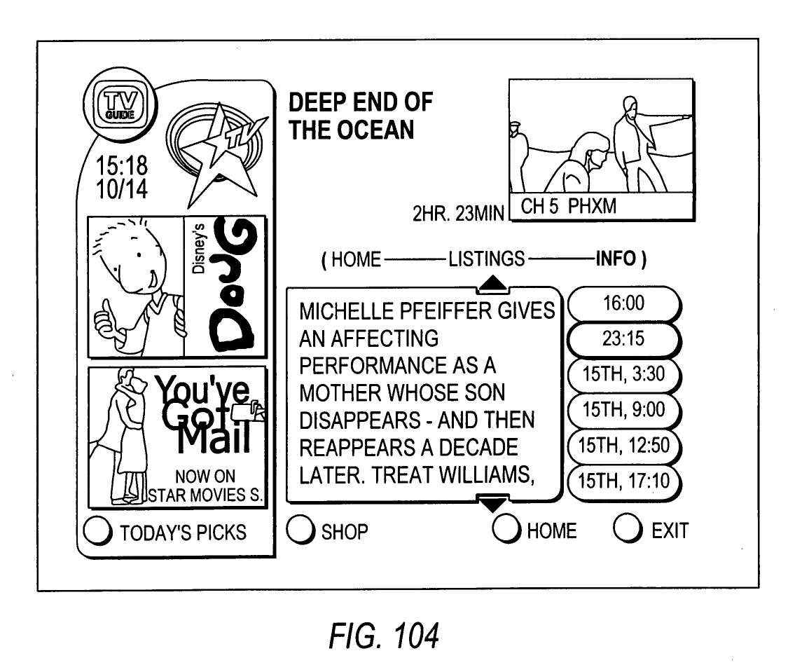

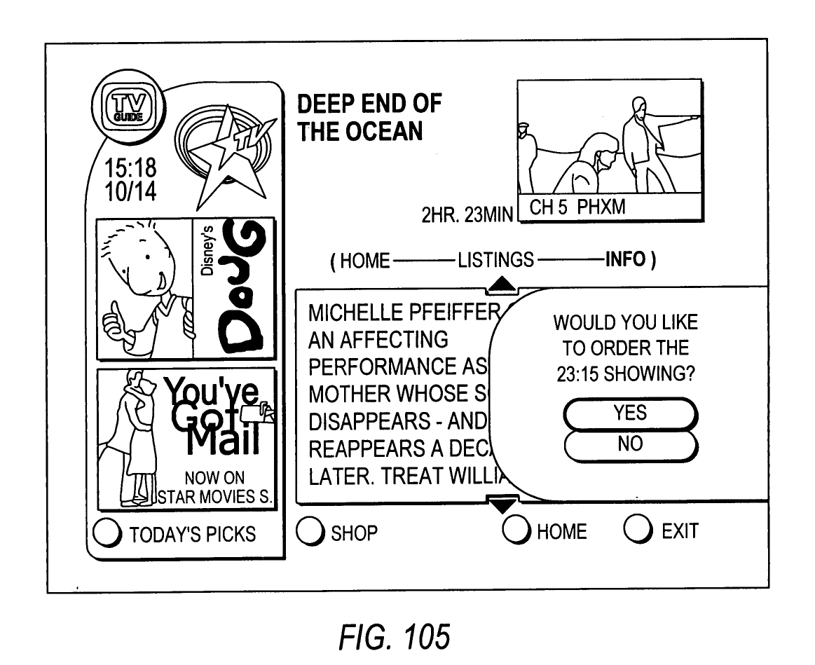

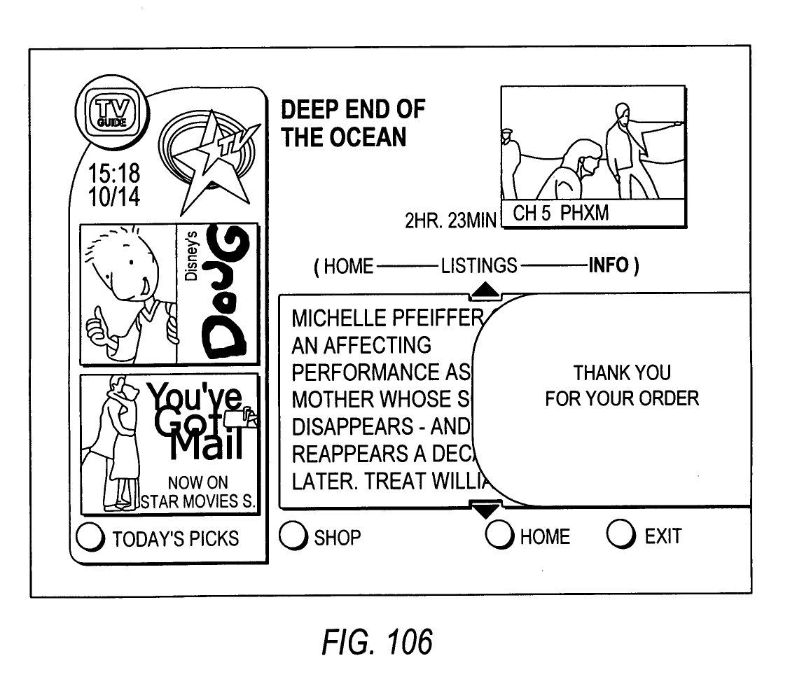

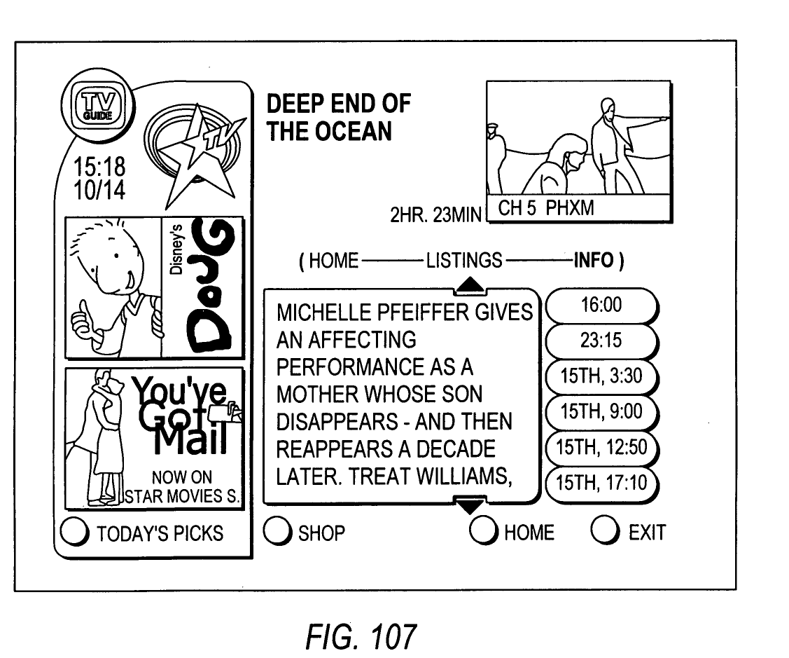

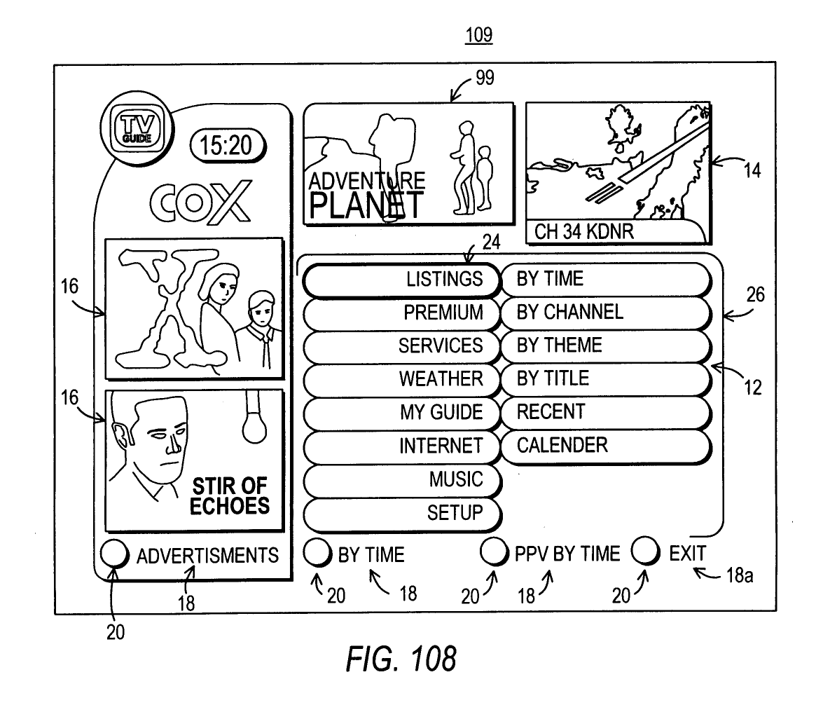

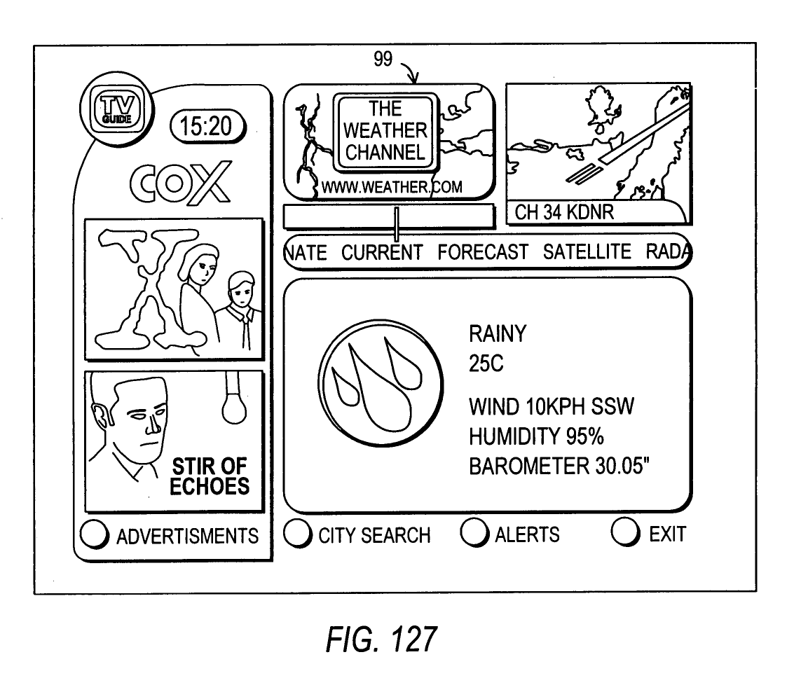

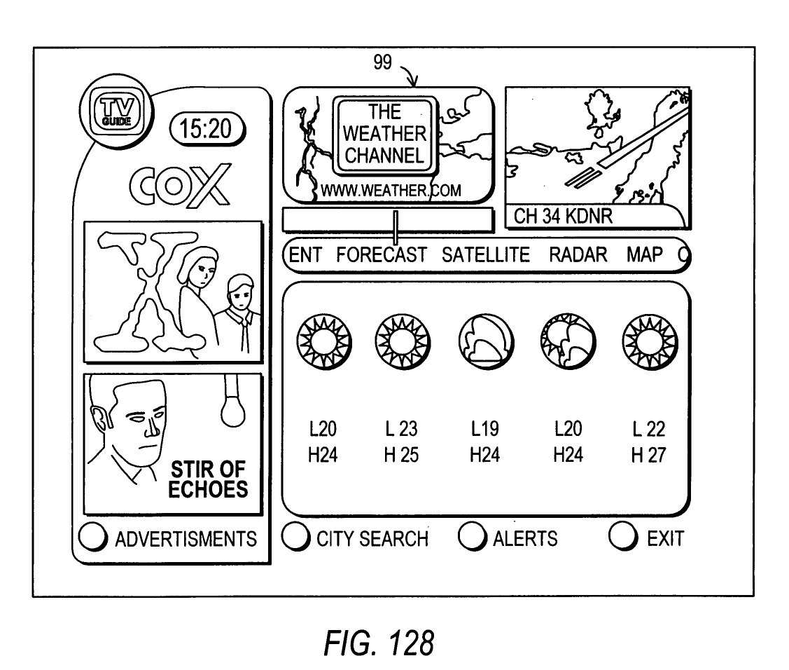

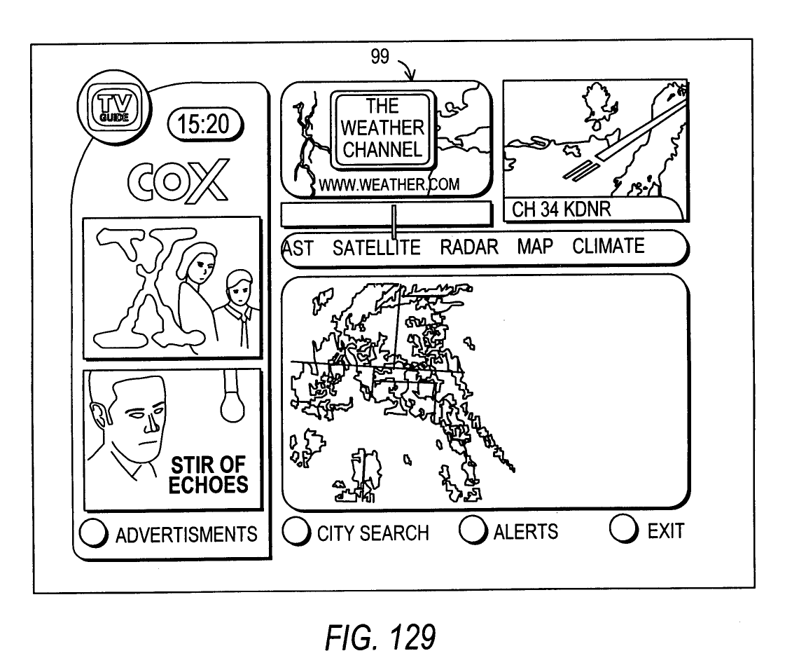

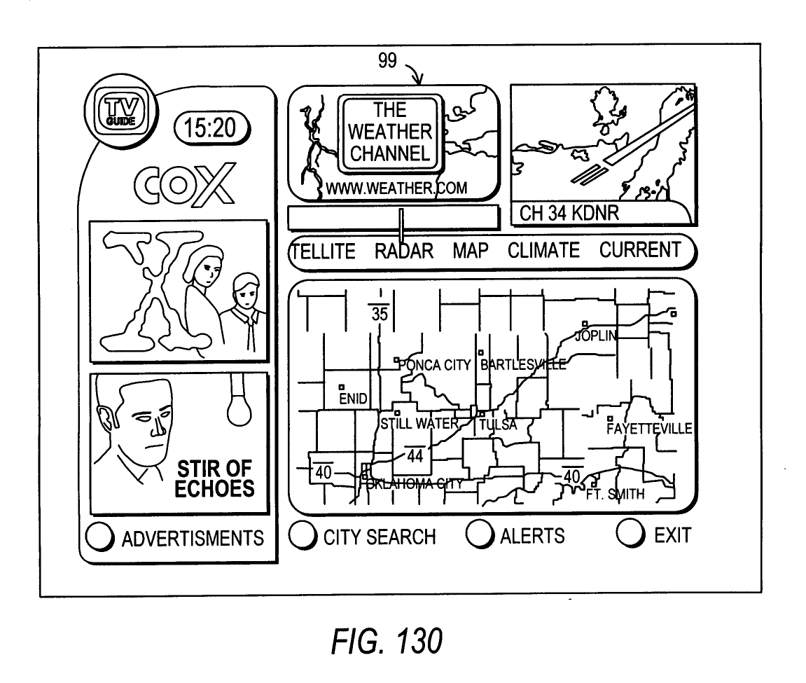

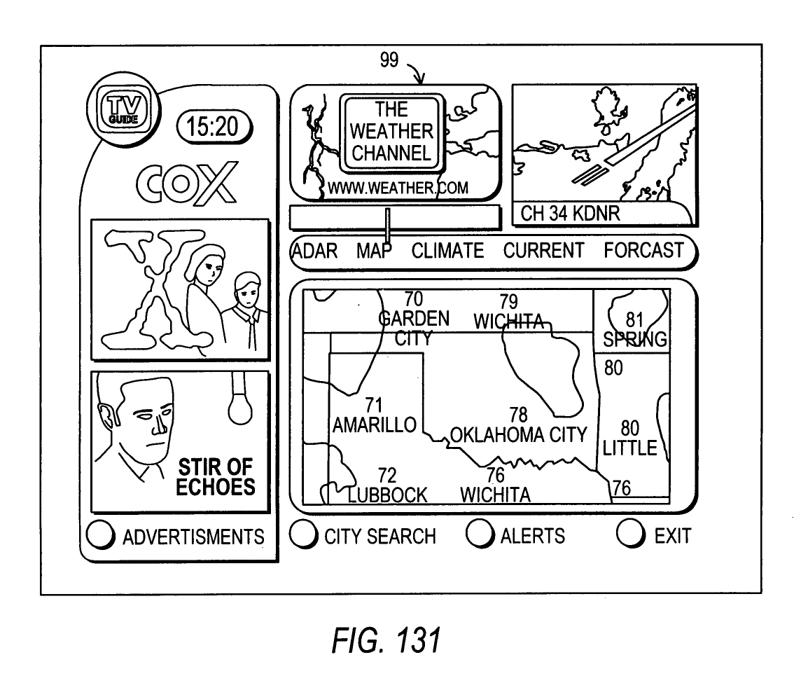

A third suitable interface approach in accordance with the present invention is shown in FIGS. 108-137B This approach is described, for example, in Moore et al. U.S. provisional patent application Ser. No. 60/170,386, filed Dec. 13, 1999, which is hereby incorporated by reference herein in its entirety. The approach shown in FIGS. 108-137B includes some of the display elements of the other approaches described herein. Some of these display elements such as, for example, anchor bar 22 and display region 38 have different display characteristics.

An illustrative screen 109 that may be displayed by the program guide of the present invention is shown in FIG. 108. Screen 109 may be displayed when a user first invokes the program guide. Screen 10 may contain various options 12. Screen 109 may also contain a picture-in-guide window 14 that contains video for the television program on the channel to which the set-top box is currently tuned. Interactive advertisements 16 may also be displayed as part of screen 109.

Screen 109 may contain options 18 for various program guide functions. The user may select a desired one of options 18 by, for example, pressing a color-coded key on the remote control. The color of the key may match the color of the dot 20 that is associated with the option. For example, the exit option 18a may have an associated dot 20 that is blue. When the user presses a corresponding blue key on the remote control, the program guide may perform function 18a. In the example of FIG. 108, function 18a directs the program guide to cease displaying screen 10, so that the user may return to the television program on the channel to which the set-top box is currently tuned (i.e., watch television (TV)). The color-coded buttons on the remote control may be the same as those that are sometimes used in certain countries to access teletext functions. Any suitable type of coding may be used if desired. Color coding is merely an example.

Another feature in FIG. 108 relates to advertisement tray 99. Advertisement tray 99 may display any suitable passive or interactive graphic, text, video, or other advertisement for a program, product, or service within the scope of the subject matter of a given feature, option, or function of the guide. If desired, a third party may purchase advertising space in the guide that corresponds to a given feature, option, or function. In FIG. 108, for example, the title “Adventure Planet” is being advertised. This may indicate, for example, that Adventure Planet is listed somewhere in program listings. Tying advertisements in advertisement tray 99 (e.g., the advertisement for “Adventure Planet”) to the subject matter of a given feature, option, or function, may provide users with an increased awareness of guide content, as opposed to simply subjecting users to advertisements for products or services without providing them with additional information related to the guide.

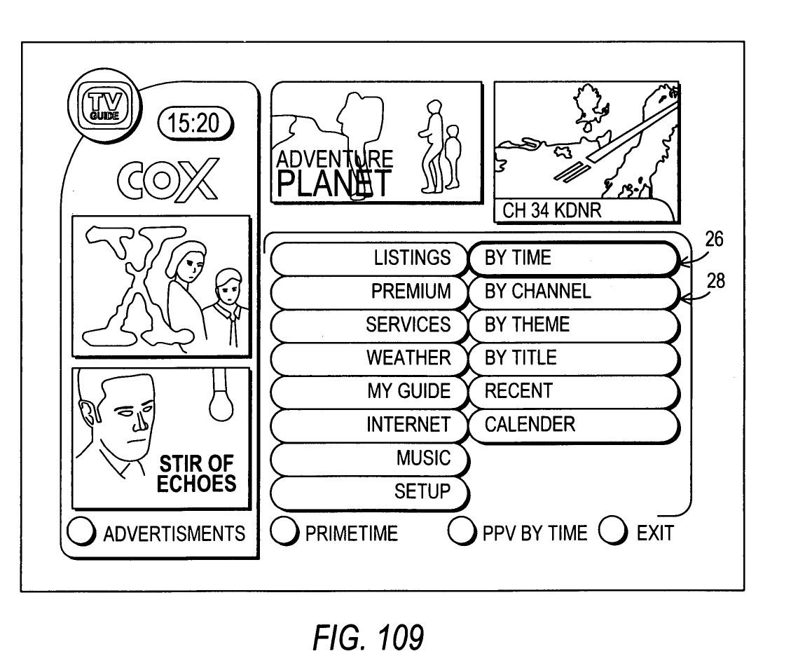

Users may access options 12 using any suitable approach. The user may move to by time option 26, for example, by pressing a right arrow key on the remote control or by pressing select (or pressing enter or pressing OK, etc.), as shown in FIG. 109. The selected option (listings) may be displayed in a different color (e.g., orange) than the other options. When any element on the display is active so that the user may select or otherwise interact with the element, that element may be, for example, lightened. Any inactive element (e.g., the options in the left column or the unselected advertisements) may be darkened relative to the active elements (e.g., the options in the right column) to show that they are inactive. The currently highlighted active element is the current selection among the active elements (e.g., the options in the right column). The user may move from by time option 26 to by channel option 28 by pressing, for example, a down arrow key on the remote control.

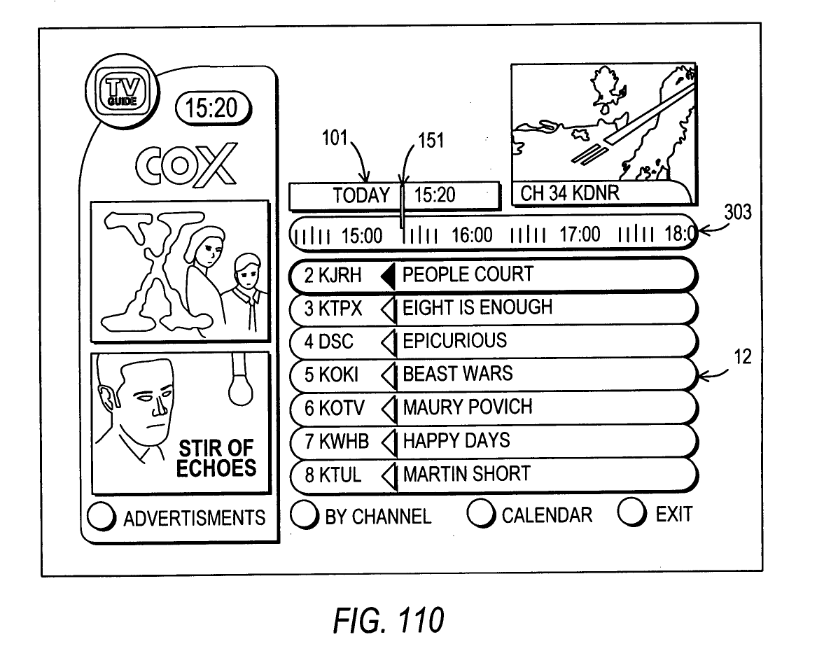

The various screen elements shown in FIGS. 108 and 109 may be displayed throughout the program guide. Picture in guide window 14, for example, may be displayed in substantially all of guide display screens to provide users with an opportunity to watch the current channel while using the guide. Advertisement 16, for example, may be displayed on substantially all of the guide screens to maximize the guide provider's opportunity to promote various titles. Advertisement tray 99 may also be provided on screens when the user has selected an option or accessed a feature or function of the guide for which an advertisement is available. FIG. 110 shows an illustrative listing by time screen that the guide may display in response to the user selecting “by time” option 26.

FIG. 110 illustrates the display of navigational bar 303. Navigational bar 303 may provide users with an opportunity to view options 12 that correspond to the currently selected position in bar 303. Navigational bar 303 may display any suitable information that indicates available criteria for the options in the current display. Navigational bar 303 may include, for example, times, channels, features, or any other suitable criteria. In the example of FIG. 110, the user has positioned indicator 151 of bar 303 to time 15:20 for the current day. Options 12 display programs that air at 15:20 accordingly. To view listings for additional times, the user may position indicator 151 (e.g., by pressing left or right keys on a remote control) to the desired time. Indicator 151 may, for example, maintain its position relative to bar 303 and the times may scroll left and right. Alternatively, indicator 151 may move left and right. In addition to indicator 151 and bar 303, sliver 101 may be displayed. Sliver 101 may display, for example, information related to the currently active option. This may include, for example, channel names, start times, program names, or any other suitable information. In this example, sliver 101 includes a label indicating the current position in bar 303. In this example, indicator 151 indicates to the user that listings for programs airing at 15:20 on the current day are displayed. Indicator 151 may change as the user manipulates bar 303 (e.g., by arrowing right or left). If the user manipulates bar 303 so that listings for the previous or next day are displayed, sliver 101 may display the name of the day for the displayed listings.

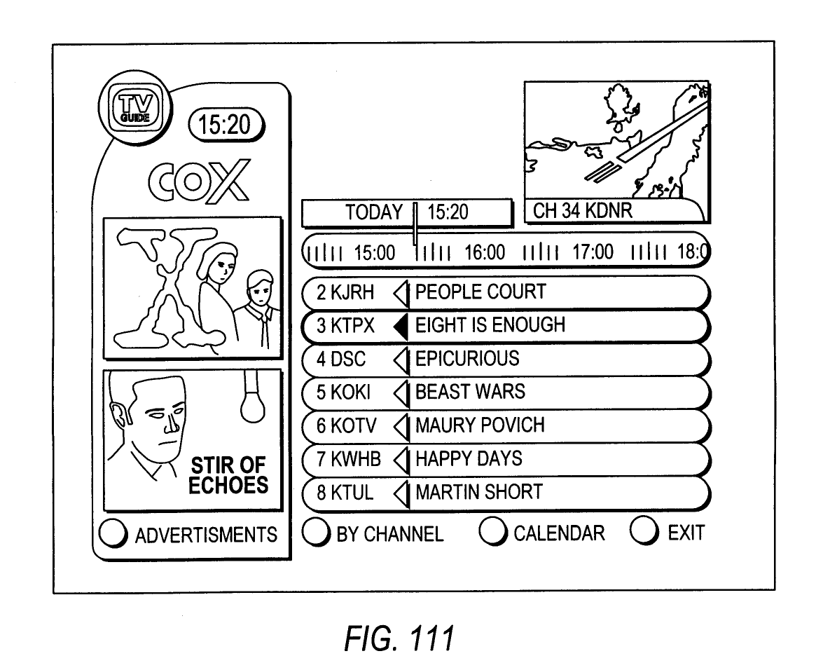

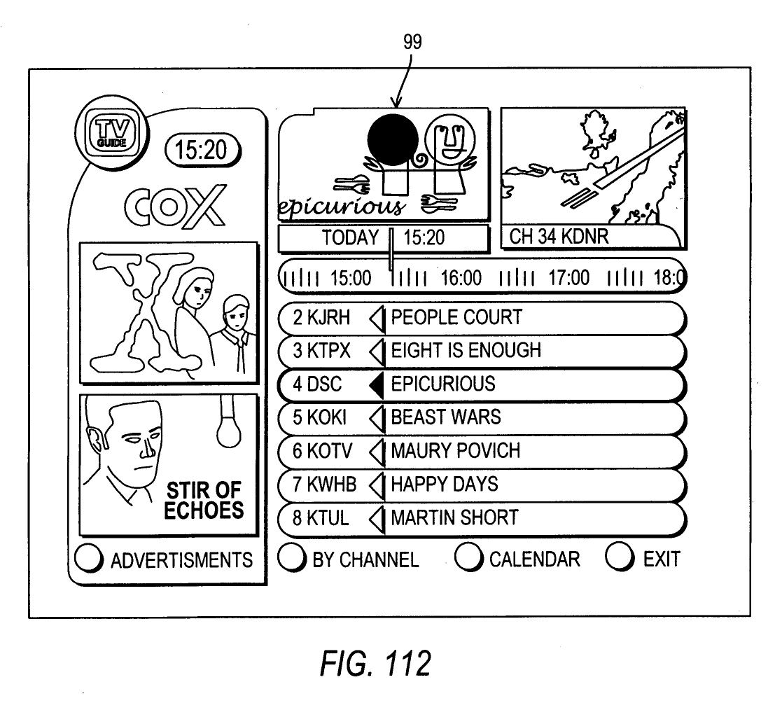

Users may view additional listings for the air time currently selected in bar 303 by, for example, arrowing down or up. As illustrated when comparing FIGS. 110 and 111, no advertisements have appeared in advertisement tray 99 because, for example, no sponsor has purchased advertisement space in the by time screen for a given feature. In FIG. 112, the user has navigated to the listing for “Epicurious.” In this example, advertisement tray 99 displays an advertisement because a sponsor has purchased advertisement rights for that particular listing. As mentioned earlier, advertisement tray 99 displays advertisements only for those products or services that are somehow related to the feature, option or function. In this example, the user's guide experience is enriched because additional graphical content (i.e., an advertisement for Epicurious) is displayed that further illustrates the listing to which the user has navigated.

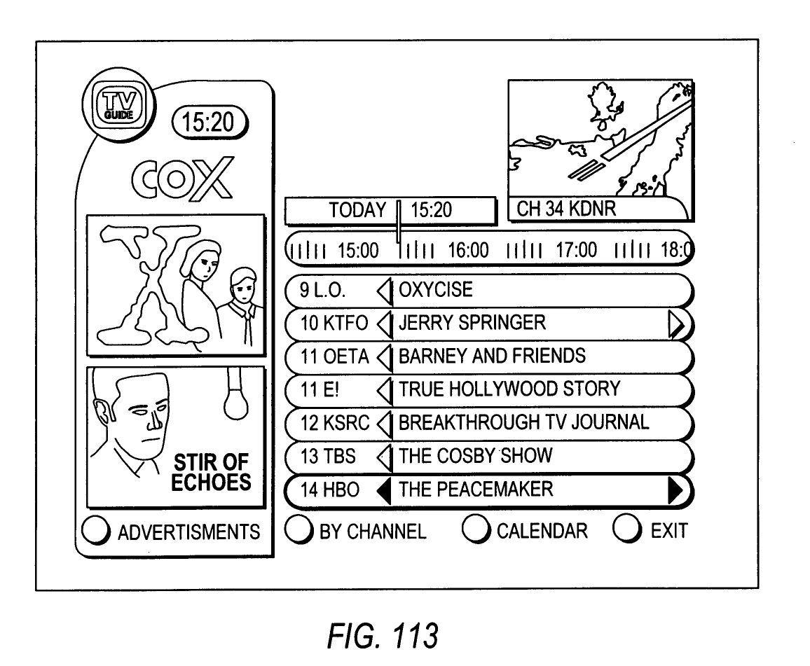

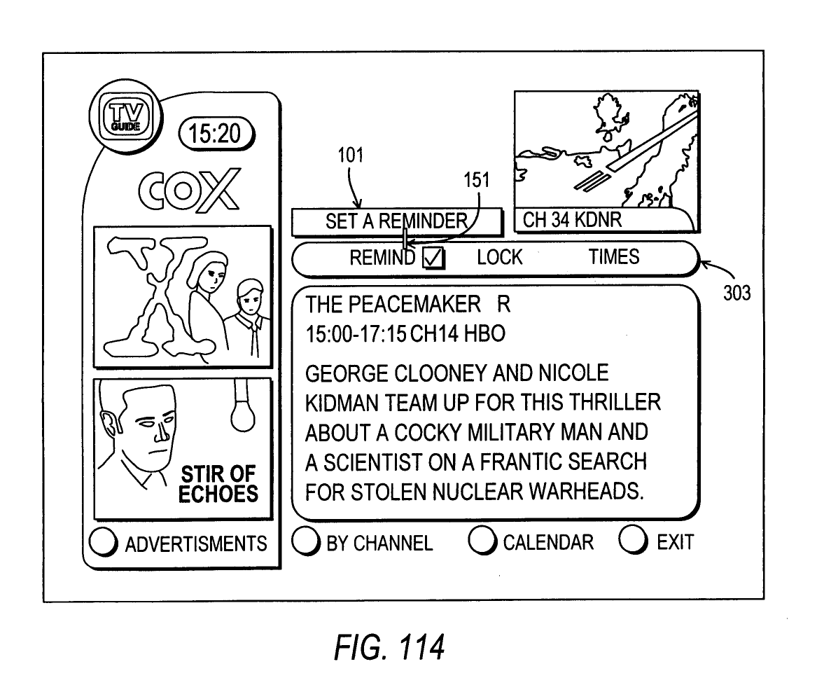

In FIG. 113, the user has navigated to a listing for “The Peacemaker” (e.g., by arranging or paging downward). As with other listings, the user may obtain additional information for a title by selecting the listing for the title (e.g., pressing on “info” or “enter” key on the user's remote control). In response, the guide may display an additional information screen, as shown, for example, on FIG. 114. The illustrative information screen of FIG. 114 may display information about a title (e.g., title, channel, rating, air time, and description). If there is more information than can fit in a single screen, the guide may provide the user with an opportunity to scroll or page up or down to access the information.

The guide may also provide the user with an opportunity to access other guide features from within an additional information screen. The guide may, for example, provide the user with an opportunity to schedule a reminder for a program, lock a program, see additional air times for a program, or access any other suitable feature. Program guide systems in which user are provided with an opportunity to access additional features are described, for example, in Rudnick et al. U.S. patent application Ser. No. 09/356,268, filed Jul. 16, 1999, which is hereby incorporated by reference herein in its entirety. The available features may be displayed, for example, in navigational bar 303. To access additional features, the user may, for example, arrow right or left. Indicator 151 may indicate the current feature (e.g., by indicator 151 moving relative to the listed features or vice versa), and sliver 101 may display a short description of the feature (e.g., “set a reminder,” “lock programs,” etc.). In FIG. 114, for example, the user has scheduled a reminder for the featured program (e.g., by pressing “enter” or “ok” after navigating to the reminder feature). The guide may display reminder indicator 701 in sliver 101 to indicate a reminder has been scheduled. The user may return to a main menu screen, such as the illustrative display screen shown in FIG. 108, by, for example, arrowing left until home or pressing “guide” or “menu” key.

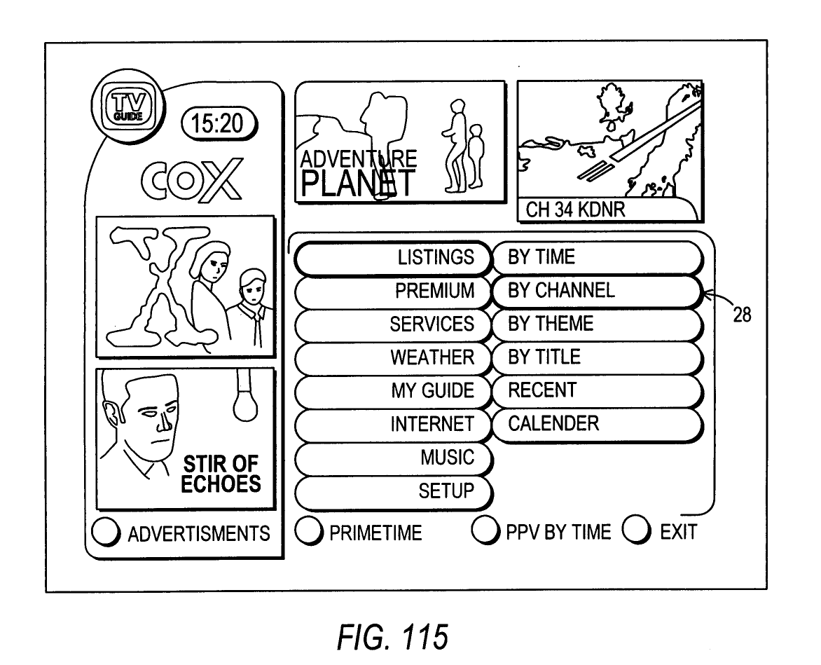

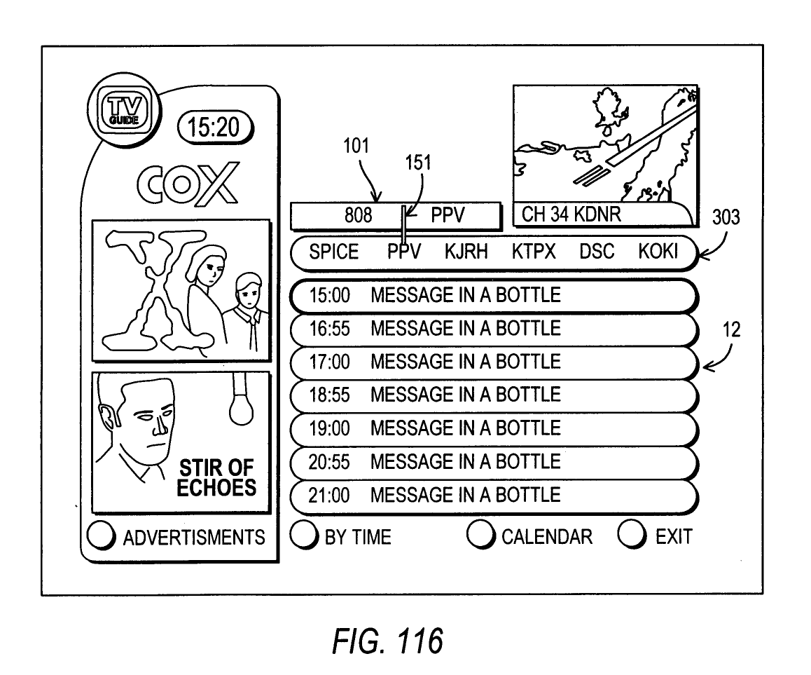

The guide may provide users with an opportunity to access listings by channel. Users may indicate a desire to access listings by channel by, for example, selecting channel option 28 as shown in FIG. 115. FIG. 115 shows the display of an advertisement in advertisement tray 99. In this example, “Adventure Planet” is being listed in one of the listings. In response to the user indicating a desire to view listings by channel, the guide may display a listings by time channel as shown in FIG. 116.

In the example of FIG. 116 the user has navigated within bar 303 to channel 808 PPV. Options 12 display programs airing on channel 808 PPV accordingly. To view listings for additional channels, the user may, for example, press left or right keys on a remote control to navigate within bar 303. Indicator 151 may, for example, maintain its central position relative to bar 303 and the channel letters 901 may scroll left and right. Sliver 101 may display the channel number and call letters for the channel indicated by indicator 151. Alternatively, indicator 151 may move, or a combination of these approaches may be used.

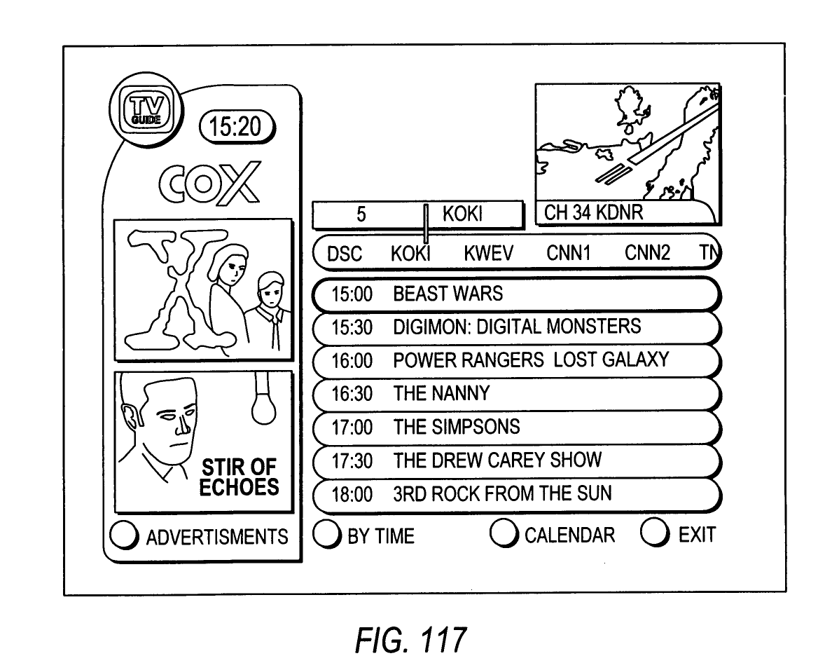

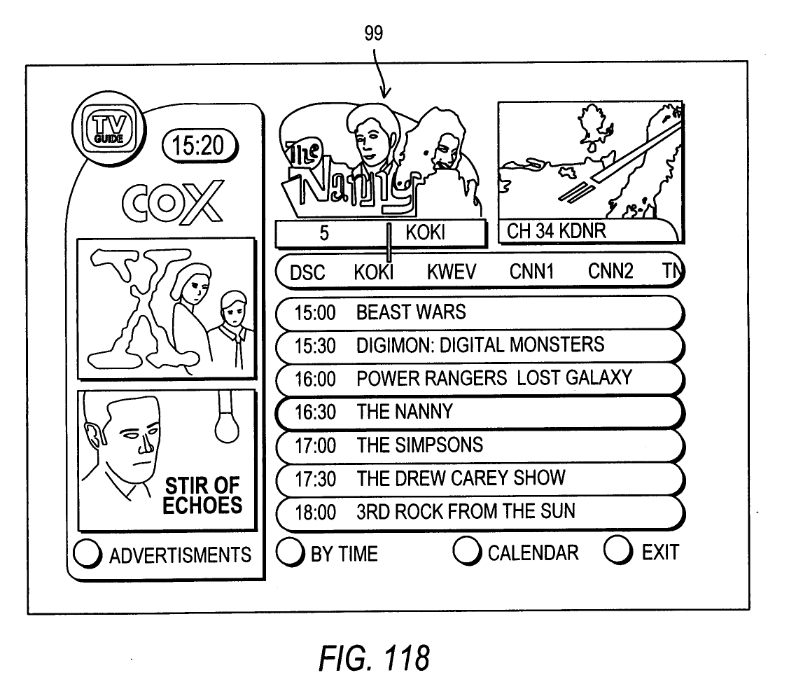

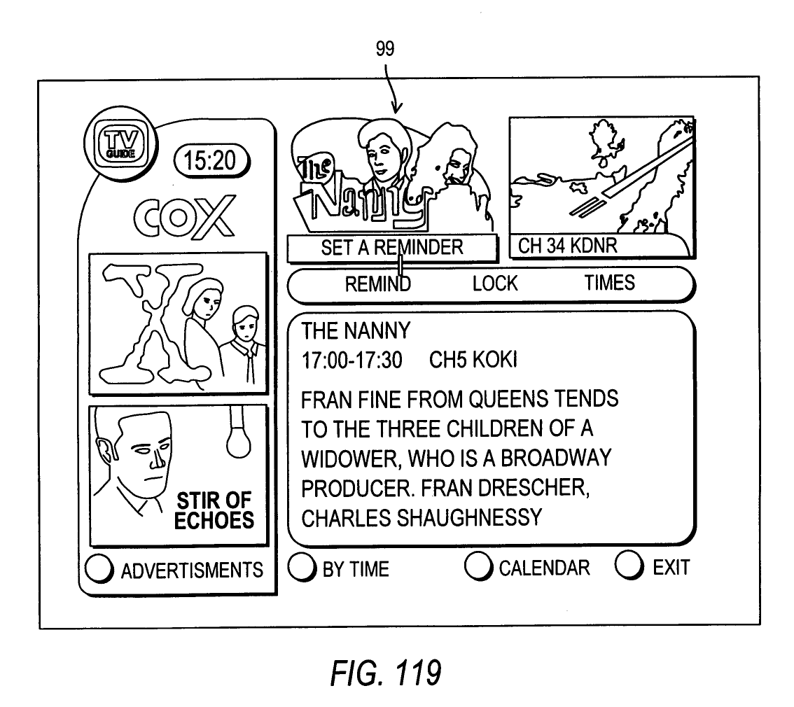

FIG. 117 shows the display of program listings in response to the user indicating a desire to view program listings for channel KOKI (e.g., by arrowing right). As shown, no advertisement is available for the current option. In FIG. 118, the user has navigated to the listing for “The Nanny” (e.g., by arrowing down). In this example, an advertisement is available for the time 16:30 (e.g., an advertisement for “The Nanny”), and is displayed in advertisement tray 99. The user may access additional information for the listing by, for example, pressing an “info key.” FIG. 119 shows an illustrative additional information screen for the Nanny. As shown in FIG. 119, information screens may include. In FIG. 119, unlike FIG. 114, a sponsor has purchased advertisement space in advertisement tray 99. In this example, an advertisement for “The Nanny” is displayed, enriching the user's experience while providing the system provider with an advertising opportunity.

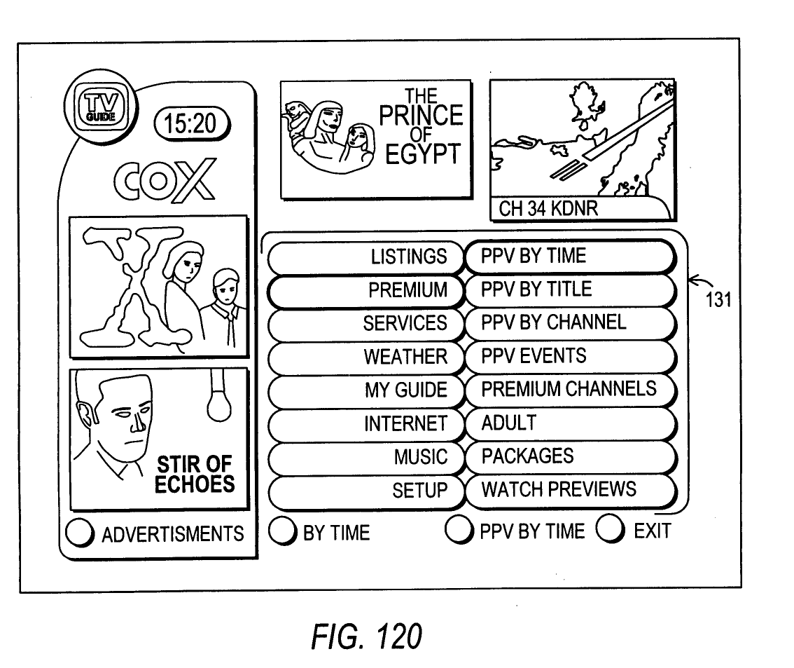

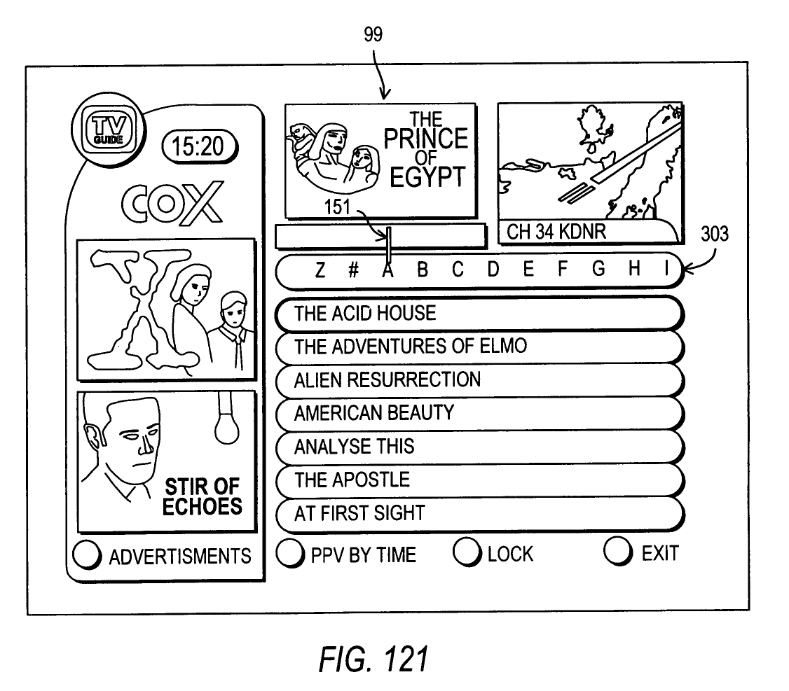

FIG. 120 shows options 12 that the guide may display in response to the user selecting a premium option. In practice, the number of options 12 available may be dynamically configurable in this screen, or any other screen if suitable. FIG. 120 also illustrates the display of an advertisement in advertisement tray 99. The advertisement shown may, for example, be for a pay-per-view program that is featured in the premium feature. As shown, the user may access pay-per-view listings by time, title and channel, and may also access pay-per-view events, premium channels, adult pay-per-view, and pay-per-view packages. The user may also access a screening room in which the user may watch previews. The user may, for example, indicate a desire to view pay-per-view listings by title (e.g., by selecting “ppv by title” option 131). In response, the guide may display a pay-per-view by title screen, such as the illustrative screen shown in FIG. 121.

In the example of FIG. 121, indicator 151 of bar 303 is initially positioned over the letter “A”. Options 12 display pay-per-view program listings that begin with the letter “A” accordingly. To view pay-per-view program listings that begin with other letters, the user may position indicator 151 (e.g., by pressing left or right keys on a remote control) to the desired letter. Indicator 151 may, for example, maintain its central position relative to navigator and the letters may scroll left and right. Alternatively, indicator 151 may move. FIG. 121 also illustrates the display of an advertisement in advertisement panel 99 that corresponds to, for example, a particular letter in bar 303 or the currently selected listing. In this example, an advertisement for “The Prince of Egypt”, a pay-per-view program within the listings (although not currently displayed in an option 12), has been assigned to the current position of bar 303.

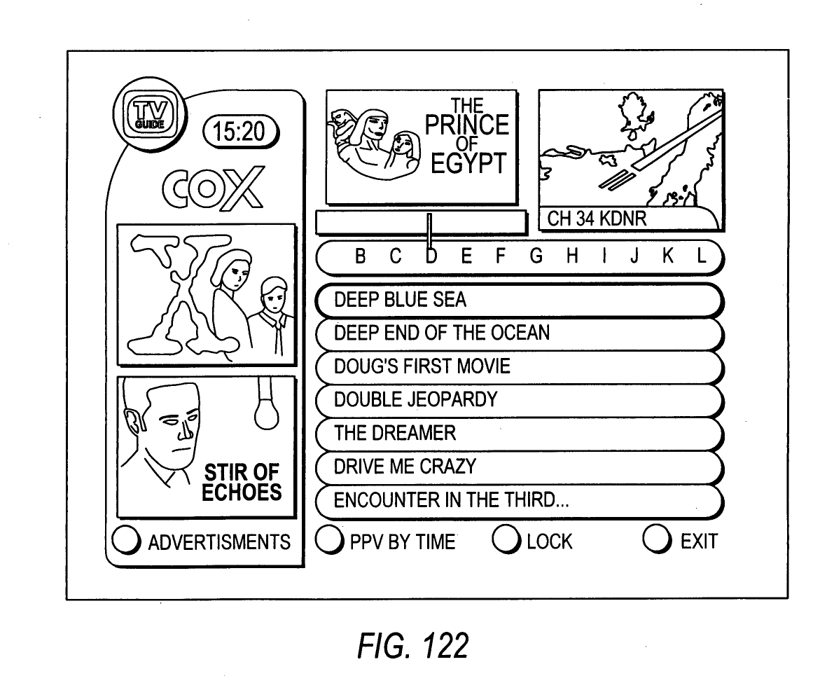

FIG. 122 illustrates the user navigating within bar 303 to letter “D”. As shown, advertisement panel 99 does not change because, for example, the advertisement shown has been assigned to the position in bar 303 for the letters “D”. Alternatively, one advertisement may be assigned to the entire bar 303. In such a case, the advertisement may change as the user navigates within the listings.

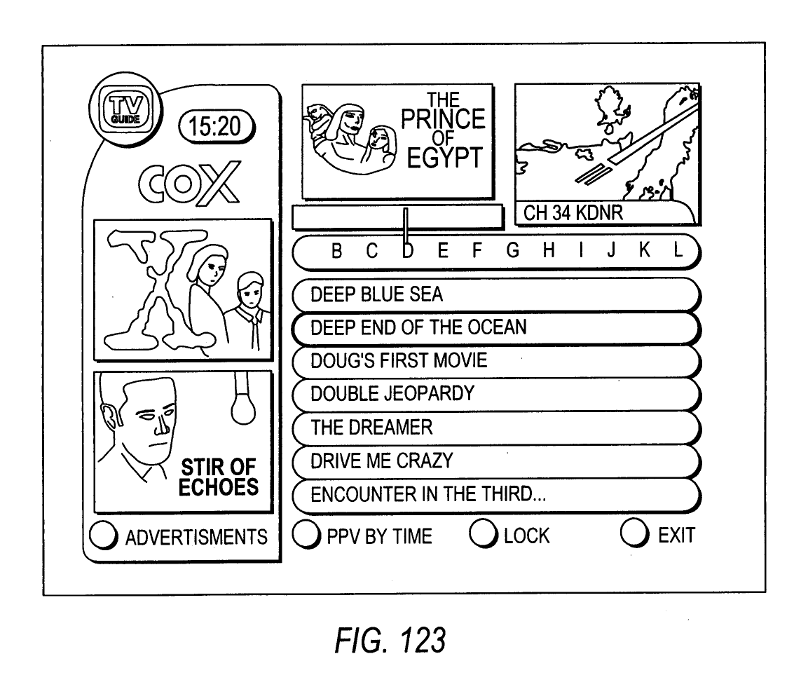

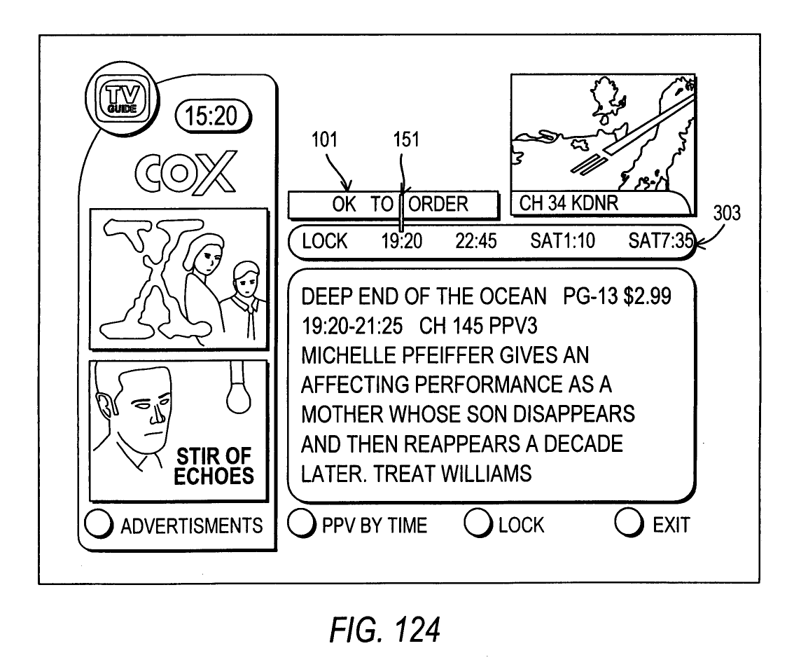

In FIG. 123, the user has navigated to the listing for “Deep End of the Ocean”. In response to the user selecting the listing, the guide may display an additional information screen such as that shown, for example, in FIG. 124. Navigational bar 303 may provide the user with an opportunity to, for example, lock the pay-per-view program, or order a particular showing. Users may access information for other showings by, for example, navigating within bar 303. Sliver 101 may indicate whether or not a particular showing is orderable. Users may order a particular showing using suitable pay-per-view ordering scheme.

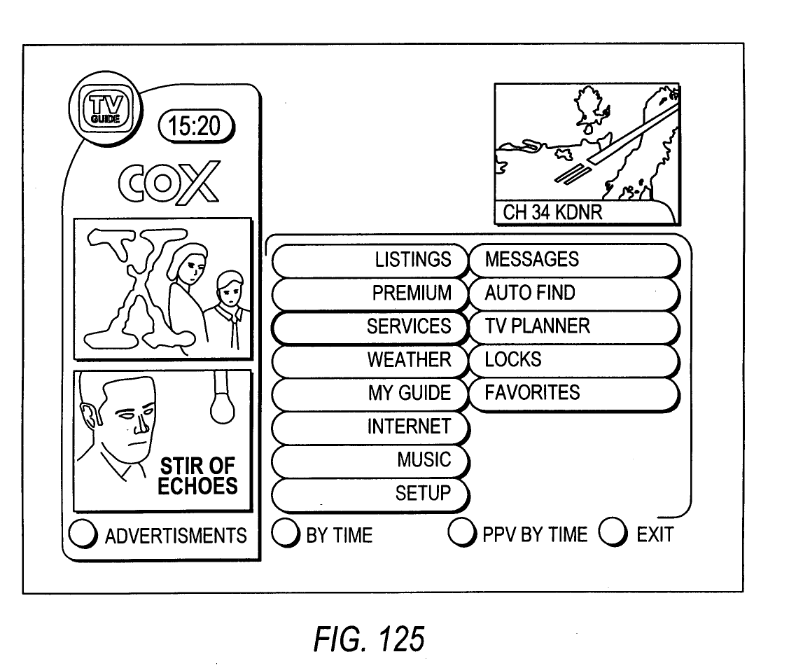

FIG. 125 shows the display of options 12 in response to the user selecting a services option. The services may include services such as messaging, auto find of programs, a tv planner, parental control, or favorites (e.g., banking application).

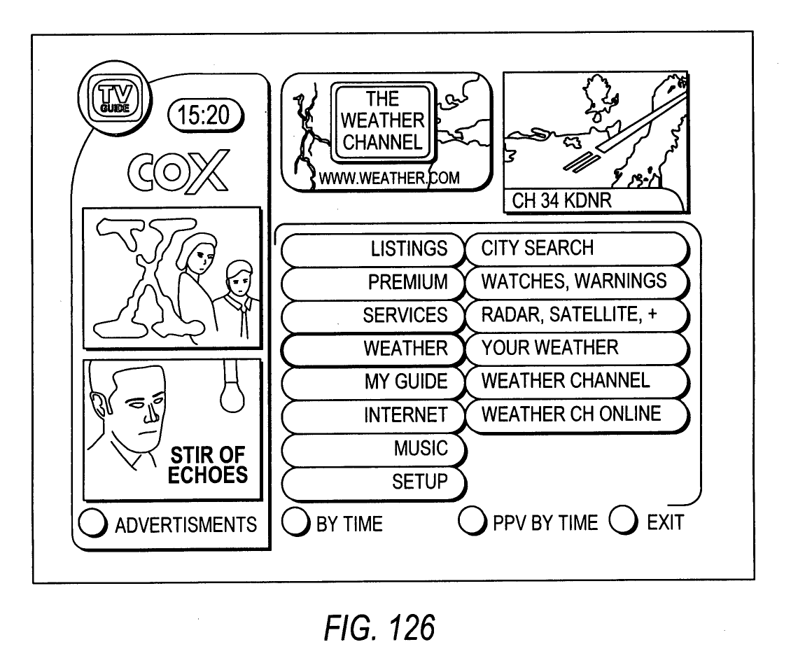

FIGS. 126-131 show illustrative display screens that the guide may display when providing access to a weather information service. The weather information provided may be national or local information. The guide may provide a user with an opportunity to access, for example, local weather information such as forecasts, satellite views, radar views, maps, archives of weather information, or other suitable weather related features. The user may, for example, choose a geographic location for which these or other features provide weather information. The guide may also provide the user with an opportunity to search for cities, access weather watches and warnings, access radar information, satellite information and other information, access a television based weather product such as the Weather Channel, access an on-line Weather Channel, or access any other suitable weather related feature. FIGS. 126-131 illustrate the display of screens for such features using another sliding effect in which, for example, displays slide with the changing of navigational bar 303. In another suitable approach, these screens may change statically. In each screen, an advertisement is displayed in advertisement tray 99. The advertisement may be, for example, for each feature from the navigation bar or, alternatively, a single advertisement for the entire weather feature.

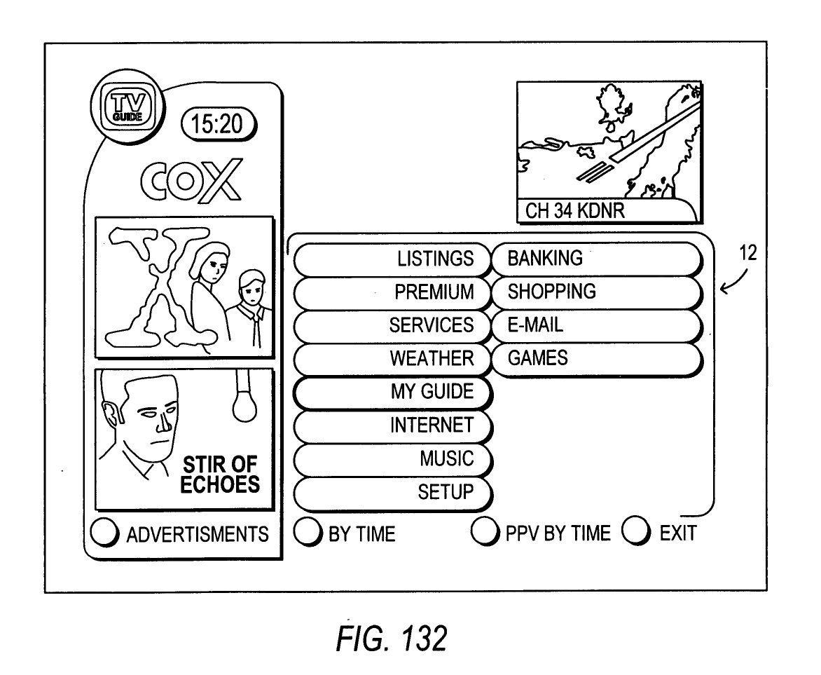

FIG. 132 shows the display of illustrative options 12 in response to the user selecting a “my guide” option. The my guide applications may include, for example, banking applications, home shopping applications, e-mail, and games.

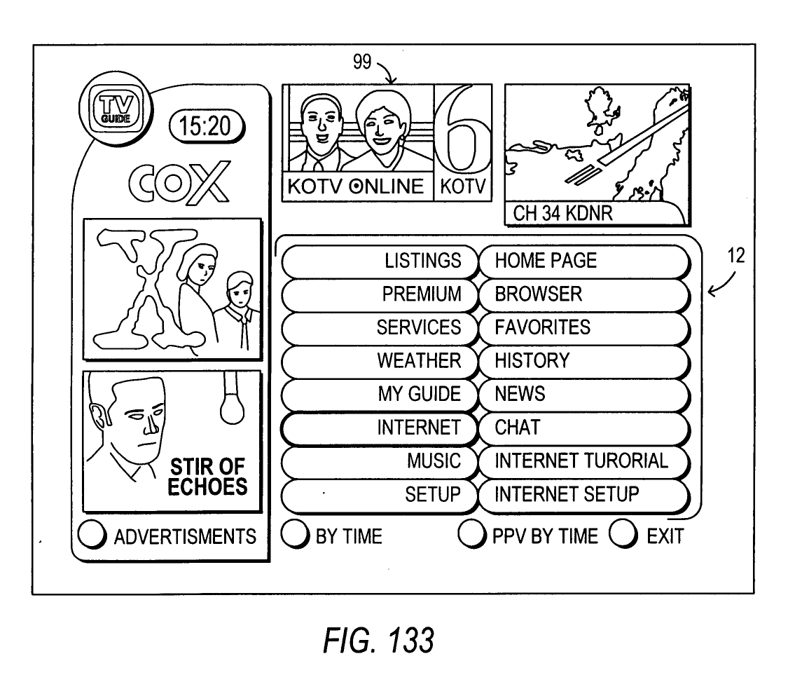

FIG. 133 shows the display of illustrative options 12 in response to the user selecting an “Internet” option. The Internet options may include, for example, accessing the user's home page, accessing a browser, accessing favorite web sites, accessing sites via the user's web history, accessing on-line news or chat services, accessing an Internet tutorial, and accessing the user's Internet setup. Any other suitable Internet services may be provided. In the example of FIG. 133, an advertisement for KOTV On-Line is displayed in advertisement tray 99. In keeping with the advertisement paradigm of the present invention, the user is provided with additional information about the current guide selection (i.e., that the user may access KOTV online or information about the site from within the current options) while still providing the guide provider with an advertising opportunity.

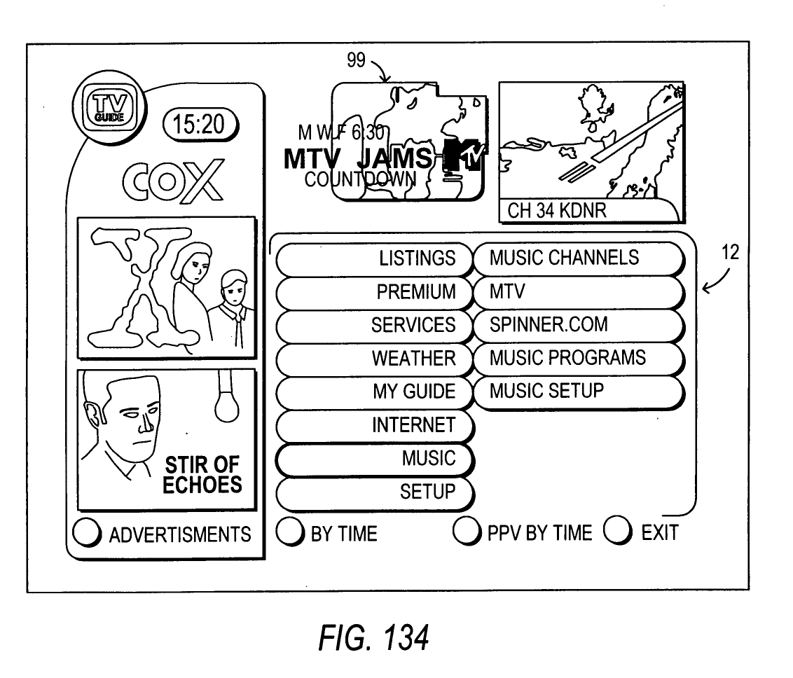

FIG. 134 shows the display of illustrative options 12 in response to the user selecting a music option. Music options may include, for example, access to digital or analog music channels, access to a video music channel (e.g., MTV), access to on-line music providers, access to a list of music programs, or access to a music setup screen where the user may set audio settings for the guide. Any other suitable music option may be provided. In the example of FIG. 134, an advertisement for MTV Jams is displayed in advertisement tray 99. In keeping with the advertisement paradigm of the present invention, the user is provided with additional information about the current guide selection (i.e., that the user may access MTV Jams or information about MTV Jams from within the current options) while still providing the guide provider with an advertising opportunity.

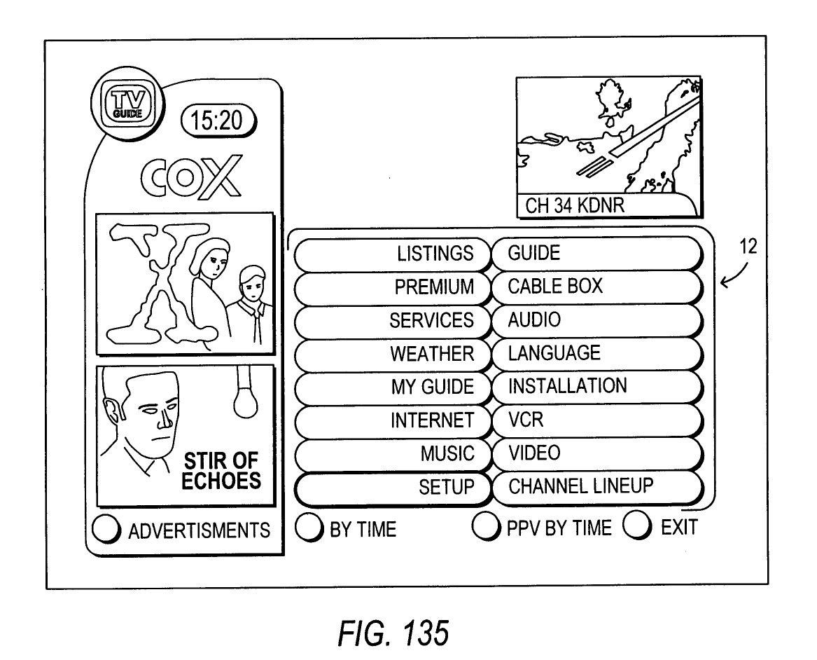

FIG. 135 shows illustrative options 12 that may be displayed in response to the user selecting a setup option. Setup options and guide setup are described in detail in, for example, above-mentioned Knudson et al. U.S. patent application Ser. No. 09/357,941, filed Jul. 16, 1999.

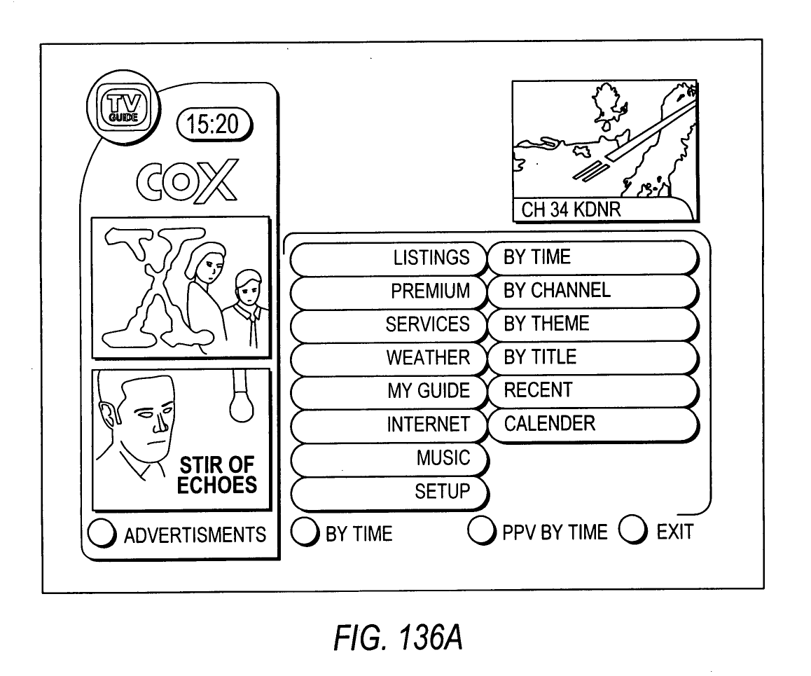

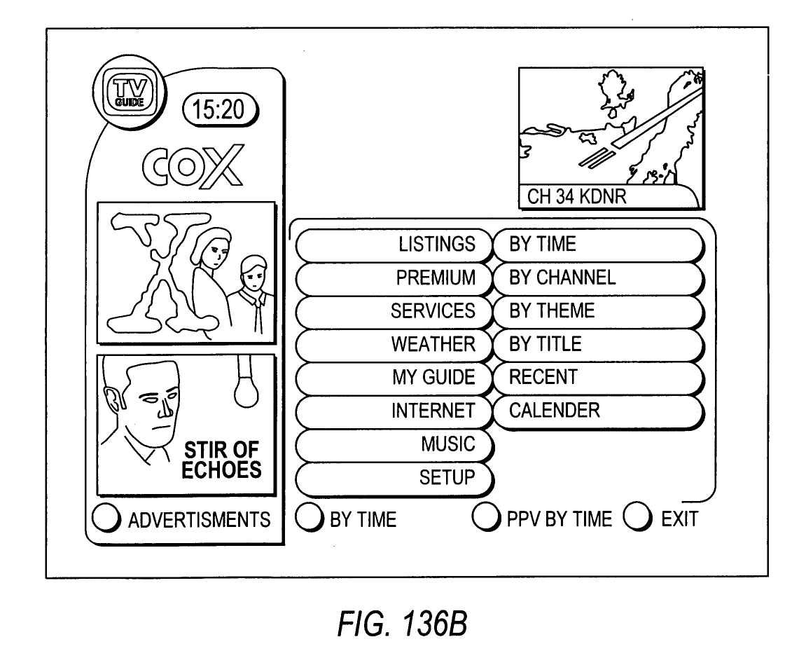

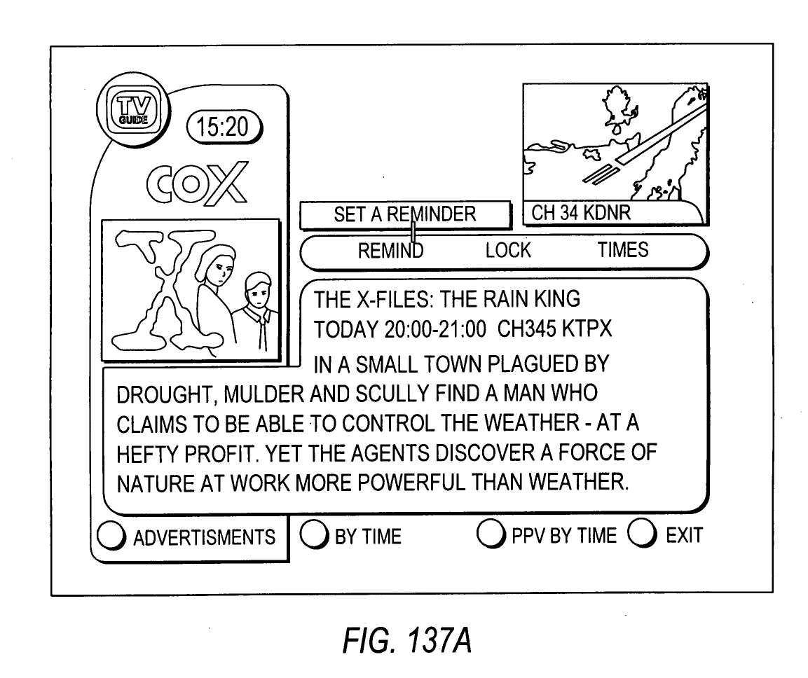

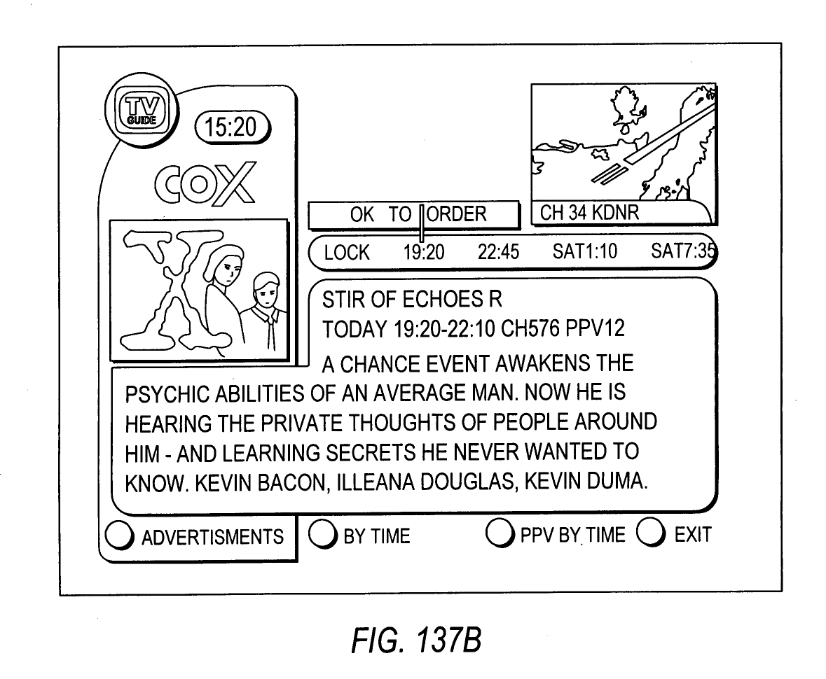

The guide may also provide users with an opportunity to select an advertisement 16 from any guide screen that includes selectable advertisements, and to obtain information for the advertised program, product, or service. Users may indicate a desire to select an advertisement by, for example, pressing the button on a remote control that is color coordinated with advertisements option 18 (FIG. 108). In response to the user indicating a desire to select an advertisement, the guide may highlight one of the advertisements 16, as shown in FIGS. 136A and 136B. In FIGS. 136A and 136B, for example, the user has selected advertisements option 18 from a main menu screen. In FIG. 136A, the user has highlighted an advertisement for “The X-Files”. In FIG. 136B, the user has highlighted an advertisement for “Stir of Echoes”. In response to the user selecting an advertisement 16, the guide may display an information screen as shown in FIGS. 137A and 137B for each advertisement, respectively. From within the information screen, a user may perform various functions, such as set a reminder for an advertised program, lock the program, see additional air times, order a particular showing, or perform any other suitable feature.

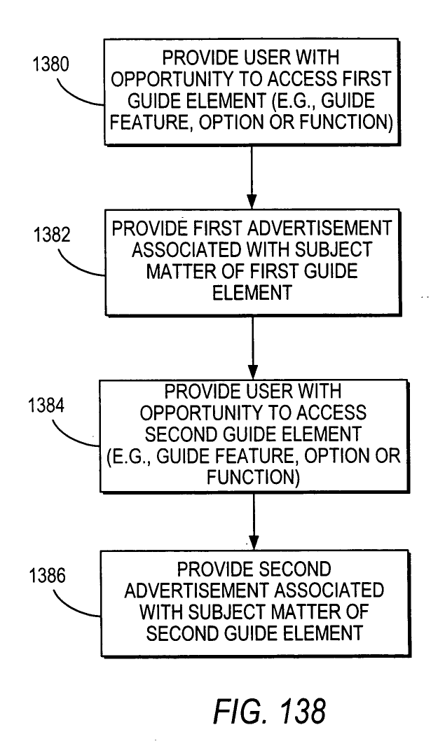

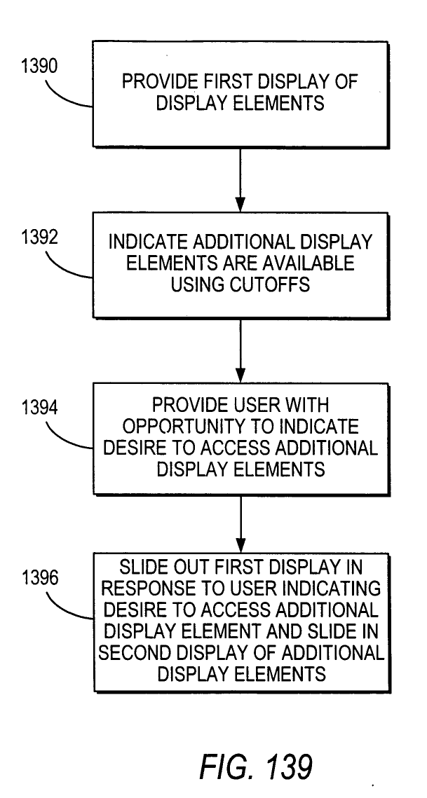

FIGS. 138-139 are flowcharts of illustrative steps involved in providing various features of the present invention. In practice, one or more of the steps shown may be combined with other steps, performed in any suitable order, or deleted.

FIG. 138 is a flowchart of illustrative steps involved in providing advertisements in advertisement tray 99 in accordance with the present invention. At step 1380, the program guide provides the user with an opportunity to access a first program guide element such as, for example, a guide feature, option, function. At step 1382, the program guide provides a first advertisement in advertisement tray 99 in response to the user accessing the first guide element. The first advertisement is associated with the subject matter of the first guide element. At step 1384, the guide provides the user with an opportunity to access a second guide element. At step 1386, the program guide provides a second advertisement in advertisement tray 99 in response to the user accessing the first guide element. The second advertisement is associated with the subject matter of the second guide element.

FIG. 139 is a flowchart of illustrative steps involved in providing a sliding navigational paradigm in accordance with the present invention. At step 1390, the program guide provides a first display of display elements. At step 1392, the program guide indicates that there are additional display elements available, using cutoffs. At step 1394, the program guide provides the user with an opportunity to indicate a desire to access additional display elements. At step 1396, the program guide slides out the first display in response to the user indicating a desire to the additional display elements, and slides in a second display of the additional display elements.

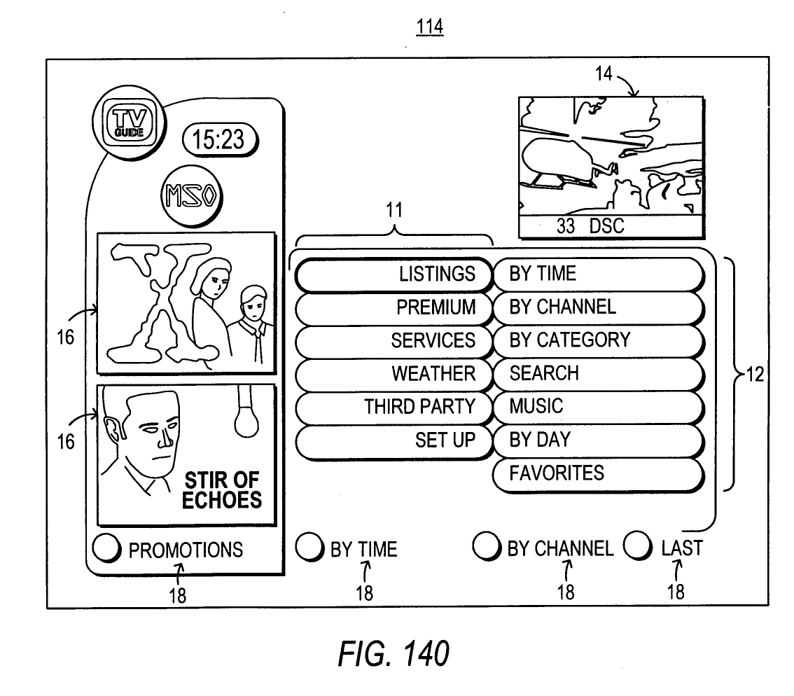

A fourth suitable interface approach in accordance with the present invention is shown in FIGS. 140-151. This approach is described, for example, in Moore et al. U.S. provisional patent application Ser. No. 60/202,302, filed May 5, 2000, which is hereby incorporated by reference herein in its entirety. The approach shown in FIGS. 140-151 includes some of the same elements of the other approaches described herein. An illustrative screen 114 that may be displayed by the program guide of the present invention is shown in FIG. 140. Screen 114 may be displayed when a user first invokes the program guide. Screen 114 may contain various menu options 11 and dependent options 12. Screen 114 may also contain a picture-in-guide window 14 that contains video for the television program on the channel to which the set-top box is currently tuned. Interactive advertisements 16 may also be displayed as part of screen 114.

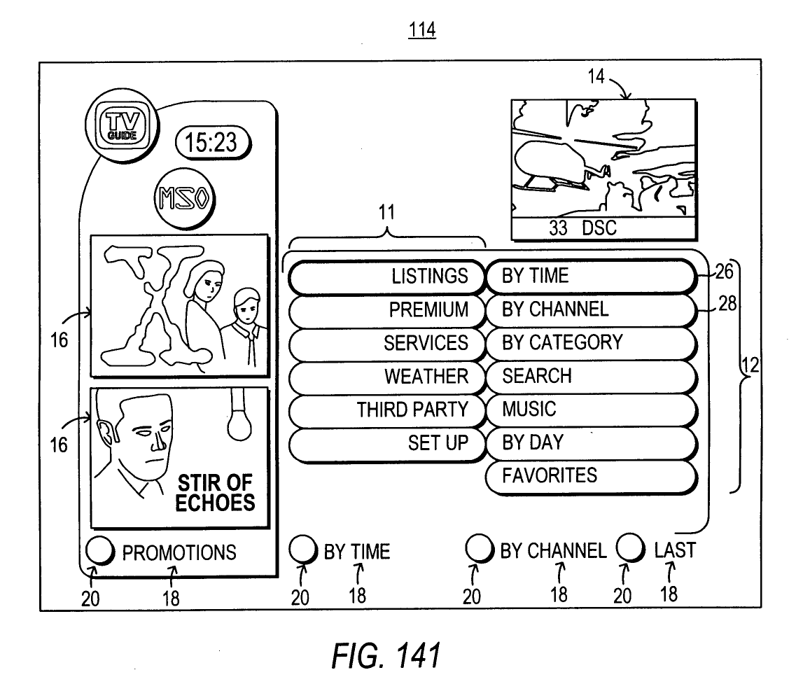

Menu options 11 in the left-hand column of screen 114 are options for a main menu. The dependent options 12 in the right hand column are options that are dependently displayed based on the currently highlighted menu option 11. As users arrow up and down within the menu options 11, the dependent options 12 will change depending on the currently selection menu option 11. Users may select menu options 11 or dependent options 12 using any suitable approach. The user may, for example press a right arrow key, a select key, or an enter key on a remote control. The selected menu option 11 (“listings”) may be displayed in a different color (e.g., orange) than the other menu options 11 and the first option 12 in the right hand column may be highlighted, as shown in FIG. 141. When any element on the display is active so that the user may select or otherwise interact with the element, that element may be, for example, lightened. Any inactive element (e.g., the options in the left column or the unselected advertisements) may be darkened relative to the active elements (e.g., the options in the right column) to show that they are inactive. The currently highlighted active element is the current selection among the active elements (e.g., the options in the right column). The user may move from by time option 26 to by channel option 28 by pressing, for example, a down arrow key on the remote control.

Screen 114 may contain soft-keys 18 for various program guide functions. The soft-keys may be dynamic; that is, the soft-keys may change depending on what the user has currently selected. The use may select, for example, a menu option 11, a dependent option 12, an advertisement 16, or picture-in-guide window 14. In this example, the user has selected “listings” dependent option 12. In response, the system presented soft-keys that provide features or functionality related to the selected option: listings by time, listings by channel, and returning to the last screen. If the user were to, for example, next select an advertisement 16, soft-keys 18 may change to indicate other features such as order, remind, last, or any other feature more suitable to the selection. The user may select a desired one of soft-keys 18 by, for example, pressing a color-coded key on the remote control. The color of the key may match the color of the dot 20 that is associated with the option. The color-coded buttons on the remote control may be the same as those that are sometimes used in certain countries to access teletext functions. Any suitable type of coding may be used if desired. Color coding is merely an example.

The various screen elements shown in FIGS. 140 and 141 may be displayed throughout the program guide. Picture in guide window 14, for example, may be displayed in substantially all guide display screens to provide users with an opportunity to watch the current channel while using the guide. Advertisements 16, for example, may be displayed on substantially all of the guide screens to maximize the guide provider's opportunity to promote various titles, other content, products or services.

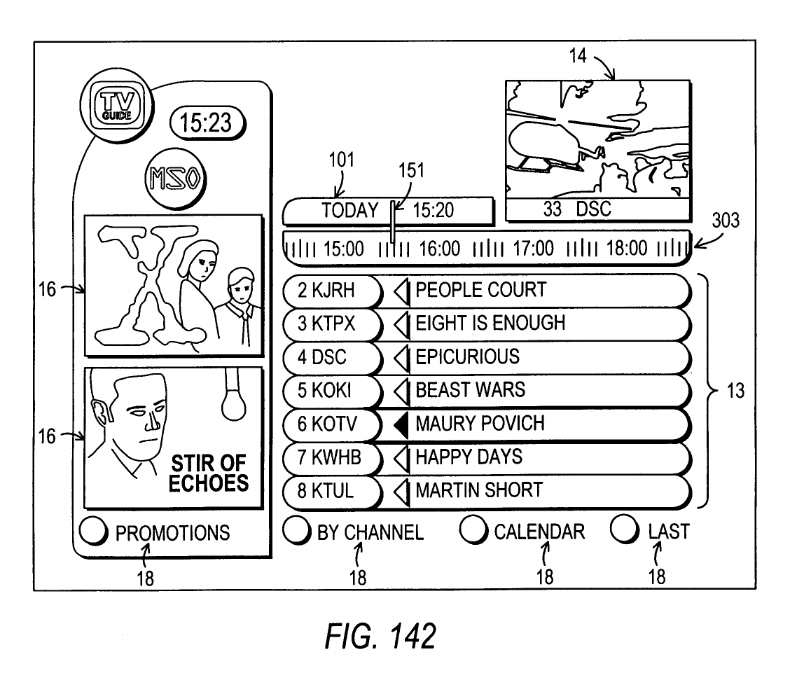

FIG. 142 shows an illustrative listing by time screen that the guide may display in response to the user selecting “by time” option 26. Listings by time screens and other guide screens may include action wheel 303. Action wheel 303 serves as the user's primary navigation tool. Action wheel 303 indicates the user's location within a given screen or section of the guide. The user may control action wheel 303 by, for example, pressing left and right arrow buttons on a remote control. Action wheel 303 may display any suitable information that indicates available criteria for the options in the current display. Action wheel 303 may include, for example, times, channels, features, or any other suitable criteria. Sliver 101 displays an expanded description of the active option within action wheel 303.

In the example of FIG. 142, the user has positioned indicator 151 of bar 303 to time 15:20 for the current day. Listings 13 are for programs that air at 15:20 accordingly. To view listings for additional times, the user may position indicator 151 (e.g., by pressing left or right keys on a remote control) to the desired time. Indicator 151 may, for example, maintain its position relative to action wheel 303 and the times may scroll left and right. Alternatively, indicator 151 may move left and right. In addition to indicator 151 and action wheel 303, sliver 101 may be displayed. Sliver 101 may display, for example, information related to the currently active option. This may include, for example, channel names, start times, program names, or any other suitable information. In this example, sliver 101 includes a label indicating the current position in action wheel 303. In this example, indicator 151 indicates to the user that listings for programs airing at 15:20 on the current day are displayed. Indicator 151 may change as the user manipulates action wheel 303 (e.g., by arrowing right or left). If the user manipulates action wheel 303 so that listings for the previous or next day are displayed, sliver 101 may display the name of the day for the displayed listings.

Action wheel 303 may be configurable. In FIG. 142, for example, the granularity of the hash marks of action wheel 303 may be configurable to facilitate program schedule variations in the international arena. Instead of 20 minute intervals, for example, the hash marks may be configured to represent 15 minute intervals to more closely correspond to program scheduling in the U.S. Any granularity may be used (e.g., 7 minutes, 1 minute, etc.).

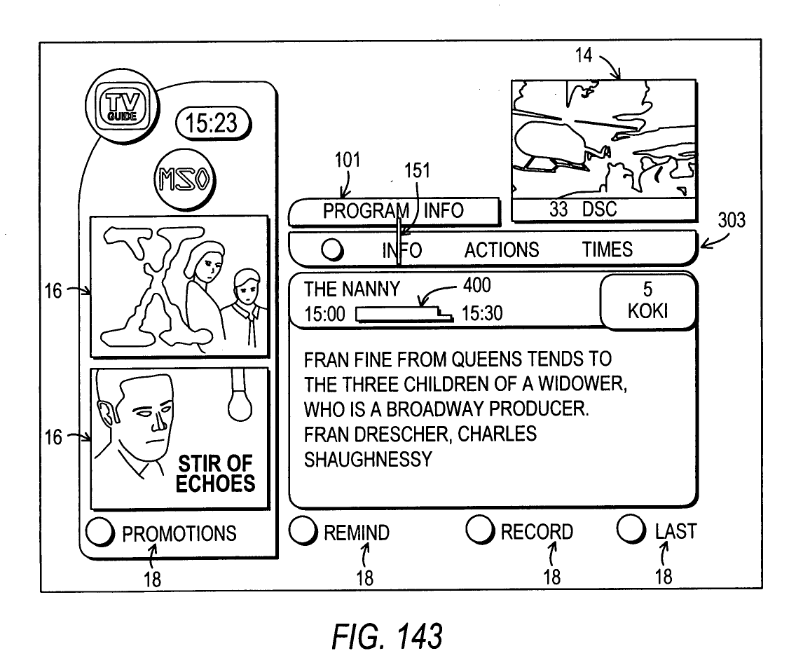

For the purposes of illustration, assume the user has navigated to a listing for “The Nanny” (e.g., by arrowing downward). As with other listings, the user may obtain additional information for a listing by selecting the listing (e.g., pressing on “info” key on the user's remote control). In response, the guide may display an additional information screen, as shown, for example, in FIG. 143. The illustrative information screen of FIG. 143 may display information about a title (e.g., title, channel, rating, air time, and description). If there is more information than can fit in a single screen, the guide may provide the user with an opportunity to scroll or page up or down to access the information. The by time screen may also include program progress bar 400 to indicate how far along a program has progressed. In this example, The Nanny started at 15:00 but it is currently 15:23.

The guide may also provide the user with an opportunity to access other guide features from within an additional information screen. The guide may, for example, provide the user with an opportunity to schedule a reminder for a program, record a program, return to the last screen, or any other suitable feature. Program guide systems in which user are provided with an opportunity to access additional features are described, for example, in Rudnick et al. U.S. patent application Ser. No. 09/356,268, filed Jul. 16, 1999, which is hereby incorporated by reference herein in its entirety. The available features may be displayed, for example, as soft-keys 18.

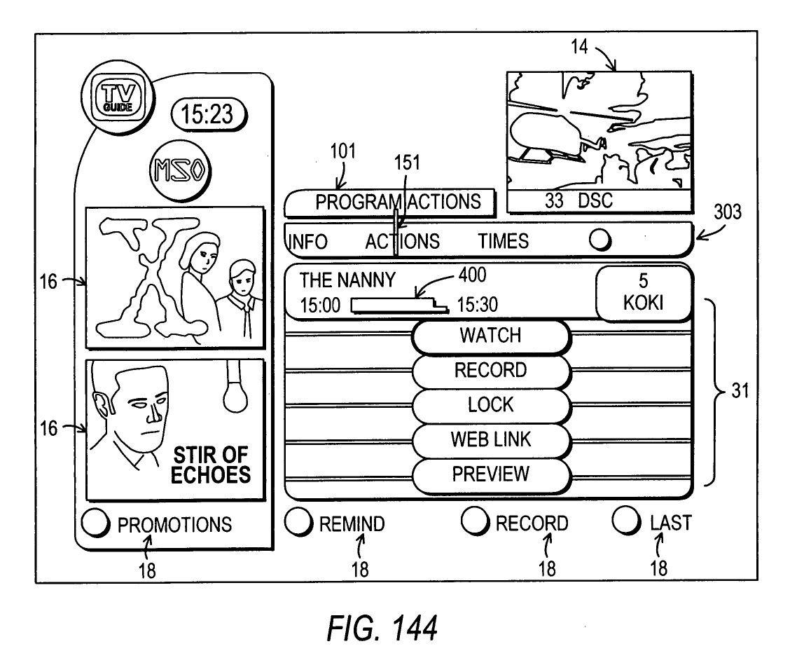

The guide may also provide additional feature in action wheel 303 of the additional information screen. In this example, two additional program guide features are associated with the program: actions and times. In response to a user navigating within action wheel 303 to “actions”, the guide may provide an actions display. An illustrative actions display is shown in FIG. 144. The actions 12 in the action display may be any action that may be associated with the selected program. The system may dynamically associate actions with a program using, for example, metadata, by putting additional fields in the program guide data, or using any other suitable approach. The actions in the action display may be linked, via executable type commands or scripts, to other applications to provide the user with enhanced features that are related to the program. In this example, actions 12 include watching the program (which is provided if the program is currently aired), recording the program (which may also be provided using, for example, soft-key 18), locking the program, accessing a web link, or viewing a preview. Additional actions that may be associated might include, for example, access to an interactive game for the program, a web site related to the program or an actor within the program, access to an e-commerce site that carries products associated with the program or featured within the program, or any other suitable action. In response to a user navigating within the action display and selecting an action, the system may provide the feature (e.g., watch, record, lock) or launch the appropriate application (e.g., a web browser to provide access to a web link).

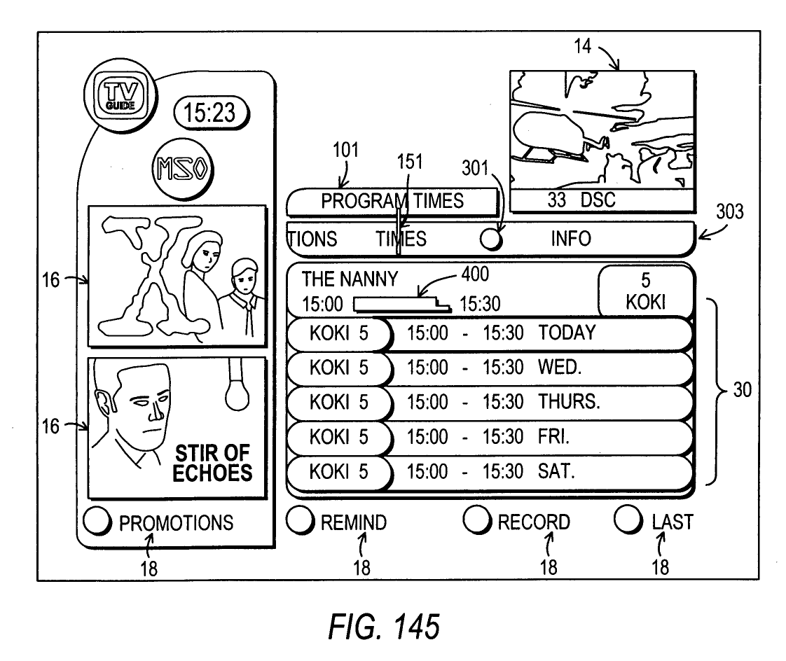

In response to the user selecting “times” from action wheel 303 of FIG. 143, the guide may provide a display of other air times as shown, for example, in FIG. 145. The guide may provide the user with an opportunity to select an air time 30 and set a reminder, schedule the showing for recording, or access any other suitable feature. From within the displays of FIGS. 144 and 145, the user may return to the information screen of FIG. 143 by navigating within action wheel 303 to return icon 301.

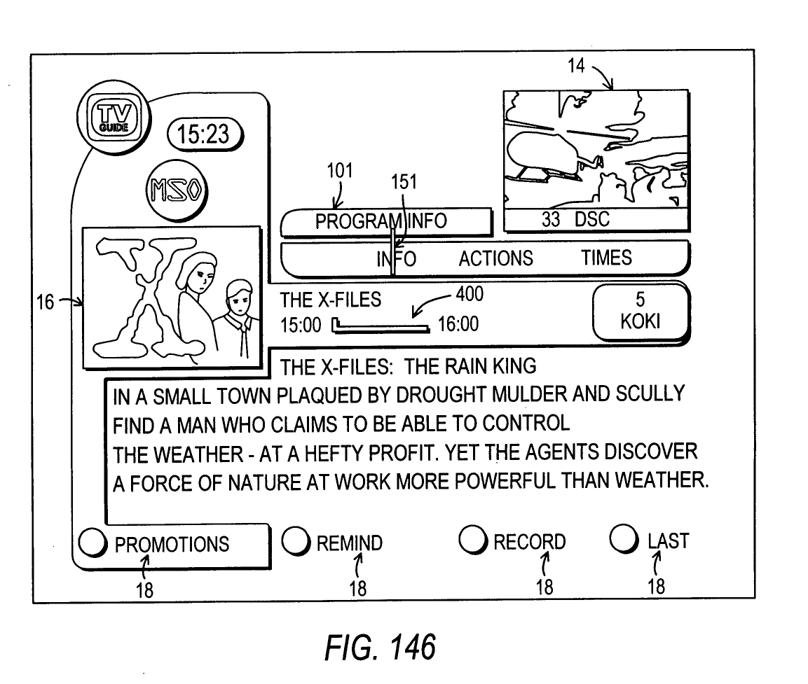

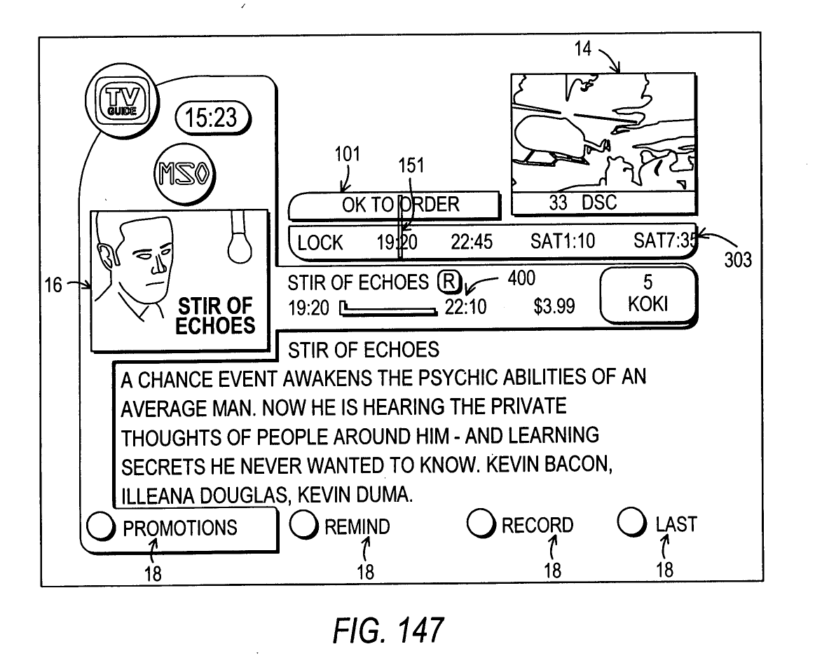

The guide may also provide users with an opportunity to select an advertisement 16 from any guide screen that includes selectable advertisements, and to obtain information for the advertised program, product, or service. Users may indicate a desire to select an advertisement by, for example, pressing the button on a remote control that is color coordinated with a soft-key 18 associated with the advertisements 16 (FIG. 140). In response to the user indicating a desire to select an advertisement 16, the guide may highlight one of the advertisements 16. In response to the user selecting an advertisement 16, the guide may display an information screen as shown in FIGS. 146 and 147 for each advertisement, respectively. From within the information screen a user may perform various functions, such as access additional actions and view other air times, by navigating within action wheel 303. FIGS. 146 and 147 also illustrate the dynamic change of soft-keys 18. In these examples, soft-keys 18 have been changed to supplement the features accessible within action wheel 303. Users may, for example, set reminders, record programs, or return to the last screen, by pressing a single button on their remote controls.

The main menu of FIG. 140 may also provide users with opportunities to search for listings by category. In response to a user selecting by category option 12, the system may provide the user with a list of categories that may include, for example, movie/drama, detective/thriller, adventure/western/war, science fiction/fantasy/horror, comedy, soap/melodrama/folkloric, romance, adult movie/drama, news/current affairs, sports, children's/youth, music, or any other suitable category or combination of categories. Each category may include one or more subcategories. The sports category, for example, may include football, baseball, and tennis subcategories. If desired, categories and subcategories may be dynamically displayed. That is, the guide may determine if a given category or subcategory has an available listing. If not, the guide may not present that category or subcategory as an option. This may tend to lessen user confusion or frustration that may occur when users select categories or subcategories for which there is no content.

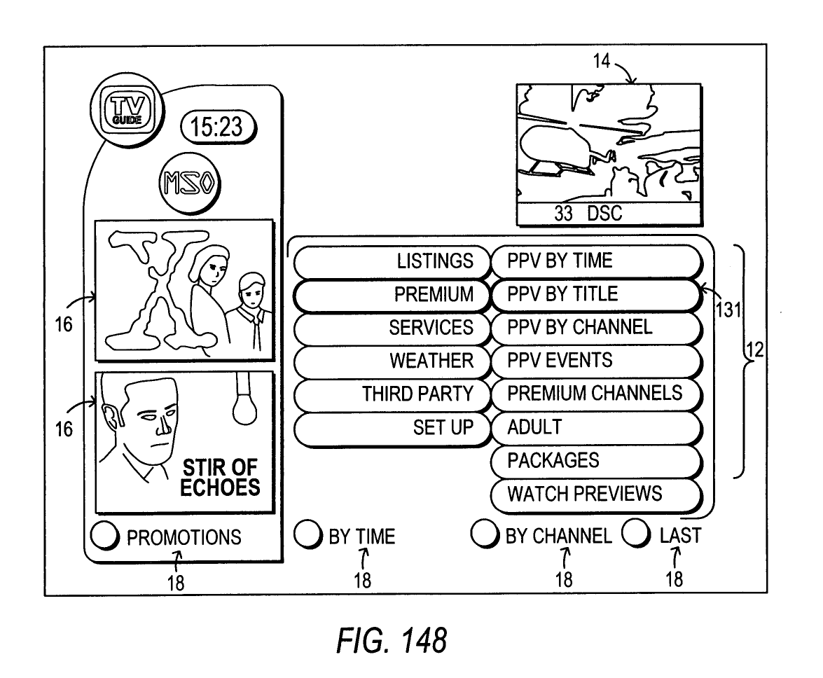

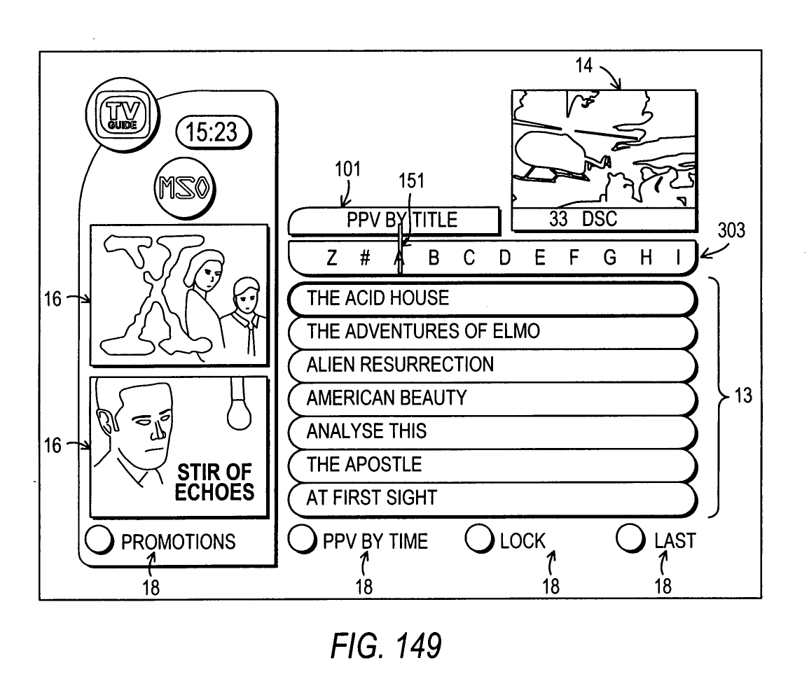

FIG. 148 shows options 12 that the guide may display in response to the user selecting a premium option 12 from the main menu of FIG. 140. In practice, the number of options 12 available may be dynamically configurable in this menu screen, or any other menu screen if suitable. As shown, the user may access pay-per-view listings by time, title and channel, and may also access pay-per-view events, premium channels, adult pay-per-view, and pay-per-view packages. The user may also access a screening room in which the user may watch previews. The user may, for example, indicate a desire to view pay-per-view listings by title (e.g., by selecting “ppv by title” option 131). In response, the guide may display a pay-per-view by title screen, such as the illustrative screen shown in FIG. 149.

In the example of FIG. 149, indicator 151 of action wheel 303 is initially positioned over the letter “A”. Listings 13 are for pay-per-view program listings that begin with the letter “A” accordingly. To view pay-per-view program listings that begin with other letters, the user may position indicator 151 (e.g., by pressing left or right keys on a remote control) to the desired letter. Indicator 151 may, for example, maintain its central position relative to action wheel 303 and the letters may scroll left and right. Alternatively, indicator 151 may move. The user may arrow up or down to see additional listings that begin with the currently selected letter. When the user arrows up or down to titles that begin with a letter other than that selected in action wheel 303, the guide may adjust action wheel 303 so that indicator 151 indicates the letter for the titles. This two-dimensional navigational paradigm for searching may enhance the user's ability to easily find a desired program from a large list of programs.

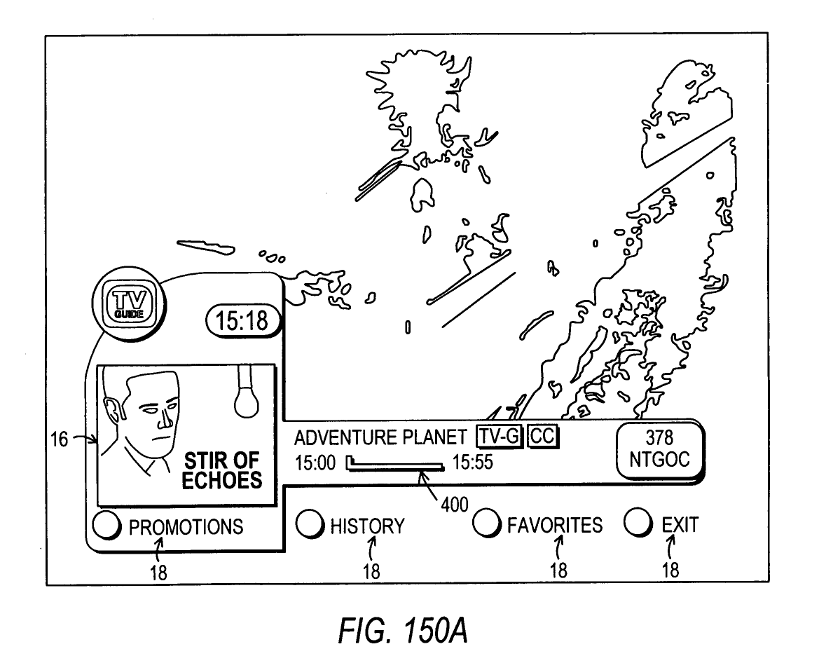

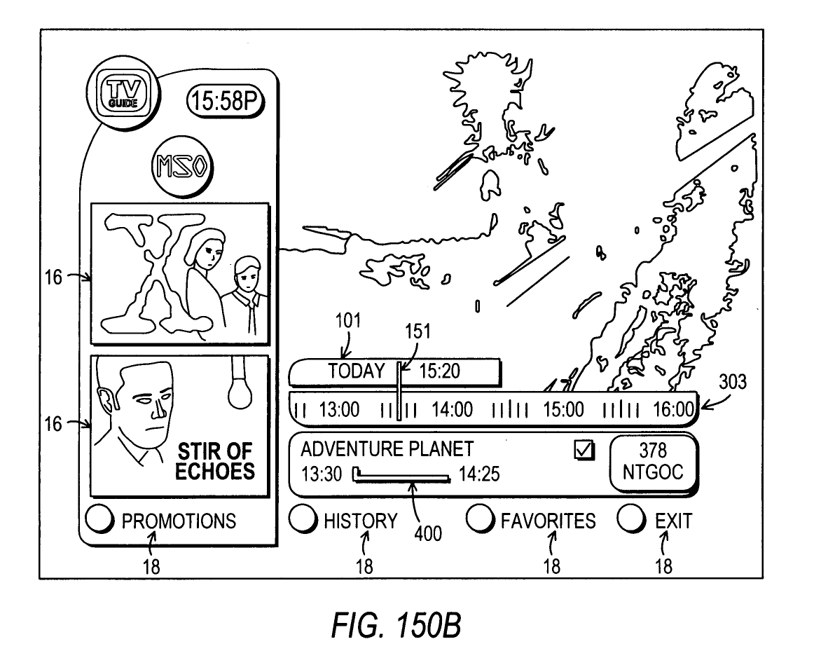

A further feature of the present invention is to incorporate soft-keys 18 or action wheel 303 into additional program guide displays, such as FLIP and BROWSE displays. FIG. 150A shows an illustrative FLIP display incorporating soft-keys 18. FIG. 150B shows an illustrative BROWSE display incorporating action wheel 303. The FLIP and BROWSE displays include a two-line program title bar containing information about the program. The second line of the title bar includes a program progress bar 400 that indicates the time remaining for the program.

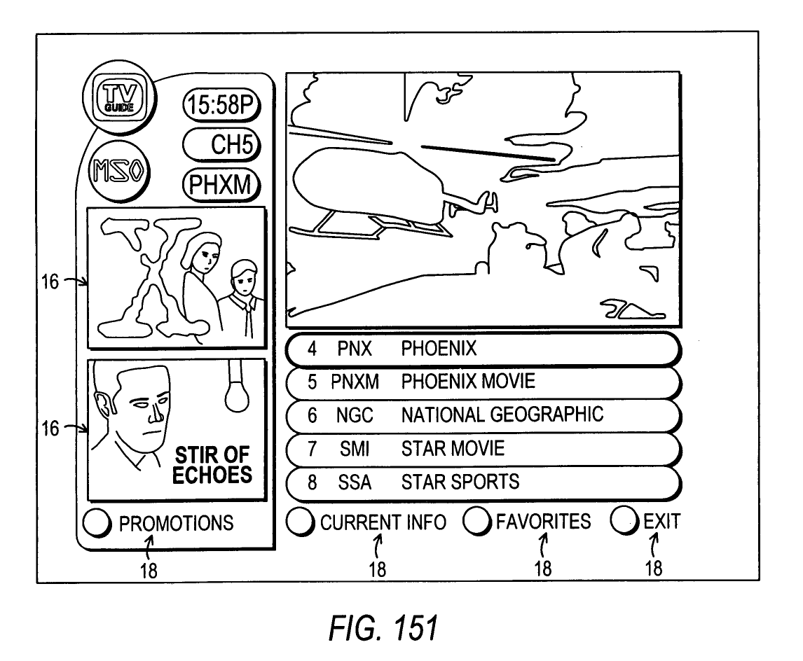

FLIP and other displays of the program guide may incorporate a history soft-key 18 that provides the user with an opportunity to access a display of previous channels that the user has watched. In response to the user pressing a key on a remote control that corresponds to the history soft-key 18, the guide may present a history display. An illustrative history display is shown in FIG. 151. The history display may include advertisements 16, dynamic soft-keys 18, and a list of the most recent channels that the user accessed. The history display indicates the programs that are currently available on the previously accessed channels. The user may arrow up or down to display the currently available programs in the video window. The user may press a suitable key (e.g., “OK” or “ENTER”) to tune to a highlighted channel and view the program in full display.

If desired, other features of the guide may use a similar display as shown in FIG. 151. A favorites feature, for example, may use the display to provide the user with a navigable list of favorites listings and a video window synchronized to the user's navigation within the list. A user may access such a favorites display by, for example, pressing a suitable key on a remote control while watching television, or by selecting a feature or option from within a guide screen. If desired, the display of FIG. 151 may be used when presenting reminders. When one or more reminders are scheduled for presentation, the guide may display a similar navigable list and synchronized video window. The user may navigate among reminders for programs to view programs in the window, and then tune to the program. If desired, the guide may provide the user with an opportunity to configure whether the user wishes a reminder to be automatically added to a history list when a reminder is displayed, whether or not the user tunes to a channel.

A further feature of the present invention is the componentization of screen elements. Each screen element may be componentized, and possesses specific characteristics. Componentization of screen elements may allow many components to be used in more than one screen. Components may also act as containers for other components. In screen 10 of FIG. 140 for example, each column of options 12 may be a component that includes separate individual component options 154. Picture in guide window 14 may also be a separate component. Advertisements 16 may be separate components, organized into a group that is a single component. Libraries of components may be constructed to provide for the more efficient storage and retrieval of component if desired.

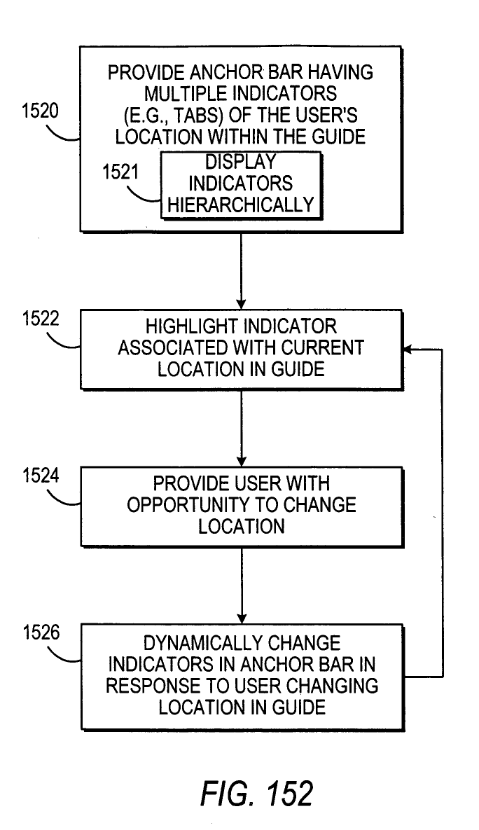

FIGS. 152-157 are flowcharts of illustrative steps involved in providing various features of the present invention. In practice, one or more of the steps shown may be combined with other steps, performed in any suitable order, or deleted.

FIG. 152 is a flowchart of illustrative steps involved in providing the dynamic anchor bar feature of the present invention. At step 1520, the program guide provides an anchor bar having multiple indicators such as, for example, tabs. If desired, the indicators may be provided hierarchically having, for example, the highest level indicator displayed at the left of the bar and the lowest level indicator displayed at the right (step 1521). At step 1522, the program guide highlights the indicator associated with the user's current location in the guide. At step 1524, the program guide may provide the user with an opportunity to change his or her location within the guide. In response to the user changing his or her location, the program guide dynamically changes the indicators in the anchor bar to reflect the users new location.

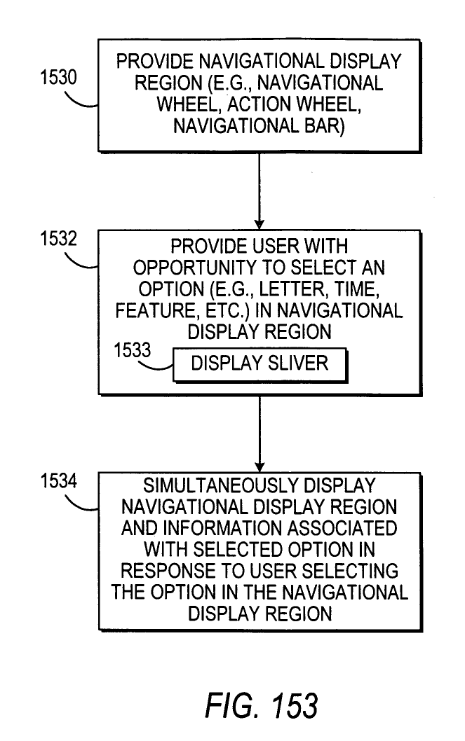

FIG. 153 is a flowchart of illustrative steps involved in providing a navigational display region such as, for example, a display region 38 (e.g., FIG. 24), a navigational wheel 303 (e.g., FIGS. 37A and 37B), a navigational bar (e.g., FIG. 109), an action wheel (e.g., FIG. 146), or another suitable navigation display. At step 1530, the program guide provides the navigational display region. At step 1532, the program guide provides the user with an opportunity to select an option (e.g., letters, times, features, etc.) in the navigational display region. If desired, a sliver may be displayed with the navigational display region (step 1533). At step 1534, the program guide simultaneously displays the navigational display region and information associated with the selected option in response to the user selecting an option in the navigational display region. The system may, for example, provide program listings for a given time, channel, that start with a given letter, or any other suitable information.

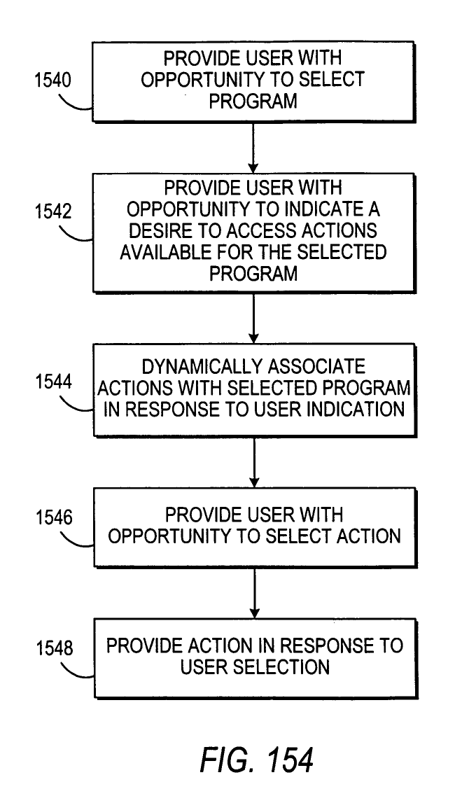

FIG. 154 is a flowchart of illustrative steps involved in providing dynamic actions associated with programs, in accordance with the present invention. At step 1540, the program guide provides a user with an opportunity to select a program. At step 1542, the program guide provides the user with an opportunity to indicate a desire to access actions available for the selected program. At step 1544, the program guide dynamically associates actions with the selected program in response to the user indication. The guide may dynamically associate actions with a program using, for example, metadata, by putting additional fields in the program guide data, or using any other suitable approach. The actions in the action display may be linked, via executable type commands or scripts, to other applications to provide the user with enhanced features that are related to the program. At step 1544, the guide provides the user with an opportunity to select one of the dynamically associated actions. At step 1548, the guide provides the selected action in response to the user selection.

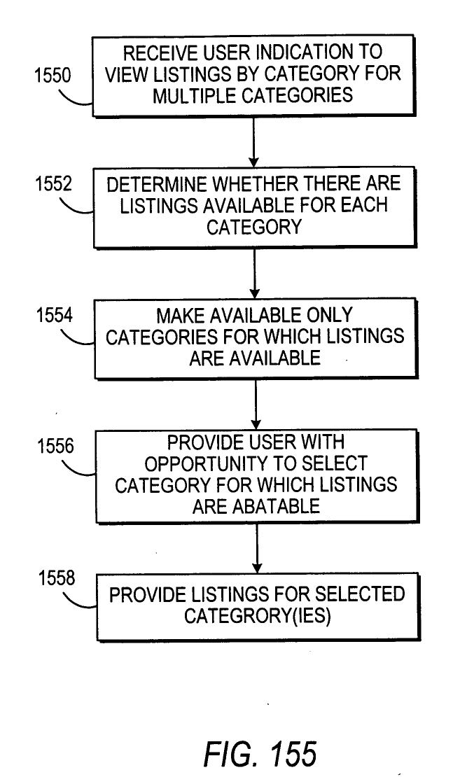

FIG. 155 is a flowchart of illustrative steps involved in providing dynamic category displays in accordance with the present invention. At step 1550, the program guide receives an indication from the user to view listings by category. At step 1552, the guide determines whether there are listings available for each category. This may be performed, for example, periodically, or in response to the user indication. At step 1554, the guide makes available for selection only those categories for which listings are available. The guide may, for example, provide a display of such categories, permit users to search only such categories, or may make such categories available for selection using any other suitable approach. At step 1556, the guide provides the user with an opportunity to select one or more of the available categories. At step 1558, the guide provides listings for the selected category or categories.

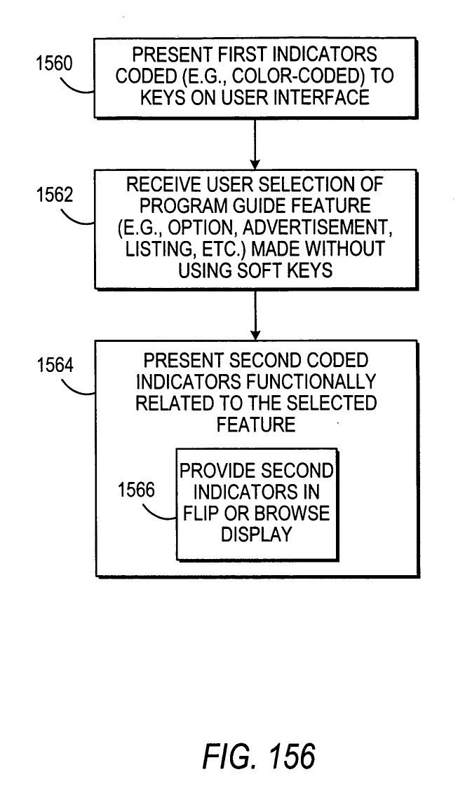

FIG. 156 is a flowchart of illustrative steps involved in providing dynamic softkeys in accordance with the present invention. At step 1560, the guide presents first softkeys that are coded (e.g., color coded) to keys on the user interface, such as keys on a remote control. At step 1562, the guide receives a selection of a program guide feature (e.g., option, advertisement, listing, etc.) made by a user without using the softkeys. At step 1564, the guide presents second softkeys in response to the user selection. The second indicators are functionally related to the selected feature. The second indicators may be provided in, for example, browse or flip displays (step 1566).

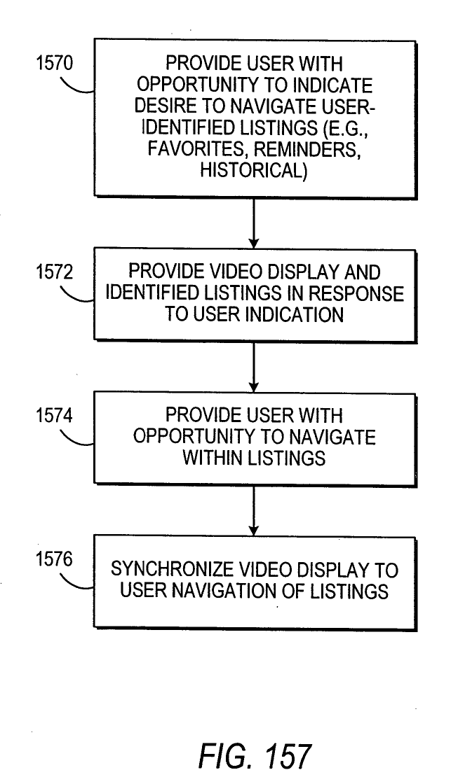

FIG. 157 is a flowchart of illustrative steps involved in providing navigational displays having synchronized video windows for histories, favorites and reminders, in accordance with the present invention. At step 1570, the guide provides the user with an opportunity to navigate user-identified listings such as, for example, favorite, reminder and historical listings. Favorite and reminder listings are expressly identified by the user; that is, the user selects or otherwise identifies those programs that the user wishes marked as favorites or for which the user wishes reminders. Historical listings are implicitly identified by the user; that is, the system tracks those programs that the user watches.

The guide, in response to the user indication, provides a video display and the identified listings at step 1572. The video display may be, for example, a video window. At step 1574, the guide provides the user with an opportunity to navigate within the listings. As the user navigates within the listings, the guide synchronizes the video display to the current listing identified (e.g., highlighted) by the user.

Thus, a program guide having an improved user interface is provided. One skilled in the art will appreciate that the present invention can be practiced by other than the described embodiments, which are presented for purposes of illustration and not of limitation, and the present invention is limited only by the claims which follow.

1-20. (canceled)

21. A method for providing displays of program listings by category comprising:
receiving a user indication to view listings by category for multiple categories;
determining whether there are listings available for each category of the multiple categories;
making available for selection only categories for which listings are available;
providing the user with an opportunity to select a category of the categories for which listings are available; and
providing a display of listings for the selected category.

22-48. (canceled)

49. An interactive television program guide system in which displays of program listings by category are provided, comprising:
means for receiving a user indication to view listings by category for multiple categories;
means for determining whether there are listings available for each category of the multiple categories;
means for making available for selection only categories for which listings are available;
means for providing the user with an opportunity to select a category of the categories for which listings are available; and
means for providing a display of listings for the selected category.

50-76. (canceled)

77. An interactive television program guide system in which displays of program listings by category are provided, comprising:
a user input device;
a display device; and
control circuitry configured to:
receive a user indication to view listings by category for multiple categories from the user input device;
determine whether there are listings available for each category of the multiple categories;
direct the display device to make available for selection with the user input device only categories for which listings are available;
direct the display device to provide the user with an opportunity to select a category of the categories for which listings are available with the user input device; and
direct the display device to provide a display of listings for the selected category.

78-84. (canceled)

85. The method of claim 21 wherein at least one of the multiple categories comprises one or more subcategories.

86. The method of claim 85 further comprising:
receiving a user indication to view listings by subcategory for multiple subcategories;
determining whether there are listings available for each subcategory of the multiple subcategories;
making available for selection only subcategories for which listings are available;
providing the user with an opportunity to select a subcategory of the subcategories for which listings are available; and
providing a display of listings for the selected subcategory.

87. The system of claim 49 wherein at least one of the multiple categories comprises one or more subcategories.

88. The system of claim 87 further comprising:
means for receiving a user indication to view listings by subcategory for multiple subcategories;
means for determining whether there are listings available for each subcategory of the multiple subcategories;
means for making available for selection only subcategories for which listings are available;
means for providing the user with an opportunity to select a subcategory of the subcategories for which listings are available; and
means for providing a display of listings for the selected subcategory.

89. The system of claim 77 wherein at least one of the multiple categories comprises one or more subcategories.

90. The system of claim 89 the control circuitry is further configured to:
receive a user indication to view listings by subcategory for multiple subcategories;
determine whether there are listings available for each subcategory of the multiple subcategories;
make available for selection only subcategories for which listings are available;
provide the user with an opportunity to select a subcategory of the subcategories for which listings are available; and
provide a display of listings for the selected subcategory.
